(19) United States
(12) Patent Application Publication
(10) Pub. No.: US 2003/0182290 A1
(43) Pub. Date: Sep. 25, 2003

(54) Integrated life planning method and systems and products for implementation

(76) Inventor: Denise S. Parker, Sunland, CA (US)

Correspondence Address: BRINKS HOFER GILSON & LIONE, P.O. BOX 10395, CHICAGO, IL, 60611, US

(21) Appl. No.: 10/013,888

(22) Filed: Oct. 19, 2001

Related U.S. Application Data
(60) Provisional application No. 60/242,283, filed on Oct. 20, 2000.

(51) Int. Cl. G06F 7/00

(52) U.S. Cl. 707/100

(57) ABSTRACT

A method for facilitating final estate planning comprises gathering data in response to a series of questions organized into four points of estate planning, which are (1) client assets, (2) client fiscal and human/pet care responsibilities (i.e. creditors, children, spouse, employers and others that are dependent upon the client), (3) desired disposition of the client's body before (e.g., assisted living, hospice, palliative care, life support) and after death (corporal disposition), and (4) funding arrangements and documentation for asset disposition to cover fiscal, human/pet care responsibilities, living body and subsequent remains disposition, and to carry out the client's other wishes. A system for performing the method includes a computer program that is preferably accessible via an internet web site. A unique identification card, known as a denicard™, is provided which includes information for accessing the bearer's or owner's end of life (EOL) plans and data that is stored in a database accessible via a the web site or a designated entity, wherein the stored data is generated by the system when the FEP method was performed. Numerous variations of FEP and EOL planning methods and systems and products for implementation are described. These can be incorporated into a total life plan.

This application claims priority from U.S. Provisional Patent Application Serial No. 60/242,283, filed Oct. 20, 2000.

### REFERENCE TO COMPUTER PROGRAM LISTINGS SUBMITTED ON COMPACT DISK

A compact disk appendix is included containing computer program code listings pursuant to 37 C.F.R. §1.52(e) and is hereby incorporated by reference. The compact disk contains program code files in ASCII format as well as graphic image files in binary format. The graphic image and document files are submitted as place holders for references within the ASCII code listings to indicate to one of ordinary skill in the art where to substitute suitable graphic images. One of ordinary skill in the art will appreciate that the contents of the graphic image files is not necessary to the operation of the disclosed embodiments. The total number of compact disks is one (1) and the files included on the compact disk are as follows.

| | | File | | |
|---|---|---|---|---|
| CD DIRECTORY | Type | Size | Dated | File name |
| Volume | | | | |
| Serial | | | | |
| Number is | | | | |
| D0F0-6884 | | | | |
| DENI_W˜5 | <DIR> | | 10-08-01 | deni_website |
| README˜8 | DOC | 77,312 | 10-08-01 | ReadMe_Copyright.doc |
| 1 file(s) | 77,312 | | | |
| | bytes | | | |
| CF | <DIR> | | 10-08-01 | cf |
| DB | <DIR> | | 10-08-01 | db |
| ONLINE˜9 | <DIR> | | 10-08-01 | Online Memorial |
| WWW | <DIR> | | 10-08-01 | www |
| | 0 file(s) | | | |
| | 0 bytes | | | |
| Directory of | | | | |
| cf | | | | |
| ACCOUNTS | <DIR> | | 10-08-01 | accounts |
| ADBANNER | CFM | 1,655 | 10-08-01 | Adbanner.cfm |
| ADD_B˜10 | CFM | 18,830 | 10-08-01 | Add_Birth_Certificate.cfm |
| ADD_B˜12 | CFM | 14,819 | 10-08-01 | Add_Birth_Records.cfm |
| ADD_E˜14 | CFM | 20,644 | 10-08-01 | Add_Emergency_Contact.cfm |
| ADD_F˜16 | CFM | 17,579 | 10-08-01 | Add_Family_History.cfm |
| ADD_M˜18 | CFM | 18,871 | 10-08-01 | Add_Marriage_Certificate.cfm |
| ADD_S˜20 | CFM | 18,936 | 10-08-01 | Add_Spouse_Death_Certificate.cfm |
| ADD_V˜22 | CFM | 33,381 | 10-08-01 | Add_Vendor_Company_Info.cfm |
| ADD_V˜24 | CFM | 13,724 | 10-08-01 | Add_Vendor_Contact_Info.cfm |
| ADD_V˜26 | CFM | 15,273 | 10-08-01 | Add_Vendor_Login_Info.cfm |
| AFFIL˜30 | CFM | 14,631 | 10-08-01 | Affiliate_Program.cfm |
| ASSETS | CFM | 27,578 | 10-08-01 | Assets.cfm |
| AUTHE˜34 | CFM | 601 | 10-08-01 | Authenticate.cfm |
| AUTHE˜36 | CFM | 579 | 10-08-01 | Authenticate_Vendor.cfm |
| BIRTH˜11 | <DIR> | | 10-08-01 | birth_certificates |
| BIRTH˜42 | CFM | 18,788 | 10-08-01 | Birth_Records.cfm |
| BUSIN˜44 | CFM | 15,112 | 10-08-01 | Business_Detail.cfm |
| BUSIN˜46 | CFM | 15,097 | 10-08-01 | Business_Detail2.cfm |
| CAR_P˜13 | <DIR> | | 10-08-01 | car_photos |
| CCARD˜50 | CFM | 1,506 | 10-08-01 | Ccard_Process.cfm |
| CCARD˜52 | CFM | 1,380 | 10-08-01 | Ccard_Process_Good.cfm |
| CCFORM | CFM | 18,476 | 10-08-01 | Ccform.cfm |
| COLUMNS | CFM | 644 | 10-08-01 | Columns.cfm |
| COLUMNS2 | CFM | 644 | 10-08-01 | Columns2.cfm |
| COLUMNS3 | CFM | 644 | 10-08-01 | Columns3.cfm |
| COLUMNS4 | CFM | 644 | 10-08-01 | Columns4.cfm |
| COLDMNS5 | CFM | 644 | 10-08-01 | Columns5.cfm |
| COLDMNS6 | CFM | 644 | 10-08-01 | Columns6.cfm |
| COLUMNS7 | CFM | 644 | 10-08-01 | Columns7.cfm |
| COLUMNS8 | CFM | 644 | 10-08-01 | Columns8.cfm |
| COLUMNS9 | CFM | 644 | 10-08-01 | Columns9.cfm |
| COMPA˜74 | CEM | 19,212 | 10-08-01 | Company_Info.cfm |
| CONTA˜76 | CFM | 20,681 | 10-08-01 | Contact_Info.cfm |
| CORPO˜15 | <DIR> | | 10-08-01 | corporate_assets |
| CUSTO˜80 | CFM | 5,524 | 10-08-01 | Customer_Service.cfm |
| CUSTO˜82 | HTM | 5,524 | 10-08-01 | Customer_Service.html |
| CUSTO˜84 | CFM | 16,739 | 10-08-01 | Customer_Welcome.cfm |
| DEBTS | <DIR> | | 10-08-01 | debts |
| DELET˜88 | CFM | 15,286 | 10-08-01 | Delete_Birth_Certificate.cfm |
| DELET˜90 | CFM | 16,344 | 10-08-01 | Delete_Emergency_Contact.cfm |
| DELET˜92 | CFM | 15,315 | 10-08-01 | Delete_Marriage_Certificate.cfm |
| DELET˜94 | CFM | 15,345 | 10-08-01 | Delete_Spouse_Death_Certificate.cfm |
| DEPEN˜19 | <DIR> | | 10-08-01 | dependents |
| DETAIL | CFM | 19,800 | 10-08-01 | Detail.cfm |
| DISCH˜21 | <DIR> | | 10-08-01 | discharge_papers |
| DOCU˜102 | CFM | 30,897 | 10-08-01 | Documents.cfm |
| EDIT˜104 | HTM | 139 | 10-08-01 | Edit1.html |
| EDIT˜108 | CFM | 19,494 | 10-08-01 | Edit_Birth_Certificate.cfm |
| EDIT˜110 | CFM | 22,706 | 10-08-01 | Edit_Emergency_Contact.cfm |
| EDIT˜112 | CFM | 19,555 | 10-08-01 | Edit_Marriage_Certificate.cfm |
| EDIT˜114 | CFM | 19,671 | 10-08-01 | Edit_Spouse_Death_Certificate.cfm |
| EMAI˜116 | CFM | 12,367 | 10-08-01 | Email_List.cfm |
| EMCHK | CFM | 552 | 10-08-01 | Emchk.cfm |
| EMER˜120 | CFM | 18,214 | 10-08-01 | Emergency_Contacts.cfm |
| ENDO˜122 | CFM | 18,667 | 10-08-01 | Endoflife.cfm |
| ENHA˜124 | CFM | 3,677 | 10-08-01 | Enhanced_Listing_Benefits.cfm |
| EQUIT˜23 | <DIR> | | 10-08-01 | equity_accounts |
| FAMI˜128 | CFM | 21,861 | 10-08-01 | Family_History.cfm |
| FUNER˜25 | <DIR> | | 10-08-01 | funeral_arrangements |
| FURNI˜27 | <DIR> | | 10-08-01 | furniture |
| FURNI˜29 | <DIR> | | 10-08-01 | furniture_photos |
| HM_A˜136 | Js | 8,850 | 10-08-01 | Hm_Arrays.js |
| HM_L˜138 | Js | 2,772 | 10-08-01 | Hm_Loader.js |
| HM_S˜140 | JPG | 29,020 | 10-08-01 | Hm_Scriptdom.js |
| HM_S˜142 | JPG | 28,254 | 10-08-01 | Hm_Scriptie4.js |
| HM_S˜144 | JPG | 24,468 | 10-08-01 | Hm_Scriptns4.js |
| INDE˜146 | HTM | 13,886 | 10-08-01 | Index.html |
| INSUR˜31 | <DIR> | | 10-08-01 | insurace_certificates |
| INSUR˜33 | <DIR> | | 10-08-01 | insurance |
| ISEMAIL | CFM | 5,848 | 10-08-01 | Isemail.cfm |
| JEWELRY | <DIR> | | 10-08-01 | jewelry |
| JEWEL˜37 | <DIR> | | 10-08-01 | jewelry_photos |
| KIT | <DIR> | | 10-08-01 | kit |
| LIVIN˜41 | <DIR> | | 10-08-01 | living_memorial |
| LIVI˜162 | CFM | 19,821 | 10-08-01 | Living_Trust.cfm |
| LIVIN˜43 | <DIR> | | 10-08-01 | living_will |
| LIVI˜166 | CFM | 12,740 | 10-08-01 | Living_Trust_Form.cfm |
| LIVIN˜45 | <DIR> | | 10-08-01 | living_will2 |
| LOGI˜170 | CFM | 18,735 | 10-08-01 | Login_Info.cfm |
| MARRI˜47 | <DIR> | | 10-08-01 | marriage_certificates |
| MEDIC˜49 | <DIR> | | 10-08-01 | medical_history |
| MEMB˜176 | CFM | 15,921 | 10-08-01 | Member_Login.cfm |
| MEMB˜178 | CFM | 33,381 | 10-08-01 | Member_Signup.cfm |
| MEMOR˜51 | <DIR> | | 10-08-01 | memorial_photos |
| MILIT˜53 | <DIR> | | 10-08-01 | military_service |
| MOTOR˜55 | <DIR> | | 10-08-01 | motor_vehicles |
| OBLI˜186 | CFM | 16,750 | 10-08-01 | Obligations.cfm |
| OCCU˜188 | CFM | 17,718 | 10-08-01 | Occupation.cfm |
| PAYM˜190 | CFM | 15,623 | 10-08-01 | Payment_Confirmation.cfm |
| PAYM˜192 | CFM | 28,092 | 10-08-01 | Payment_Form.cfm |
| PAYM˜194 | CFM | 19,054 | 10-08-01 | Payment_Form2.cfm |
| PAYM˜196 | CFM | 34,438 | 10-08-01 | Payment_Form3.cfm |
| PERSO˜57 | <DIR> | | 10-08-01 | personal_property |
| PERSO˜59 | <DIR> | | 10-08-01 | personal_property_photos |
| PERSO˜61 | <DIR> | | 10-08-01 | personally_held_stocks |
| PETS | <DIR> | | 10-08-01 | pets |
| PINK_˜65 | <DIR> | | 10-08-01 | pink_slips |
| PRIN˜208 | CFM | 5,586 | 10-08-01 | Print_Document.cfm |
| REDIRECT | CFM | 160 | 10-08-01 | Redirect.cfm |
| REGI˜212 | CFM | 668 | 10-08-01 | Registration_Complete.cfm |
| RESO˜214 | HTM | 9,950 | 10-08-01 | Resource_Locator.html |
| RESU˜216 | CFM | 5,111 | 10-08-01 | Resultpages.cfm |
| RETIR˜67 | <DIR> | | 10-08-01 | retirement_accounts |
| ROWS | CFM | 755 | 10-08-01 | Rows.cfm |
| SAFET˜69 | <DIR> | | 10-08-01 | safety_deposit_boxes |
| SEARCH | CFM | 13,219 | 10-08-01 | Search.cfm |
| SEAR˜226 | CFM | 2,477 | 10-08-01 | Search_Data.cfm |
| SERV˜228 | CFM | 15,554 | 10-08-01 | Service_Providers.cfm |
| SERV˜230 | HTM | 15,554 | 10-08-01 | Service_Providers.html |
| SIDE˜232 | CFM | 3,761 | 10-08-01 | Side_Menu.cfm |
| SIGN˜234 | CFM | 22,369 | 10-08-01 | Signup_Answers.cfm |
| SIGN˜236 | CFM | 15,034 | 10-08-01 | Signup_Questions.cfm |
| SPEC˜240 | CFM | 33,501 | 10-08-01 | Special_Payment_Form.cfm |
| SPOUS˜71 | <DIR> | | 10-08-01 | spouse_death_certificates |
| TEST˜244 | HTM | 3,820 | 10-08-01 | Test2.html |
| TEST˜246 | HTM | 5,764 | 10-08-01 | Test.html |
| TISSU˜73 | <DIR> | | 10-08-01 | tissue_donations |
| UPDA˜250 | CFM | 15,522 | 10-08-01 | Update_Vendor_Program2.cfm |
| UPDA˜252 | CFM | 16,859 | 10-08-01 | Update_Vendor_Login_Info.cfm |
| UPDA˜254 | CFM | 852 | 10-08-01 | Update_Vendor2.cfm |
| UPDA˜256 | CFM | 34,254 | 10-08-01 | Update_Vendor_Program.cfm |
| UPDA˜258 | CFM | 852 | 10-08-01 | Update_Vendor3.cfm |
| UPDA˜260 | CFM | 1,522 | 10-08-01 | Update_Listing_Ccard_Process.cfm |
| UPDA˜262 | CFM | 14,637 | 10-08-01 | Update_Listing_Order_Confirmation.cfm |
| UPDA˜264 | CFM | 39,352 | 10-08-01 | Update_Vendor_Company_Info.cfm |
| UPDA˜266 | CFM | 18,256 | 10-08-01 | Update_Vendor_Contact_Info.cfm |
| VEND˜268 | CFM | 35,439 | 10-08-01 | Vendor_Offered_Services.cfm |
| VEND˜270 | CFM | 16,859 | 10-08-01 | Vendor_Login.cfm |
| VEND˜272 | CFM | 13,754 | 10-08-01 | Vendor_Search2.cfm |
| VEND˜274 | CFM | 17,748 | 10-08-01 | Vendor_Details.cfm |
| VEND˜276 | CFM | 13,404 | 10-08-01 | Vendor_Resources.cfm |
| VEND˜278 | CFM | 14,026 | 10-08-01 | Vendor_Search.cfm |
| VEND˜280 | CFM | 13,404 | 10-08-01 | Vendor_Report.cfm |
| VEND˜282 | CFM | 38,715 | 10-08-01 | Vendor_Signup.cfm |
| VEND˜284 | CFM | 18,839 | 10-08-01 | Vendor_Login_Info.cfm |
| VEND˜286 | CFM | 19,678 | 10-08-01 | Vendor_Billing_Info.cfm |
| VEND˜288 | CFM | 18,186 | 10-08-01 | Vendor_Contact_Info.cfm |
| VEND˜290 | CFM | 17,623 | 10-08-01 | Vendor_Detail.cfm |
| VEND˜292 | CFM | 13,418 | 10-08-01 | Vendor_Detail_Listing.cfm |
| 108 file(s) | | | | |
| 1,522,679 | | | | |
| bytes | | | | |
| Directory of | | | | |
| cf\accounts | | | | |
| ADBANNER | CFM | 1,658 | 10-08-01 | Adbanner.cfm |
| ADD | CFM | 24,154 | 10-08-01 | Add.cfm |
| DELETE | CFM | 17,977 | 10-08-01 | Delete.cfm |
| EDIT | CFM | 25,168 | 10-08-01 | Edit.cfm |
| HM_LO˜14 | Js | 2,772 | 10-08-01 | Hm_Loader.js |
| HM_SC˜16 | Js | 29,020 | 10-08-01 | Hm_Scriptdom.js |
| HM_SC˜18 | Js | 28,254 | 10-08-01 | Hm_Scriptie4.js |
| HM_SC˜20 | Js | 24,468 | 10-08-01 | Hm_Scriptns4.js |
| PRINT˜22 | CFM | 6,972 | 10-08-01 | Print_Document.cfm |
| RESULTS | CFM | 20,122 | 10-08-01 | Results.cfm |
| 10 file(s) | | | | |
| 180,565 | | | | |
| bytes | | | | |
| Directory of | | | | |
| cf\birth_{—} | | | | |
| certificates | | | | |
| ACF1558 | PDF | 81,814 | 10-08-01 | Acf1558.pdf |
| ACF2154 | PDF | 81,814 | 10-08-01 | Acf2154.pdf |
| ACF2157 | PDF | 81,814 | 10-08-01 | Acf2157.pdf |
| ACF30F2 | PDF | 81,814 | 10-08-01 | Acf30f2.pdf |
| ACF3331 | PDF | 81,814 | 10-08-01 | Acf3331.pdf |
| ACF657 | PDF | 81,814 | 10-08-01 | Acf657.pdf |
| ACFBB | PDF | 81,814 | 10-08-01 | Acfbb.pdf |
| ACFBE | PDF | 81,814 | 10-08-01 | Acfbe.pdf |
| AK854˜22 | JPG | 35,686 | 10-08-01 | Ak8549-001.jpg |
| NEW | JPG | 3,858 | 10-08-01 | New.jpg |
| UNKNOWN | PDF | 81,814 | 10-08-01 | Unknown.pdf |
| 11 file(s) | | | | |
| 775,870 | | | | |
| bytes | | | | |
| Directory of | | | | |
| cf\car_photos | | | | |
| 3TRUCKS | JPG | 35,700 | 10-08-01 | 3trucks.jpg |
| 3TRUCKS2 | JPG | 98,206 | 10-08-01 | 3trucks2.jpg |
| AT329˜10 | JPG | 26,090 | 10-08-01 | At3298-001.jpg |
| TRUCK | JPG | 98,206 | 10-08-01 | Truck.jpg |
| | 4 | | | |
| | file(s) | | | |
| | 258,202 | | | |
| | bytes | | | |
| Directory of | | | | |
| cf\corporate_{—} | | | | |
| assets | | | | |
| ADBANNER | CFM | 1,658 | 10-08-01 | Adbanner.cfm |
| ADD | CFM | 23,580 | 10-08-01 | Add.cfm |
| DELETE | CFM | 17,868 | 10-08-01 | Delete.cfm |
| EDIT | CFM | 24,506 | 10-08-01 | Edit.cfm |
| HM_AR˜14 | js | 8,850 | 10-08-01 | Hm_Arrays.js |
| HM_LO˜16 | js | 2,772 | 10-08-01 | Hm_Loader.js |
| HM_SC˜18 | JPG | 29,020 | 10-08-01 | Hm_Scriptdom.js |
| HM_SC˜20 | JPG | 28,254 | 10-08-01 | Hm_Scriptie4.js |
| HM_SC˜22 | JPG | 24,468 | 10-08-01 | Hm_Scriptns4.js |
| PRINT˜24 | CFM | 6,682 | 10-08-01 | Print_Document.cfm |
| RESULTS | CFM | 19,801 | 10-08-01 | Results.cfm |
| 11 file(s) | | | | |
| 187,459 | | | | |
| bytes | | | | |
| Directory of | | | | |
| cf\debts | | | | |
| ADBANNER | CFM | 1,658 | 10-08-01 | Adbanner.cfm |
| ADD | CFM | 25,325 | 10-08-01 | Add.cfm |
| ADD_D˜10 | CFM | 22,830 | 10-08-01 | Add_Debtor.cfm |
| DELETE | CFM | 15,597 | 10-08-01 | Delete.cfm |
| EDIT | CFM | 29,553 | 10-08-01 | Edit.cfm |
| HM_LO˜16 | js | 2,772 | 10-08-01 | Hm_Loader.js |
| HM_SC˜18 | JPG | 29,020 | 10-08-01 | Hm_Scriptdom.js |
| HM_SC˜20 | JPG | 28,254 | 10-08-01 | Hm_Scriptie4.js |
| HM_SC˜22 | JPG | 24,468 | 10-08-01 | Hm_Scriptns4.js |
| PRINT˜24 | CFM | 9,482 | 10-08-01 | Print_Document.cfm |
| RESULTS | CFM | 20,224 | 10-08-01 | Results.cfm |
| 11 file(s) | | | | |
| 209,183 | | | | |
| bytes | | | | |
| Directory of | | | | |
| cf\dependents | | | | |
| ADBANNER | CFM | 1,658 | 10-08-01 | Adbanner.cfm |
| ADD | CFM | 20,226 | 10-08-01 | Add.cfm |
| ADD_D˜10 | CFM | 22,830 | 10-08-01 | Add_Debtor.cfm |
| ADD_PDF | CFM | 19,621 | 10-08-01 | Add_Pdf.cfm |
| DELETE | CFM | 15,489 | 10-08-01 | Delete.cfm |
| DELET˜16 | CFM | 15,374 | 10-08-01 | Delete_Pdf.cfm |
| EDIT | CFM | 20,250 | 10-08-01 | Edit.cfm |
| EDIT_PDF | CFM | 19,653 | 10-08-01 | Edit_Pdf.cfm |
| HM_AR˜22 | js | 8,850 | 10-08-01 | Hm_Arrays.js |
| HM_LO˜24 | js | 2,772 | 10-08-01 | Hm_Loader.js |
| HM_SC˜26 | JPG | 29,020 | 10-08-01 | Hm_Scriptdom.js |
| HM_SC˜28 | JPG | 28,254 | 10-08-01 | Hm_Scriptie4.js |
| HM_SC˜30 | JPG | 24,468 | 10-08-01 | Hm_Scriptns4.js |
| PRINT˜32 | CFM | 6,350 | 10-08-01 | Print_Document.cfm |
| RESULTS | CFM | 17,335 | 10-08-01 | Results.cfm |
| 15 file(s) | | | | |
| 252,150 | | | | |
| bytes | | | | |
| Directory of | | | | |
| cf\discharge_{—} | | | | |
| papers | | | | |
| ACF23D4 | PDF | 81,814 | 10-08-01 | Acf23d4.pdf |
| ACF6B9 | PDF | 81,814 | 10-08-01 | Acf6b9.pdf |
| ACF6BC | PDF | 81,814 | 10-08-01 | Acf6bc.pdf |
| UNKNOWN | PDF | 81,814 | 10-08-01 | Unknown.pdf |
| | 4 | | | |
| | file(s) | | | |
| | 327,256 | | | |
| | bytes | | | |
| Directory of | | | | |
| cf\equity_{—} | | | | |
| accounts | | | | |
| ADBANNER | CFM | 1,658 | 10-08-01 | Adbanner.cfm |
| ADD | CFM | 24,719 | 10-08-01 | Add.cfm |
| DELETE | CFM | 17,515 | 10-08-01 | Delete.cfm |
| EDIT | CFM | 25,284 | 10-08-01 | Edit.cfm |
| HM_AR˜14 | js | 8,850 | 10-08-01 | Hm_Arrays.js |
| HM_LO˜16 | js | 2,772 | 10-08-01 | Hm_Loader.js |
| HM_SC˜18 | JPG | 29,020 | 10-08-01 | Hm_Scriptdom.js |
| HM_SC˜20 | JPG | 28,254 | 10-08-01 | Hm_Scriptie4.js |
| HM_SC˜22 | JPG | 24,468 | 10-08-01 | Hm_Scriptns4.js |
| PRINT˜24 | CFM | 6,770 | 10-08-01 | Print_Document.cfm |
| RESULTS | CFM | 19,754 | 10-08-01 | Results.cfm |
| 11 file(s) | | | | |
| 189,064 | | | | |
| bytes | | | | |
| Directory of | | | | |
| cf\funeral_{—} | | | | |
| arrangements | | | | |
| ADBANNER | CFM | 1,658 | 10-08-01 | Adbanner.cfm |
| ADD | CFM | 3,257 | 10-08-01 | Add.cfm |
| ADD_C˜10 | CFM | 15,433 | 10-08-01 | Add_Cemetery.cfm |
| ADD_F˜12 | CFM | 15,481 | 10-08-01 | Add_Funeral_Home.cfm |
| ADD_R˜14 | CFM | 20,969 | 10-08-01 | Add_Responsible_Party.cfm |
| ADD_V˜16 | CFM | 15,436 | 10-08-01 | AddVendor.cfm |
| DELETE | CFM | 15,113 | 10-08-01 | Delete.cfm |
| EDIT | CFM | 36,978 | 10-08-01 | Edit.cfm |
| FIND_˜22 | CFM | 17,951 | 10-08-01 | Find_Cemetery.cfm |
| FIND_˜24 | CFM | 17,945 | 10-08-01 | Find_Funeral_Home.cfm |
| FIND_˜26 | CFM | 27,985 | 10-08-01 | Find_Step3_Vendor.cfm |
| FIND_˜28 | CFM | 29,715 | 10-08-01 | Find_Step4_Vendor.cfm |
| FIND_˜30 | CFM | 31,228 | 10-08-01 | Find_Step5_Vendor.cfm |
| FIND_˜32 | CFM | 17,947 | 10-08-01 | Find_Vendor.cfm |
| HM_AR˜34 | js | 8,850 | 10-08-01 | Hm_Arrays.js |
| HM_LO˜36 | js | 2,772 | 10-08-01 | Hm_loader.js |
| HM_SC˜38 | JPG | 29,020 | 10-08-01 | Hm_Scriptdom.js |
| HM_SC˜40 | JPG | 28,254 | 10-08-01 | Hm_Scriptie4.js |
| HM_SC˜42 | JPG | 24,468 | 10-08-01 | Hm_Scriptns4.js |
| PRINT˜44 | CFM | 16,756 | 10-08-01 | Print_Document.cfm |
| RESULTS | CFM | 27,577 | 10-08-01 | Results.cfm |
| RESUL˜48 | CFM | 5,111 | 10-08-01 | Resultpages.cfm |
| REVIE˜50 | CFM | 4,463 | 10-08-01 | Review_Record.cfm |
| ROWS | CFM | 755 | 10-08-01 | Rows.cfm |
| STEP1 | CFM | 16,299 | 10-08-01 | Step1.cfm |
| STEP10 | CFM | 17,269 | 10-08-01 | Step10.cfm |
| STEP2 | CFM | 16,897 | 10-08-01 | Step2.cfm |
| STEP3 | CFM | 18,575 | 10-08-01 | Step3.cfm |
| STEP4 | CFM | 19,367 | 10-08-01 | Step4.cfm |
| STEP5 | CFM | 21,136 | 10-08-01 | Step5.cfm |
| STEP6 | CFM | 20,179 | 10-08-01 | Step6.cfm |
| STEP7 | CFM | 27,982 | 10-08-01 | Step7.cfm |
| STEP8 | CFM | 18,860 | 10-08-01 | Step8.cfm |
| STEP9 | CFM | 17,394 | 10-08-01 | Step9.cfm |
| VENDO˜74 | CFM | 18,599 | 10-08-01 | Vendor_Details.cfm |
| VENDO˜76 | CFM | 19,906 | 10-08-01 | Vendor_Details2.cfm |
| VENDO˜78 | CFM | 19,478 | 10-08-01 | Vendor_Details3.cfm |
| 37 file(s) | | | | |
| 667,063 | | | | |
| bytes | | | | |
| Directory of | | | | |
| cf\furniture | | | | |
| ADBANNER | CFM | 1,658 | 10-08-01 | Adbanner.cfm |
| ADD | CFM | 21,687 | 10-08-01 | Add.cfm |
| ADD_PIX | CFM | 21,406 | 10-08-01 | Add_Pix.cfm |
| DELETE | CFM | 17,490 | 10-08-01 | Delete.cfm |
| DELET˜14 | CFM | 17,536 | 10-08-01 | Delete_Pix.cfm |
| EDIT | CFM | 22,588 | 10-08-01 | Edit.cfm |
| EDIT_PIX | CFM | 21,849 | 10-08-01 | Edit_Pix.cfm |
| HM_AR˜20 | js | 8,850 | 10-08-01 | Hm_Arrays.js |
| HM_LO˜22 | js | 2,772 | 10-08-01 | Hm_Loader.js |
| HM_SC˜24 | JPG | 29,020 | 10-08-01 | Hm_Scriptdom.js |
| HM_SC˜26 | JPG | 28,254 | 10-08-01 | Hm_Scriptie4.js |
| HM_SC˜28 | JPG | 24,468 | 10-08-01 | Hm_Scriptns4.js |
| PRINT˜30 | CFM | 6,419 | 10-08-01 | Print_Document.cfm |
| RESULTS | CFM | 19,702 | 10-08-01 | Results.cfm |
| 14 file(s) | | | | |
| 243,699 | | | | |
| bytes | | | | |
| Directory of | | | | |
| cf\furniture_{—} | | | | |
| photos | | | | |
| AB36163 | JPG | 114,150 | 10-08-01 | Ab36163.jpg |
| AK8946˜8 | JPG | 75,589 | 10-08-01 | Ak8946-001.jpg |
| | 2 file(s) | | | |
| | 189,739 | | | |
| | bytes | | | |
| Directory of | | | | |
| cf\insurace_{—} | | | | |
| certificates | | | | |
| ACF11D0 | PDF | 81,814 | 10-08-01 | Acf11d0.pdf |
| ACF20B3 | PDF | 81,814 | 10-08-01 | Acf20b3.pdf |
| UNKNOWN | PDF | 81,814 | 10-08-01 | Unknown.pdf |
| | 3 file(s) | | | |
| | 245,442 | | | |
| | bytes | | | |
| Directory of | | | | |
| cf\insurance | | | | |
| ADBANNER | CFM | 1,658 | 10-08-01 | Adbanner.cfm |
| ADD | CFM | 35,022 | 10-08-01 | Add.cfm |
| ADD_B˜10 | CFM | 24,338 | 10-08-01 | Add_Beneficiary.cfm |
| ADD_PDF | CFM | 21,851 | 10-08-01 | Add_Pdf.cfm |
| DELETE | CFM | 17,966 | 10-08-01 | Delete.cfm |
| DELET˜16 | CFM | 16,633 | 10-08-01 | Delete_Pdf.cfm |
| EDIT | CFM | 33,563 | 10-08-01 | Edit.cfm |
| EDIT_PDF | CFM | 22,005 | 10-08-01 | Edit_Pdf.cfm |
| HM_AR˜22 | js | 8,850 | 10-08-01 | Hm_Arrays.js |
| HM_LO˜24 | js | 2,772 | 10-08-01 | Hm_Loader.js |
| HM_SC˜26 | JPG | 29,020 | 10-08-01 | Hm_Scriptdom.js |
| HM_SC˜28 | JPG | 28,254 | 10-08-01 | Hm_Scriptie4.js |
| HM_SC˜30 | JPG | 24,468 | 10-08-01 | Hm_Scriptns4.js |
| PRINT˜32 | CFM | 10,432 | 10-08-01 | Print_Document.cfm |
| RESULTS | CFM | 23,406 | 10-08-01 | Results.cfm |
| 15 file(s) | | | | |
| 300,238 | | | | |
| bytes | | | | |
| Directory of | | | | |
| cf\jewelry | | | | |
| ADBANNER | CFM | 1,658 | 10-08-01 | Adbanner.cfm |
| ADD | CFM | 21,460 | 10-08-01 | Add.cfm |
| ADD_PIX | CFM | 21,330 | 10-08-01 | Add_Pix.cfm |
| DELETE | CFM | 17,558 | 10-08-01 | Delete.cfm |
| DELET˜14 | CFM | 17,515 | 10-08-01 | Delete_Pix.cfm |
| EDIT | CFM | 22,284 | 10-08-01 | Edit.cfm |
| HM_AR˜18 | js | 8,850 | 10-08-01 | Hm_Arrays.js |
| HM_LO˜20 | js | 2,772 | 10-08-01 | Hm_Loader.js |
| HM_SC˜22 | JPG | 29,020 | 10-08-01 | Hm_Scriptdom.js |
| HM_SC˜24 | JPG | 28,254 | 10-08-01 | Hm_Scriptie4.js |
| HM_SC˜26 | JPG | 24,468 | 10-08-01 | Hm_Scriptns4.js |
| PRINT˜28 | CFM | 6,058 | 10-08-01 | Print_Document.cfm |
| RESULTS | CFM | 19,312 | 10-08-01 | Results.cfm |
| 13 file(s) | | | | |
| 220,539 | | | | |
| bytes | | | | |
| Directory of | | | | |
| cf\jewelry_{—} | | | | |
| photos | | | | |
| AK8949˜6 | JPG | 71,210 | 10-08-01 | Ak8949-001.jpg |
| AR5467˜8 | JPG | 53,457 | 10-08-01 | Ar5467-001.jpg |
| ROSES | GIF | 14,372 | 10-08-01 | Roses.gif |
| T105-˜12 | JPG | 132,286 | 10-08-01 | T105-multi.jpg |
| | 4 file(s) | | | |
| | 271,325 | | | |
| | bytes | | | |
| Directory of | | | | |
| cf\kit | | | | |
| ORDER_˜6 | CFM | 38 | 10-08-01 | Order_Form.cfm |
| | 1 file(s) | | | |
| | 38 bytes | | | |
| Directory of | | | | |
| cf\living_{—} | | | | |
| memorial | | | | |
| ADBANNER | CFM | 1,658 | 10-08-01 | Adbanner.cfm |
| ADD | CFM | 16,890 | 10-08-01 | Add.cfm |
| ADD_C˜10 | CFM | 15,431 | 10-08-01 | Add_Cemetery.cfm |
| ADD_PIX | CFM | 19,163 | 10-08-01 | Add_Pix.cfm |
| ADD_R˜14 | CFM | 20,507 | 10-08-01 | Add_Responsible_Party.cfm |
| COLUMNS | CFM | 639 | 10-08-01 | Columns.cfm |
| DELETE | CFM | 15,111 | 10-08-01 | Delete.cfm |
| EDIT | CFM | 30,357 | 10-08-01 | Edit.cfm |
| FIND_˜22 | CFM | 17,949 | 10-08-01 | Find_Cemetery.cfm |
| HM_AR˜24 | js | 8,850 | 10-08-01 | Hm_Arrays.js |
| HM_LO˜26 | js | 2,772 | 10-08-01 | Hm_Loader.js |
| HM_SC˜28 | JPG | 29,020 | 10-08-01 | Hm_Scriptdom.js |
| HM_SC˜30 | JPG | 28,254 | 10-08-01 | Hm_Scriptie4.js |
| HM_SC˜32 | JPG | 24,468 | 10-08-01 | Hm_Scriptns4.js |
| PHOTO˜38 | CFM | 17,033 | 10-08-01 | Photo_Album.cfm |
| RESULTS | CFM | 24,302 | 10-08-01 | Results.cfm |
| RESUL˜42 | CFM | 5,111 | 10-08-01 | Resultpages.cfm |
| REVIE˜44 | CFM | 4,463 | 10-08-01 | Review_Record.cfm |
| ROWS | CFM | 755 | 10-08-01 | Rows.cfm |
| STEP1 | CFM | 19,164 | 10-08-01 | Step1.cfm |
| STEP2 | CFM | 19,675 | 10-08-01 | Step2.cfm |
| STEP3 | CFM | 23,420 | 10-08-01 | Step3.cfm |
| STEP4 | CFM | 23,962 | 10-08-01 | Step4.cfm |
| 23 file(s) | | | | |
| 368,954 | | | | |
| bytes | | | | |
| Directory of | | | | |
| cf\living | | | | |
| will | | | | |
| ADBANNER | CFM | 1,658 | 10-08-01 | Adbanner.cfm |
| ADD | CFM | 26,148 | 10-08-01 | Add.cfm |
| ADD_R˜10 | CFM | 20,857 | 10-08-01 | Add_Responsible_Party.cfm |
| DELETE | CFM | 15,113 | 10-08-01 | Delete.cfm |
| DENI_˜14 | GIF | 2,046 | 10-08-01 | Deni_Logo_Living_Will.gif |
| EDIT | CFM | 40,148 | 10-08-01 | Edit.cfm |
| FUNER˜18 | CFM | 16,135 | 10-08-01 | Funeral_Arrangement.cfm |
| HM_AR˜20 | js | 8,850 | 10-08-01 | Hm_Arrays.js |
| HM_LO˜22 | js | 2,772 | 10-08-01 | Hm_Loader.js |
| HM_SC˜24 | JPG | 29,020 | 10-08-01 | Hm_Scriptdom.js |
| HM_SC˜26 | JPG | 28,254 | 10-08-01 | Hm_Scriptie4.js |
| HM_SC˜28 | JPG | 24,468 | 10-08-01 | Hm_Scriptns4.js |
| OLD_I˜30 | HTM | 14,178 | 10-08-01 | Old_Intro.html |
| PRINT˜32 | CFM | 10,994 | 10-08-01 | Print_Card.cfm |
| PRINT˜34 | CFM | 24,707 | 10-08-01 | Print_Document.cfm |
| RESULTS | CFM | 36,341 | 10-08-01 | Results.cfm |
| STEP2 | CFM | 32,792 | 10-08-01 | Step2.cfm |
| 17 file(s) | | | | |
| 334,481 | | | | |
| bytes | | | | |
| Directory of | | | | |
| cf\living_{—} | | | | |
| will2 | | | | |
| ADBANNER | CFM | 1,658 | 10-08-01 | Adbanner.cfm |
| ADD | CFM | 29,111 | 10-08-01 | Add.cfm |
| ADD_R˜10 | CFM | 20,815 | 10-08-01 | Add_Responsible_Party.cfm |
| CCARD˜12 | CFM | 1,496 | 10-08-01 | Ccard_Process.cfm |
| DELETE | CFM | 15,071 | 10-08-01 | Delete.cfm |
| DENI_˜16 | GIF | 2,046 | 10-08-01 | Deni_Logo_Living_Will.gif |
| EDIT | CFM | 40,106 | 10-08-01 | Edit.cfm |
| FUNER˜20 | CFM | 16,093 | 10-08-01 | Funeral_Arrangement.cfm |
| HM_AR˜22 | js | 8,850 | 10-08-01 | Hm_Arrays.js |
| HM_LO˜24 | js | 2,772 | 10-08-01 | Hm_Loader.js |
| HM_SC˜26 | JPG | 29,020 | 10-08-01 | Hm_Scriptdom.js |
| HM_SC˜28 | JPG | 28,254 | 10-08-01 | Hm_Scriptie4.js |
| HM_SC˜30 | JPG | 24,468 | 10-08-01 | Hm_Scriptns4.js |
| PAYME˜32 | CFM | 15,484 | 10-08-01 | Payment_Confirmation.cfm |
| PRINT˜34 | CFM | 10,952 | 10-08-01 | Print_Card.cfm |
| PRINT˜36 | CFM | 24,665 | 10-08-01 | Print_Document.cfm |
| RESULTS | CFM | 36,299 | 10-08-01 | Results.cfm |
| STEP2 | CFM | 32,750 | 10-08-01 | Step2.cfm |
| 18 file(s) | | | | |
| 339,910 | | | | |
| bytes | | | | |
| Directory of | | | | |
| cf\marriage_{—} | | | | |
| certificates | | | | |
| ACF66E | PDF | 81,814 | 10-08-01 | Acf66e.pdf |
| AR3096˜8 | JPG | 22,254 | 10-08-01 | Ar3096-002.jpg |
| UNKNOWN | PDF | 81,814 | 10-08-01 | Unknown.pdf |
| | 3 file(s) | | | |
| | 185,882 | | | |
| | bytes | | | |
| Directory of | | | | |
| cf\medical_{—} | | | | |
| history | | | | |
| ADBANNER | CFM | 1,658 | 10-08-01 | Adbanner.cfm |
| ADD | CPM | 24,193 | 10-08-01 | Add.cfm |
| DELETE | CFM | 15,112 | 10-08-01 | Delete.cfm |
| EDIT | CFM | 26,440 | 10-08-01 | Edit.cfm |
| HM_AR˜14 | js | 8,850 | 10-08-01 | Hm_Arrays.js |
| HM_LO˜16 | js | 2,772 | 10-08-01 | Hm_Loader.js |
| HM_SC˜18 | JPG | 29,020 | 10-08-01 | Hm_Scriptdom.js |
| HM_SC˜20 | JPG | 28,254 | 10-08-01 | Hm_Scriptie4.js |
| HM_SC˜22 | JPG | 24,468 | 10-08-01 | Hm_Scriptns4.js |
| PRINT˜24 | CFM | 9,850 | 10-08-01 | Print_Document.cfm |
| RESULTS | CFM | 20,563 | 10-08-01 | Results.cfm |
| 11 file(s) | | | | |
| 191,180 | | | | |
| bytes | | | | |
| Directory of | | | | |
| cf\memorial_{—} | | | | |
| photos | | | | |
| ACF533 | JPG | 53,457 | 10-08-01 | Acf533.jpg |
| ACF546 | JPG | 53,457 | 10-08-01 | Acf546.jpg |
| ACF554 | JPG | 53,457 | 10-08-01 | Acf554.jpg |
| ACF556 | JPG | 53,457 | 10-08-01 | Acf556.jpg |
| AK855˜14 | JPG | 27,985 | 10-08-01 | Ak8554-001.jpg |
| AK893˜16 | JPG | 43,608 | 10-08-01 | Ak8932-002.jpg |
| AK894˜18 | JPG | 71,210 | 10-08-01 | Ak8949-001.jpg |
| AR546˜20 | JPG | 53,457 | 10-08-01 | Ar5467-001.jpg |
| BES_017 | JPG | 39,947 | 10-08-01 | Bes_017.jpg |
| CB827˜24 | JPG | 104,789 | 10-08-01 | Cb8273-001.jpg |
| LA177˜26 | JPG | 79,655 | 10-08-01 | La1772-003.jpg |
| TEST | JPG | 53,457 | 10-08-01 | Test.jpg |
| 12 filets) | | | | |
| 687,936 | | | | |
| bytes | | | | |
| Directory of | | | | |
| cf\military_{—} | | | | |
| service | | | | |
| ADBANNER | CFM | 1,658 | 10-08-01 | Adbanner.cfm |
| ADD | CFM | 20,051 | 10-08-01 | Add.cfm |
| ADD_PDF | CFM | 19,647 | 10-08-01 | Add_Pdf.cfm |
| DELETE | CFM | 15,670 | 10-08-01 | Delete.cfm |
| DELET˜14 | CFM | 15,878 | 10-08-01 | Delete_Pdf.cfm |
| EDIT | CFM | 21,030 | 10-08-01 | Edit.cfm |
| EDIT_PDF | CFM | 20,199 | 10-08-01 | Edit_Pdf.cfm |
| HM_AR˜20 | js | 8,850 | 10-08-01 | Hm_Arrays.js |
| HM_LO˜22 | js | 2,772 | 10-08-01 | Hm_Loader.js |
| HM_SC˜24 | JPG | 29,020 | 10-08-01 | Hm_Scriptdom.js |
| HM_SC˜26 | JPG | 28,254 | 10-08-01 | Hm_Scriptie4.js |
| HM_SC˜28 | JPG | 24,468 | 10-08-01 | Hm_Scriptns4.js |
| PRINT˜30 | CFM | 6,932 | 10-08-01 | Print_Document.cfm |
| RESULTS | CFM | 17,937 | 10-08-01 | Results.cfm |
| 14 file(s) | | | | |
| 232,366 | | | | |
| bytes | | | | |
| Directory of | | | | |
| cf\motor | | | | |
| vehicles | | | | |
| ADBANNER | CFM | 1,658 | 10-08-01 | Adbanner.cfm |
| ADD | CFM | 26,905 | 10-08-01 | Add.cfm |
| ADD_PDF | CFM | 21,533 | 10-08-01 | Add_Pdf.cfm |
| ADD_PIX | CFM | 21,448 | 10-08-01 | Add_Pix.cfm |
| ADD_T˜14 | CFM | 21,777 | 10-08-01 | Add_Title.cfm |
| DELETE | CFM | 17,586 | 10-08-01 | Delete.cfm |
| DELET˜18 | CFM | 17,899 | 10-08-01 | Delete_Pdf.cfm |
| DELET˜20 | CFM | 17,876 | 10-08-01 | Delete_Pix.cfm |
| EDIT | CFM | 30,036 | 10-08-01 | Edit.cfm |
| EDIT_PDF | CFM | 21,995 | 10-08-01 | Edit_Pdf.cfm |
| EDIT_PIX | CFM | 22,002 | 10-08-01 | Edit_Pix.cfm |
| HM_AR˜28 | js | 8,850 | 10-08-01 | Hm_Arrays.js |
| HM_LO˜30 | js | 2,772 | 10-08-01 | Hm_Loader.js |
| HM_SC˜32 | JPG | 29,020 | 10-08-01 | Hm_Scriptdom.js |
| HM_SC˜34 | JPG | 28,254 | 10-08-01 | Hm_Scriptie4.js |
| HM_SC˜36 | JPG | 24,468 | 10-08-01 | Hm_Scriptns4.js |
| PRINT˜38 | CFM | 7,961 | 10-08-01 | Print_Document.cfm |
| RESULTS | CFM | 21,339 | 10-08-01 | Results.cfm |
| 18 file(s) | | | | |
| 343,479 | | | | |
| bytes | | | | |
| Directory of | | | | |
| cf\personal_{—} | | | | |
| property | | | | |
| ADBANNER | CFM | 1,658 | 10-08-01 | Adbanner.cfm |
| ADD | CFM | 27,129 | 10-08-01 | Add.cfm |
| ADD_PIX | CFM | 22,077 | 10-08-01 | Add_Pix.cfm |
| ADD_T˜12 | CFM | 22,317 | 10-08-01 | Add_Title.cfm |
| DELETE | CFM | 16,708 | 10-08-01 | Delete.cfm |
| DELET˜16 | CFM | 17,964 | 10-08-01 | Delete_Pix.cfm |
| EDIT | CFM | 28,285 | 10-08-01 | Edit.cfm |
| EDIT_PIX | CFM | 21,194 | 10-08-01 | Edit_Pix.cfm |
| HM_AR˜22 | js | 8,850 | 10-08-01 | Hm_Arrays.js |
| HM_LO˜24 | js | 2,772 | 10-08-01 | Hm_Loader.js |
| HM_SC˜26 | JPG | 29,020 | 10-08-01 | Hm_Scriptdom.js |
| HM_SC˜28 | JPG | 28,254 | 10-08-01 | Hm_Scriptie4.js |
| HM_SC˜30 | JPG | 24,468 | 10-08-01 | Hm_Scriptns4.js |
| PRINT˜32 | CFM | 7,679 | 10-08-01 | Print_Document.cfm |
| RESULTS | CFM | 20,946 | 10-08-01 | Results.cfm |
| 15 file(s) | | | | |
| 279,321 | | | | |
| bytes | | | | |
| Directory of | | | | |
| cf\personal_{—} | | | | |
| property_{—} | | | | |
| photos | | | | |
| AK9795˜6 | JPG | 48,783 | 10-08-01 | Ak9795-001.jpg |
| T108-M˜8 | JPG | 44,877 | 10-08-01 | T108-multi-1.jpg |
| | 2 | 93,660 | | |
| | file(s) | bytes | | |
| Directory of | | | | |
| cf\ | | | | |
| personally_{—} | | | | |
| held_stocks | | | | |
| ADBANNER | CFM | 1,658 | 10-08-01 | Adbanner.cfm |
| ADD | CFM | 23,199 | 10-08-01 | Add.cfm |
| DELETE | CFM | 17,526 | 10-08-01 | Delete.cfm |
| EDIT | CFM | 23,925 | 10-08-01 | Edit.cfm |
| HM_AR˜14 | js | 8,850 | 10-08-01 | Hm_Arrays.js |
| HM_LO˜16 | js | 2,772 | 10-08-01 | Hm_Loader.js |
| HM_SC˜18 | JPG | 29,020 | 10-08-01 | Hm_Scriptdom.js |
| HM_SC˜20 | JPG | 28,254 | 10-08-01 | Hm_Scriptie4.js |
| HM_SC˜22 | JPG | 24,468 | 10-08-01 | Hm_Scriptns4.js |
| PRINT˜24 | CFM | 7,053 | 10-08-01 | Print_Document.cfm |
| RESULTS | CFM | 20,114 | 10-08-01 | Results.cfm |
| 11 file(s) | | | | |
| 186,839 | | | | |
| bytes | | | | |
| Directory of | | | | |
| cf\pets | | | | |
| ADBANNER | CFM | 1,658 | 10-08-01 | Adbanner.cfm |
| ADD | CFM | 19,305 | 10-08-01 | Add.cfm |
| ADD_R˜10 | CFM | 20,775 | 10-08-01 | Add_Responsible_Party.cfm |
| DELETE | CFM | 14,929 | 10-08-01 | Delete.cfm |
| EDIT | CFM | 19,923 | 10-08-01 | Edit.cfm |
| HM_AR˜16 | js | 8,850 | 10-08-01 | Hm_Arrays.js |
| HM_LO˜18 | js | 2,772 | 10-08-01 | Hm_Loader.js |
| HM_SC˜20 | JPG | 29,020 | 10-08-01 | Hm_Scriptdom.js |
| HM_SC˜22 | JPG | 28,254 | 10-08-01 | Hm_Scriptie4.js |
| HM_SC˜24 | JPG | 24,468 | 10-08-01 | Hm_Scriptns4.js |
| RESULTS | CFM | 19,525 | 10-08-01 | Results.cfm |
| 11 file(s) | | | | |
| 189,479 | | | | |
| bytes | | | | |
| Directory of | | | | |
| cf\pink_{—} | | | | |
| slips | | | | |
| ACF132 | PDF | 81,814 | 10-08-01 | Acf132.pdf |
| ACF1DF1 | PDF | 81,814 | 10-08-01 | Acf1df1.pdf |
| ACF2081 | PDF | 81,814 | 10-08-01 | Acf2081.pdf |
| ACF512 | PDF | 81,814 | 10-08-01 | Acf512.pdf |
| ACF51E | PDF | 81,814 | 10-08-01 | Acf51e.pdf |
| ACF52F | PDF | 81,814 | 10-08-01 | Acf52f.pdf |
| UNKNOWN | PDF | 81,814 | 10-08-01 | Unknown.pdf |
| | 7 file(s) | | | |
| | 572,698 | | | |
| | bytes | | | |
| Directory of | | | | |
| cf\retirement_{—} | | | | |
| accounts | | | | |
| ADBANNER | CFM | 1,658 | 10-08-01 | Adbanner.cfm |
| ADD | CFM | 23,124 | 10-08-01 | Add.cfm |
| DELETE | CFM | 17,698 | 10-08-01 | Delete.cfm |
| EDIT | CFM | 24,085 | 10-08-01 | Edit.cfm |
| HM_AR˜14 | js | 8,850 | 10-08-01 | Hm_Arrays.js |
| HM_LO˜16 | js | 2,772 | 10-08-01 | Hm_Loader.js |
| HM_SC˜18 | JPG | 29,020 | 10-08-01 | Hm_Scriptdom.js |
| HM_SC˜20 | JPG | 28,254 | 10-08-01 | Hm_Scriptie4.js |
| HM_SC˜22 | JPG | 24,468 | 10-08-01 | Hm_Scriptns4.js |
| PRINT˜24 | CFM | 8,282 | 10-08-01 | Print_Document.cfm |
| RESULTS | CFM | 21,296 | 10-08-01 | Results.cfm |
| 11 file(s) | | | | |
| 189,507 | | | | |
| bytes | | | | |
| Directory of | | | | |
| cf\safety_{—} | | | | |
| Deposit | | | | |
| boxes | | | | |
| ADBANNER | CFM | 1,658 | 10-08-01 | Adbanner.cfm |
| ADD | CFM | 22,320 | 10-08-01 | Add.cfm |
| DELETE | CFM | 17,994 | 10-08-01 | Delete.cfm |
| EDIT | CFM | 22,961 | 10-08-01 | Edit.cfm |
| HM_AR˜14 | js | 8,850 | 10-08-01 | Hm_Arrays.js |
| HM_LO˜16 | js | 2,772 | 10-08-01 | Hm_Loader.js |
| HM_SC˜18 | JPG | 29,020 | 10-08-01 | Hm_Scriptdom.js |
| HM_SC˜20 | JPG | 28,254 | 10-08-01 | Hm_Scriptie4.js |
| HM_SC˜22 | JPG | 24,468 | 10-08-01 | Hm_Scriptns4.js |
| PRINT˜24 | CFM | 6,399 | 10-08-01 | Print_Document.cfm |
| RESULTS | CFM | 19,578 | 10-08-01 | Results.cfm |
| 11 file(s) | | | | |
| 184,274 | | | | |
| bytes | | | | |
| Directory of | | | | |
| cf\spouse | | | | |
| Death | | | | |
| certificates | | | | |
| ACF660 | PDF | 81,814 | 10-08-01 | Acf660.pdf |
| ACF670 | PDF | 81,814 | 10-08-01 | Acf670.pdf |
| LA604˜10 | JPG | 75,750 | 10-08-01 | La6043-020.jpg |
| UNKNOWN | PDF | 81,814 | 10-08-01 | Unknown.pdf |
| | 4 file(s) | | | |
| | 321,192 | | | |
| | bytes | | | |
| Directory of | | | | |
| cf\tissue_{—} | | | | |
| donations | | | | |
| ADBANNER | CFM | 1,658 | 10-08-01 | Adbanner.cfm |
| ADD | CFM | 22,877 | 10-08-01 | Add.cfm |
| ADD_R˜10 | CFM | 20,972 | 10-08-01 | Add_Responsible_Party.cfm |
| DELETE | CFM | 15,095 | 10-08-01 | Delete.cfm |
| DENI_˜14 | GIF | 2,046 | 10-08-01 | Deni_Logo_Living_Will.gif |
| EDIT | CFM | 24,491 | 10-08-01 | Edit.cfm |
| HM_AR˜18 | js | 8,850 | 10-08-01 | Hm_Arrays.js |
| HM_LO˜20 | js | 2,772 | 10-08-01 | Hm_Loader.js |
| HM_SC˜22 | JPG | 29,020 | 10-08-01 | Hm_Scriptdom.js |
| HM_SC˜24 | JPG | 28,254 | 10-08-01 | Hm_Scriptie4.js |
| HM_SC˜26 | JPG | 24,468 | 10-08-01 | Hm_Scriptns4.js |
| PRINT˜28 | CFM | 9,031 | 10-08-01 | Print_Card.cfm |
| PRINT˜30 | CFM | 6,903 | 10-08-01 | Print_Document.cfm |
| RESULTS | CFM | 17,650 | 10-08-01 | Results.cfm |
| 14 file(s) | | | | |
| 214,087 | | | | |
| bytes | | | | |
| Directory of | | | | |
| db | | | | |
| DENI_MDB | MDB | 7,024,640 | 10-08-01 | Deni.mdb |
| | 1 file(s) | | | |
| | 7,024,640 | | | |
| | bytes | | | |
| Directory of | | | | |
| Online | | | | |
| Memorial | | | | |
| ADD_ME˜6 | HIM | 20,707 | 10-08-01 | Add_Memorial.html |
| OBITUA˜8 | HTM | 13,379 | 10-08-01 | Obituary.html |
| ONLIN˜10 | HTM | 13,276 | 10-08-01 | Online_Memorial.html |
| SAMPL˜12 | HTM | 21,848 | 10-08-01 | Sample_Memorial.html |
| TEST | <DIR> | | 10-08-01 | test |
| | 4 file(s) | | | |
| | 73,728 | | | |
| | bytes | | | |
| Directory of | | | | |
| Online | | | | |
| Memorial\test | | | | |
| ADBANNER | CFM | 1,658 | 10-08-01 | Adbanner.cfm |
| ADD | CFM | 16,890 | 10-08-01 | Add.cfm |
| ADD_C˜10 | CFM | 15,431 | 10-08-01 | Add_Cemetery.cfm |
| ADP_PIX | CFM | 19,163 | 10-08-01 | Add_Pix.cfm |
| ADD_R˜14 | CFM | 20,507 | 10-08-01 | Add_Responsible_Party.cfm |
| COLUMNS | CFM | 639 | 10-08-01 | Columns.cfm |
| DELETE | CFM | 15,111 | 10-08-01 | Delete.cfm |
| EDIT | CFM | 30,357 | 10-08-01 | Edit.cfm |
| FIND_˜22 | CFM | 17,949 | 10-08-01 | Find_Cemetery.cfm |
| HM_AR˜24 | js | 8,850 | 10-08-01 | Hm_Arrays.js |
| HM_LO˜26 | js | 2,772 | 10-08-01 | Hm_Loader.js |
| HM_SC˜28 | JPG | 29,020 | 10-08-01 | Hm_Scriptdom.js |
| HM_SC˜30 | JPG | 28,254 | 10-08-01 | Hm_Scriptie4.js |
| HM_SC˜32 | JPG | 24,468 | 10-08-01 | Hm_Scriptns4.js |
| PHOTO˜34 | CFM | 17,033 | 10-08-01 | Photo_Album.cfm |
| RESULTS | CFM | 24,302 | 10-08-01 | Results.cfm |
| RESUL˜38 | CFM | 5,111 | 10-08-01 | Resultpages.cfm |
| REVIE˜40 | CFM | 4,463 | 10-08-01 | Review_Record.cfm |
| ROWS | CFM | 755 | 10-08-01 | Rows.cfm |
| SAMPL˜44 | HTM | 10,605 | 10-08-01 | Sample.html |
| STEP1 | CFM | 19,164 | 10-08-01 | Step1.cfm |
| STEP2 | CFM | 19,675 | 10-08-01 | Step2.cfm |
| STEP3 | CFM | 23,420 | 10-08-01 | Step3.cfm |
| STEP4 | CFM | 23,962 | 10-08-01 | Step4.cfm |
| 24 file(s) | | | | |
| 379,559 | | | | |
| bytes | | | | |
| Directory of | | | | |
| www | | | | |
| ABOUT_˜6 | HTM | 13,595 | 10-08-01 | About_Deni.html |
| ADBANNER | CFM | 1,649 | 10-08-01 | Adbanner.cfm |
| ADD_L˜10 | HTM | 14,538 | 10-08-01 | Add_Listing.html |
| ADD_N˜12 | CFM | 5,011 | 10-08-01 | Add_Newsletter.cfm |
| ADD_N˜14 | HTM | 11,474 | 10-08-01 | Add_New_Listing.html |
| AFFIL˜16 | HTM | 9,493 | 10-08-01 | Affiliate_Program_Confirmation.html |
| AFTER˜18 | HTM | 11,745 | 10-08-01 | After_Loss.html |
| ANTIG˜20 | HTM | 29 | 10-08-01 | Antigrief.html |
| ARRAN˜22 | HTM | 29 | 10-08-01 | Arrangeintro.html |
| ARTIC˜24 | HTM | 29 | 10-08-01 | Article.html |
| ASSIS˜26 | HTM | 13,464 | 10-08-01 | Assisded_Living.html |
| ATTOR˜28 | HTM | 29 | 10-08-01 | Attorney.html |
| BOOKS | CFM | 2,605 | 10-08-01 | Books.cfm |
| BOOK_˜32 | HTM | 11,087 | 10-08-01 | Book_Store.html |
| BURIA˜34 | HTM | 23,099 | 10-08-01 | Burial_Insurance.html |
| BUSIN˜36 | CFM | 14,585 | 10-08-01 | Business_Detail.cfm |
| CARE_˜38 | HTM | 11,163 | 10-08-01 | Care_Givers.html |
| CARE_˜40 | HTM | 11,848 | 10-08-01 | Care_Giving.html |
| CATEG˜42 | HTM | 15,716 | 10-08-01 | Category_Service_Providers.html |
| CCARD˜44 | CFM | 1,515 | 10-08-01 | Ccard_Process.cfm |
| CCFORM | CFM | 18,135 | 10-08-01 | Ccform.cfm |
| CHAT_˜48 | HTM | 10,513 | 10-08-01 | Chat_Room.html |
| CHECK˜50 | HTM | 29 | 10-08-01 | Checklist.html |
| CHILD˜52 | HTM | 15,155 | 10-08-01 | Childcare_Checklist.html |
| CHILD˜54 | HTM | 20,602 | 10-08-01 | Child_Care.html |
| CHILD˜56 | HTM | 11,179 | 10-08-01 | Child_Journal.html |
| CHILD˜58 | HTM | 15,137 | 10-08-01 | Child_Money_Basics.html |
| CLICK˜60 | HTM | 10,581 | 10-08-01 | Clickhere.html |
| COLLE˜62 | HTM | 12,302 | 10-08-01 | College_Saving.html |
| COMPA˜64 | HTM | 11,656 | 10-08-01 | Company.html |
| COMPH˜66 | HTM | 29 | 10-08-01 | Comphome.html |
| CONGR˜68 | HTM | 14,864 | 10-08-01 | Congress_Reception.html |
| CONTA˜70 | HTM | 11,165 | 10-08-01 | Contact_Us.html |
| CONTE˜72 | HTM | 23,054 | 10-08-01 | Content_Affiliates.html |
| CONTE˜74 | HTM | 12,768 | 10-08-01 | Content_Copyright.html |
| COOPI˜76 | HTM | 14,375 | 10-08-01 | Cooping.html |
| COPYR˜78 | HTM | 38,806 | 10-08-01 | Copyright.html |
| COPYR˜80 | HTM | 29 | 10-08-01 | Copyrights.html |
| CREDI˜82 | HTM | 18,689 | 10-08-01 | Credit_Cards.html |
| CREMA˜84 | HTM | 24,981 | 10-08-01 | Cremation_Options.html |
| CREMI˜86 | HTM | 29 | 10-08-01 | Cremintro.html |
| CUSTO˜88 | HTM | 15,303 | 10-08-01 | Customer_Service.html |
| DEF_L˜90 | HTM | 11,479 | 10-08-01 | Def_Life_Planning.html |
| DENI_˜92 | HTM | 24,958 | 10-08-01 | Deni_Affiliates.html |
| DENI_˜96 | HTM | 17,686 | 10-08-01 | Deni_Products.html |
| DENI_˜98 | HTM | 29 | 10-08-01 | Deni_Text.html |
| DENI˜100 | HTM | 10,440 | 10-08-01 | Deni.html |
| DIRE˜102 | HTM | 11,167 | 10-08-01 | Directory.html |
| DPAH˜104 | HTM | 13,954 | 10-08-01 | Dpahc.html |
| ELDE˜106 | HTM | 11,418 | 10-08-01 | Elder_Care.html |
| EMAI˜108 | CFM | 11,931 | 10-08-01 | Email_List.cfm |
| EMCHK | CFM | 552 | 10-08-01 | Emchk.cfm |
| END_˜112 | HTM | 12,929 | 10-08-01 | End_0f_Life.html |
| ESTA˜114 | HTM | 29 | 10-08-01 | Estatehome.html |
| ESTA˜116 | HTM | 19,985 | 10-08-01 | Estate_Planner.html |
| ESTA˜118 | HTM | 14,140 | 10-08-01 | Estate_Planning.html |
| ESTA˜120 | HTM | 15,262 | 10-08-01 | Estate_Planning_Definitions.html |
| ESTA˜122 | HTM | 22,524 | 10-08-01 | Estate_Taxes.html |
| E_CA˜124 | CFM | 17,107 | 10-08-01 | E_Card_Step1.cfm |
| E_CA˜126 | HTM | 16,132 | 10-08-01 | E_Card.html |
| E_CA˜128 | CFM | 9,053 | 10-08-01 | E_Card_Thanks.cfm |
| FEES˜130 | HTM | 29 | 10-08-01 | Fees.html |
| FINA˜132 | HTM | 25,742 | 10-08-01 | Final_Estate_Planning.html |
| FINA˜134 | HTM | 13,473 | 10-08-01 | Financial_Planner.html |
| FORM˜136 | HTM | 29 | 10-08-01 | Form_Member.html |
| FORU˜138 | HTM | 9,347 | 10-08-01 | Forum.html |
| FUNE˜140 | HTM | 22,985 | 10-08-01 | Funeral_Insurance.html |
| FUNE˜142 | HTM | 19,864 | 10-08-01 | Funeral_Rituals.html |
| FUNE˜144 | HTM | 29 | 10-08-01 | Funeralhome.html |
| FUNN˜146 | HTM | 20,823 | 10-08-01 | Funneral_Details.html |
| FUNN˜148 | HTM | 25,935 | 10-08-01 | Funneral_Planning.html |
| GIVI˜150 | HTM | 18,264 | 10-08-01 | Giving_Back.html |
| GRES˜152 | HTM | 29 | 10-08-01 | Gresource.html |
| GRIE˜154 | HTM | 29 | 10-08-01 | Griefhome.html |
| GRIE˜156 | HTM | 29 | 10-08-01 | Griefpro.html |
| GRIE˜158 | HTM | 14,673 | 10-08-01 | Grief.html |
| HELP˜160 | HTM | 12,509 | 10-08-01 | Helping.html |
| HM_A˜162 | js | 8,347 | 10-08-01 | Hm_Arrays.js |
| HM_L˜164 | js | 2,772 | 10-08-01 | Hm_Loader.js |
| HM_S˜166 | JPG | 29,020 | 10-08-01 | Hm_Scriptdom.js |
| HM_S˜168 | JPG | 28,254 | 10-08-01 | Hm_Scriptie4.js |
| HM_S˜170 | JPG | 24,468 | 10-08-01 | Hm_Scriptns4.js |
| HOME˜172 | HTM | 15,307 | 10-08-01 | Home_Care.html |
| HOME˜174 | HTM | 29 | 10-08-01 | Home.html |
| INDE˜176 | HTM | 15,171 | 10-08-01 | Index2.html |
| INDE˜178 | HTM | 15,652 | 10-08-01 | Index.html |
| INSU˜180 | HTM | 22,877 | 10-08-01 | Insurance.html |
| INVE˜1S2 | HTM | 16,408 | 10-08-01 | Investment_Vihicles.html |
| INVE˜184 | HTM | 11,496 | 10-08-01 | Investments.html |
| ISEMAIL | CFM | 5,848 | 10-08-01 | Isemail.cfm |
| LIFE˜188 | HTM | 12,860 | 10-08-01 | Life_Planning_System.html |
| LIFE˜190 | HTM | 12,597 | 10-08-01 | Life_Organizer.html |
| LIFE˜192 | HTM | 14,506 | 10-08-01 | Life_Planning.html |
| LIFE˜194 | HTM | 11,066 | 10-08-01 | Life_Planning_Cd.html |
| LIFE˜196 | HTM | 35,164 | 10-08-01 | Life_Planning_Glossary.html |
| LIFE˜198 | HTM | 15,557 | 10-08-01 | Life_Planning_Mistakes.html |
| LIVI˜200 | HTM | 6,441 | 10-08-01 | Livinghome.html |
| LOAD˜202 | HTM | 2,292 | 10-08-01 | Loadme.html |
| LONG˜204 | HTM | 12,704 | 10-08-01 | Long_Term_Care.html |
| MEMI˜206 | HTM | 5,592 | 10-08-01 | MemInfohome.html |
| MENU˜208 | CFM | 7,916 | 10-08-01 | Menu_Test.cfm |
| MESS˜210 | HTM | 79 | 10-08-01 | Message_Forum.html |
| NEWS | CFM | 1,896 | 10-08-01 | News.cfm |
| NEWS˜216 | HTM | 10,763 | 10-08-01 | Newsletter.html |
| NEWS˜218 | HTM | 10,389 | 10-08-01 | News.html |
| OFFI˜220 | HTM | 30,381 | 10-08-01 | Official_Terms.html |
| ONLI˜222 | HTM | 13,276 | 10-08-01 | Online_Memorial.html |
| ORDE˜224 | CFM | 21,296 | 10-08-01 | Order_Confirmation.cfm |
| ORDE˜226 | HTM | 8,675 | 10-08-01 | Order_Form.html |
| ORDE˜228 | CFM | 7,219 | 10-08-01 | Order_Form.cfm |
| ORDE˜230 | CFM | 4,964 | 10-08-01 | Order_Form1.cfm |
| OTHE˜232 | HTM | 14,628 | 10-08-01 | Other_Estate_Planning.html |
| OUTS˜234 | HTM | 12,150 | 10-08-01 | Outside_Affiliates.html |
| PAGE˜236 | CFM | 167 | 10-08-01 | Page_Filler1.cfm |
| PAGE˜238 | CFM | 277 | 10-08-01 | Page_Filler2.cfm |
| PART˜240 | HTM | 11,525 | 10-08-01 | Partners.html |
| PAYM˜242 | CFM | 53,416 | 10-08-01 | Payment_Form.cfm |
| PAY_˜244 | HTM | 12,860 | 10-08-01 | Pay_Care.html |
| PLAN˜246 | HTM | 29 | 10-08-01 | Planning.html |
| PREP˜248 | HTM | 29 | 10-08-01 | Preplan.html |
| PREP˜250 | HTM | 13,168 | 10-08-01 | Preplanning_Kit.html |
| PREP˜252 | HTM | 12,344 | 10-08-01 | Preplanning_Kit_Cd.html |
| PRES˜254 | TXT | 4,544 | 10-08-01 | PressRelease |
| PRIV˜256 | HTM | 15,570 | 10-08-01 | Privacy_Policy.html |
| REAL˜258 | HTM | 16,311 | 10-08-01 | Real_Estate.html |
| RECO˜260 | HTM | 10,323 | 10-08-01 | Record_Book.html |
| RECO˜262 | HTM | 12,125 | 10-08-01 | Record_Book_Purchased.html |
| RECO˜264 | HTM | 12,029 | 10-08-01 | Recovery_Signs.html |
| RESO˜266 | HTM | 10,980 | 10-08-01 | Resource_Locator.html |
| RESU˜268 | CFM | 5,111 | 10-08-01 | Resultpages.cfm |
| RETI˜270 | HTM | 17,298 | 10-08-01 | Retirement_Planning.html |
| REVE˜272 | HTM | 15,818 | 10-08-01 | Reverse_Mortgage.html |
| ROWS | CFM | 755 | 10-08-01 | Rows.cfm |
| SEARCH | CFM | 12,750 | 10-08-01 | Search.cfm |
| SELL˜278 | HTM | 15,474 | 10-08-01 | Selling_Policy.html |
| SERV˜280 | HTM | 15,194 | 10-08-01 | Service_Providers.html |
| SITE˜282 | HTM | 29 | 10-08-01 | Sitecont2.html |
| SITE˜286 | HTM | 26,732 | 10-08-01 | Site_Map.html |
| SOCI˜288 | HTM | 20,214 | 10-08-01 | Social_Security.html |
| SPON˜290 | HTM | 11,223 | 10-08-01 | Sponsors.html |
| STAT˜292 | HTM | 29 | 10-08-01 | States.html |
| STAT˜294 | HTM | 12,784 | 10-08-01 | State_Bill.html |
| TEST˜296 | HTM | 2,034 | 10-08-01 | Test.html |
| TRI | GIF | 835 | 10-08-01 | Tri.gif |
| TRIL | GIF | 835 | 10-08-01 | Tril.gif |
| TRUS˜302 | HTM | 23,095 | 10-08-01 | Trusts.html |
| VEND˜304 | HTM | 16,897 | 10-08-01 | Vendor_Benefits.html |
| VEND˜306 | HTM | 12,408 | 10-08-01 | Vendor_Programs.html |
| VETE˜308 | HTM | 29 | 10-08-01 | Veterans.html |
| VICT˜310 | HTM | 11,574 | 10-08-01 | Victim_Resources.html |
| WEBS˜312 | HTM | 29 | 10-08-01 | Webservices.html |
| WEB_˜314 | HTM | 10,579 | 10-08-01 | Web_Links.html |
| WHAT˜316 | CFM | 1,917 | 10-08-01 | Whats_New.cfm |
| WHAT˜318 | HTM | 10,264 | 10-08-01 | Whats_New.html |
| WILL˜320 | HTM | 17,059 | 10-08-01 | Wills.html |
| YOUR˜324 | HTM | 13,688 | 10-08-01 | Your_Credit.html |
| 157 file(s) | | | | |
| 1,820,515 | | | | |
| bytes | | | | |
| Total files | | | | |
| listed: | | | | |
| 661 file(s) | | | | |
| 20,249, 680 | | | | |
| bytes | | | | |

### COPYRIGHT NOTICE

A portion of the disclosure of this patent document contains material that is subject to copyright protection. The copyright owner has no objection to the copying by anyone of the patent document or the patent disclosure as they appear in the Patent and Trademark Office patent file or records for reading only, but otherwise reserves all copyright rights.

### BACKGROUND OF THE INVENTION

Despite the certainty of death, few people are fully prepared for the inevitable, or even for the possibility of a long-term debilitating illness, by having adequate financial resources and other plans in place. Some excuse this lack of preparation on their youth and good health, yet sudden death or debilitating illness can befall anyone at anytime.

The present inventor believes that every individual should ask, if I were to die today:

1. What are my assets and where are they?

2. What are my responsibilities?

3. What do I want done with my body in the event of my incapacity or death?

4. How will my assets be applied to meet my responsibilities and plans?

Having sufficient information gathered together in an organized fashion to provide an adequate answer to all of these questions is rare, yet much of the information sought by these questions is needed at the time of incapacity or death. The details required to answer these broad questions are so numerous and must be derived from such varied sources that some details may be overlooked. Thus, even a conscientious individual desiring to make adequate end of life plans cannot do so without a “road map” of questions to guide them. Further, even to the extent information is stored in various places to answer some of these questions prior to incapacity or death in a comprehensive end of life plan, there is generally no means to organize the needed material or to implement the plan.

Many individuals do have one or more insurance policies, but have not made adequate plans to notify the beneficiaries of the existence of the policies or how to locate and benefit from them. In the event of debilitating illness, such policies may lapse due to a failure to pay premiums. Further, an analysis of the adequacy of the insurance coverage along with other assets to cover all financial obligations in the event of a debilitating illness or death is frequently absent.

Many individuals have drafted wills and made some end of life financial plans via an attorney or financial planner, yet ignore how such wills or plans will be brought to the attention of the legal advisor, trustee and/or beneficiaries at the appropriate time. There is often no planned method for advising all that need to know of a person's death or incapacity. Further, there are often no plans for assisted living in the event individuals cannot fully care for themselves, and/or no plans for a funeral, burial, and other arrangements. Thus, in the event of a debilitating illness or death, the bereaved family, friends and/or associates of the ill or dead individual are forced to seek out necessary information and make arrangements in a short period of time while their emotional state and exigent circumstances may affect their objectivity, rational thinking or ability to function.

There is a “death care” industry, comprising funeral homes, cemeteries, funeral planners, and providers of caskets, urns, monuments and related materials. Some death care industry resources have begun to use the internet world wide web to advertise and sell their products, such as caskets and funeral planning. However, arranging services needed from death care industry resources is only a part of final estate planning (“FEP”). A truly comprehensive final estate plan should incorporate resources from other resources to provide for all of the emotional, business and physical aspects associated with death and dying. The death care industry is not fully integrated with other FEP resources and industries.

Final estate planning may be incorporated into an end of life and even broader total life planning process. End of life planning, otherwise referred to as EOLP, is a process that all individuals should go through to plan for retirement, assisted living in the event of a debilitating illness, and for death. There are many disparate aspects to EOLP, which call upon various resources in various locations, such as the death care industry, insurance industry, health care industry, financial and investment industries, legal advisors, estate planners, government programs, organ and tissue donor agencies, and grief counseling. There is currently no EOLP system available to consumers to readily integrate the various resources needed to create a comprehensive end of life plan that reflects an individual's unique financial position, obligations and desires. Since EOLP is a part of total life planning, or LP, there are no comprehensive life planning system or computer programs available.

The world wide web has directories and sites for certain industries and other resources that are needed for EOLP, for example, insurance products, estate planning, health care facilities, grief resources, church and clergy, senior services, and government programs.

For example, a program called Quicken® WillWriter 2001, available from Intuit, Inc. of Mountain View, Calif., USA, helps a user create wills, trusts, powers of attorney, advance healthcare directives, and memorial plans. However, there are numerous limitations to the program. Likewise, there are web sites that provide information or assistance with portions of life planning. For example, home-organizer.com provides a program that permits a personal computer to be used as a virtual filing cabinet for important documents. A similar program is available at carethere.com for assessing caregiving needs and provides related healthcare and financial information. At www.metlife.com, advice on a variety of insurance and other issues are provided in a Life Advice® Library, but it is not linked into a comprehensive interactive total life or end of life planning program. There are also eldercare and medical care web sites that provide information, planning or search tools, such as elderlifeplanning.com, guideforlife.com, healthandage.com, and carepathways.com. However, these resources are not integrated into an organized, comprehensive, interactive and readily accessible program and/or network to assist with total life planning, FEP or EOLP.

There is a need for total life (TL) and end of life planning methods and technologies to facilitate implementation thereof that will assist individuals and professional planners to gather and update necessary information, integrate TL, FEP and/or EOLP resources, create a central repository for individual asset records, facilitate users to set aside adequate financial assets and plans for meeting obligations, assisted living and end of life needs, arrange for corporal disposition after death, and carry out the desires of the individual. There is also a need for methods and products to ensure that TL (otherwise referred to as LP), FEP and/or EOLP plans are readily accessible to the individual or a party designated by the individual, such as an “informant,” to ensure that TL, FEP and/or EOLP plans can be implemented with ease when needed, and to permit such plans and records to be readily updated to reflect changed circumstances. Further, there is a need for a common source for accessing information about and acquiring assistance from the various industries and professions required for integrated and comprehensive TL, FEP and/or EOLP, such as but not limited to the death care industry, insurance industry, hospice or retirement home industry, and the legal profession. These and other needs are met by the present invention described in more detail below.

### BRIEF SUMMARY OF THE INVENTION

In an embodiment, a total life planning interactive data gathering, storage and analysis program, and system is provided for gathering information regarding an individual's assets, financial and personal obligations, assisted living and corporal disposition desires, and arrangements for carrying out the disposition of assets to cover the individual's obligations and desires. A core aspect of a total life planning system includes an EOLP system, which includes a final estate planning (FEP) system and program for implementation thereof. The total life planning system is available in paper form via preprinted materials, or in a preferred embodiment is carried out via a computer program that can be run on a personal computer and/or accessed via the internet. The software code to carry out the program can be stored in an electronic storage medium, such as a hard drive, floppy disk, DVD, CD-R and/or CD ROM. In an embodiment, a CD or DVD incorporating the program also acts as a storage medium for collected TLP, EOLP and/or FEP data. In a preferred embodiment, the CD ROM or DVD is “wallet sized” and also serves as an ID card.

In a preferred embodiment, individual client information is gathered via an interactive LP computer program in operative connection with an internet web site, in which the program instructs the computer to provide the user with a checklist of information sought. Information obtained in response to prompts or a hierarchical list of interrogatories is stored and accessible via a unique storage identity code for the client, optionally protected by a password. In addition to or in place of a password, access to individual LP data may be protected by biometric indicia, such as voiceprint, fingerprint, and retinal scan. Stored client data is accessible for updating by the client, the program provider (hub operator), and in certain circumstances by resource vendors, employers, and designated third parties. In an embodiment, an automated system for facilitating multiparty interactions between geographically separated entities for EOLP and/or LP is provided. It is to be understood that the EOLP and FEP features of the present invention may be used independently or as part of total life planning (TLP or LP), and therefore, that EOLP and/or FEP descriptions herein are merely exemplary and not limiting. Preferably, the assets, obligations and corporal disposition desires of the client are automatically analyzed to identify areas where assistance might be desirable and to suggest LP and/or EOLP options. For example, a staffed resource center can be provided to handle information requests and referrals, and can communicate with program users via instant messaging, telephone and/or videophone for example. In a preferred embodiment, at the client's option, relevant vendor information is supplied to the client, and/or selected client and client need information is referred to particular vendors identified by the LP/EOLP program.

In an embodiment, the client is provided with an LP/EOLP ID card (denicard™) that includes their ID code, and a contact phone number. Preferably, the ID card and/or protective cover or sleeve for same prominently includes instructions, such as “IN THE EVENT OF ILLNESS, INJURY OR DEATH, PLEASE CALL THE FOLLOWING PHONE NUMBER AND PROVIDE THE FOLLOWING ID CODE.” The denicard™ may comprise a DVD or CD that includes the LP program and/or client data; if client data is stored thereon or accessible by use of the card, it is preferably pass code protected or include biometric identifiers. In one embodiment, the phone number on the denicard™ may be that of the LP/EOLP program service provider, or in the alternative that of the “informant” or other contact requested. Depending on the contact number utilized, the provision of the ID Code to the contact activates a confirmation procedure and/or computer program module or routine to ensure that the individual's end of life plan (“EOL plan”) should be implemented. In one embodiment, the confirmation procedure involves access to a 24 hour, always staffed, contact center, which takes steps to confirm that the client is in need of EOL plan activation, and to ensure that the agent of the client obligated to implement the client's EOL plan has confirmed receipt of the notice of the client's need. The same procedure can be followed for FEP and/or other LP aspects, for everything from anniversary announcements to zoo trips.

In another aspect, the denicard™ can include an electronic chip to store and update client information and interact with other data transmission and processing equipment, and/or a magnetic strip or other computer readable media with updateable client information stored thereon can be included (i.e., the denicard™ may store insurance policy information, contact information, etc.). The denicard™ and/or optional cover or sleeve can be formed of brightly colored plastic with waterproof markings to gain the attention of a caregiver, police, or others that search the client's possessions in the event of incapacity or death. In an embodiment, the denicard™ includes a ceramic or metal fire resistant ID tag, and/or an optional GPS locator. As noted above, the denicard™ may also comprise a DVD or CD disk that includes the LP/EOLP program, LP/EOLP data, and/or an internet access program for accessing LP/EOLP data and/or resources. As used herein, the term life planning (LP) incorporates EOLP and FEP and the term EOLP incorporates FEP.

In another embodiment, the system of the present invention provides LP resource providers with a simple method of and system for integrating their various offerings with that of other providers to both gain access to more customers and to provide better service. In this way geographically isolated and complementary LP vendors and resources can form a seamless network accessible (and locatable) via a click of a computer mouse and via use of a variety of search terms, such as but not limited to deni, deni.net, death, insurance, funeral, casket, burial, retirement, etc. In an embodiment, resource providers, or vendors, pay the program administrator to be listed (a one time and/or periodic fee) as a provider of particular resources on an internet site through which the LP program can be accessed or with the preprinted LP materials, and/or to have client referrals made automatically as the LP program is utilized or if a need is identified during use of the LP program. This business-to-business (“B2B”) aspect of the present invention is preferably accessible as a web application. In one aspect, vendors can be sent client information and/or a vendor can update client information stored by the program administrator for a product or service supplied by the vendor, provided it is authorized by the particular client. For example, an insurance provider can access the LP program administrator web site and stored client LP plan data to provide updated coverage limits, changes to premiums and due dates, beneficiary information, or provide notice that premiums are late or that the policy has been cancelled.

It is not necessary for the client to store all information with the EOLP program administrator. For example, the location of an insurance policy or a will document rather than the document text can be stored by the EOLP program provider. However, in an embodiment, scanned document images (i.e., insurance policies, wills, health directives such as do-not-resuscitate (DNR) instructions, and medical histories, etc.), optionally with signature, are stored to facilitate implementation of an LP plan when needed. Further, audio and video recordings can be stored. For example, a digital photo and/or video inventory of personal property is made and stored (this would facilitate on line auctions of estate property to be liquidated).

A preferred program provider and administrator is deni™ Resources, Inc., of Sunland, Calif. A preferred internet web site for the integrated LP program of the present invention is deni.net, or http://www.deni.net (Deni, deni, deni.net, denicard, Deni Enterprises, and Deni Resources are all proprietary trademarks of Deni Resources, Inc., which reserves all rights thereto). Deni™ has developed an interactive TLP/EOLP program, described herein, that helps clients create comprehensive TL/EOL plans, and which incorporates a final estate planning (FEP) method and system that gathers, stores, and analyzes data in four categories, referred to as the four points of final estate planning: Point 1: assets, such as personal property, real estate, retirement and other financial accounts, insurance policies, etc.; Point 2: Obligations or responsibilities, such as debts to creditors, dependent children, pets, etc.; Point 3: Corporal disposition, including desires or arrangements for assisted living, funeral, burial, cremation, organ donation, etc.; and Point 4: Plans for applying the assets identified in Point 1 to the obligations of Point 2 and desires and plans of Point 3. The deni.net site is also a valuable information source for individuals seeking help with FEP and EOLP, and provides a worldwide forum and network for resource providers to showcase their offerings to the public and to complementary resource providers. The present invention provides a single readily accessible site for most if not all FEP, EOLP, and TLP needs. Use of the deni™ program also leads to better planning for all aspects of life and death, including but not limited to child planning, college, retirement, vacations, housing, long term care, and death. Hence, the methods and systems and products of the present invention are useful for whole life planning.

In one aspect, the LP method of the present invention involves transformation of discrete LP data stored at or accessible from various locations into an organized format of data stored in labeled fields (whether in preprinted forms or electronically). A computer program and system is provided for acquiring, organizing, updating, analyzing and outputting some or all of the data and for generating life plans, along with an optional method and system for implementing such plans, and for providing assistance to the information provider to complete certain data fields, such as fields requiring EOL data regarding insurance or death care providers. The system also optionally comprises a device for advertising the existence of and how to access the data (e.g., the denicard™). In an embodiment, one or more data fields are updateable by one or more geographically isolated operators (e.g., client, vendor, web site operator, insurance policy or will beneficiary), with one or more fields optionally being automatically updatable via access to linked databases. Thus, for example automated accounting and bill paying can be performed with a bank account balance field value being reduced for payments and increased for deposits, and insurance coverage limits and premium fields automatically updated. The system optionally provides for automated notification in the event that certain fields become invalid or require input from a user; for example, in the event that an insurance policy beneficiary dies, and the beneficiary data field in the policy holder's data set is related to a corresponding field in another data set linked to the beneficiary, a notice would be sent to the insurance company and/or policy holder. Likewise, the beneficiary can be automatically notified of the death of an individual listing them as a beneficiary. This can be accomplished by a relational database. Thus, by activating an EOL plan, insurance benefits from linked insurance companies can be automatically paid to beneficiaries upon determining that conditions precedent to exercise of the policy are met.

The present invention will be better understood by the more detailed description below including a description of a preferred deni.net web site architecture and associated features and functions.

### BRIEF DESCRIPTION OF THE DRAWINGS

FIG. 1 is a diagram of how the resources of various industries that provide funeral services and final estate planning are integrated by deni™ in a hub and spoke configuration.

FIG. 2 is a schematic block diagram overview of an embodiment of an EOL/TL Planning System of the present invention, and the blocks represent software modules for carrying out the particular activity described.

FIGS. 3-4 are schematic block diagram overviews of software modules (flowcharts) for collecting and analyzing exemplary types of data associated with Point 1 of the Final Estate Planning System in the Deni™ interactive EOLP program embodiment of the present invention, as well as for vendor referrals associated therewith, the specific types of data being, respectively, personal property/real estate, and insurance benefits. Other software modules for jewelry, furniture, stocks and bonds, motor vehicles, accounts and monies, annuities, business ownership, possible future inheritances, and monies and assets not otherwise specifically requested may be present and operate similarly but are not shown.

FIGS. 5-6 are schematic block diagram overviews of software modules for collecting and analyzing exemplary types of data associated with Point 2 of the Final Estate Planning System in the Deni™ interactive EOLP program embodiment of the present invention, as well as for vendor referrals associated therewith, the specific types of data being, respectively, debts, and dependent children. Other software modules for power of attorney—caregiver arrangements and desires may be present and operate similarly but are not shown.

FIGS. 7-12 are schematic block diagram overviews of software modules for collecting and analyzing exemplary types of data associated with Point 3 of the Final Estate Planning System in the Denim interactive EOLP program embodiment of the present invention, as well as for vendor referrals associated therewith, the specific types of data being, respectively, living will/power of attorney, funeral pre-arrangements and/or desires, organ and tissue donation, medical history, military benefits, living memorial. Other software modules such as for long term care arrangements and/or desires may be present and operate similarly but are not shown.

FIG. 13 is a schematic block diagram overview of software modules for collecting and analyzing exemplary types of data associated with Point 4 of the Final Estate Planning System in the Denim interactive EOLP program embodiment of the present invention, specifically information associated with documenting and funding for obligations and desires identified in Points 2 and 3.

FIG. 14 is a schematic block diagram overview of an embodiment of a preferred web site architecture constructed in accordance with the present invention for carrying out inter alia the Final Estate Planning System in the deni™ interactive EOLP program embodiment of the present invention, including linkages of various resource pages to the home page.

FIGS. 15-22 are schematic overviews of the architectures of linked web pages for various resources and other operational aspects of an embodiment of the Final Estate Planning System in the deni™ interactive EOLP program.

FIGS. 23-28 are exemplary screen shots generated from an exemplary program of the present invention running on the internet, specifically deni.net.

### DETAILED DESCRIPTION OF THE INVENTION

In a preferred embodiment, a method and computer program, and systems and products for implementation of same are provided that facilitate a final estate planning professional in evaluating a client's end of life plans and to diagnose and suggest solutions to any deficiencies by asking a series of questions categorized into four points of estate planning, which are (1) client assets, (2) client fiscal and human/pet care responsibilities (i.e. creditors, children, spouse, employers and others that are dependent upon the client), (3) desired disposition of the client's body before (e.g., assisted living, hospice, palliative care, life support) and after death (corporal disposition), and (4) funding arrangements and documentation for asset disposition to cover fiscal, human/pet care responsibilities, living body and subsequent remains disposition, and to carry out the client's other wishes. Preferably, this end of life planning is done as part of preparing a total life plan.

The present invention includes a method for preparing, maintaining, updating, and implementing end of life plans for clients, and comprises a data processing system and method for obtaining, storing and analyzing client information, as well as for linking clients with vendors, and vendors with vendors. The system provides a hub and spoke configuration in which clients and vendors form the spokes linked to the planning and data storage hub.

In the absence of a client retaining a professional planner, the system and program of the present invention enable the client to gather necessary data in a readily accessible and organized form that facilitates the client's end of life planning and total life planning, and maintains the information for third party use when needed. By automatically identifying weaknesses in a client's plans, or by providing access to a variety of resources (i.e., via instant messaging, helpline, and/or resource locator), the system also permits clients to improve their TL, EOL and final estate plans even if they do not retain a professional planner (although the program provides referrals to such planners, and recommends that plans prepared by the use of the system be reviewed by appropriate professionals).

In one embodiment, users of the FEP method are asked to answer questions in the four categories (“points”) discussed above, preferably posed by a computer, and their answers are stored and analyzed. For each planning element or subject matter, unique educational program modules are provided to educate the user about the particular subject matter. The education modules may include FAQs (frequently asked questions), informative windows of information, interactive icons that automatically pop up when a particular question is asked, a search function, and resource referrals. In the alternative, clients can answer the questions on preprinted forms. In this latter embodiment, however, it would be preferred to enter the data from the forms into a computer.

In an alternative embodiment, an interactive program, including a questionnaire categorized into the four points of final estate planning will be accessible via an internet website. The questionnaire is presented in the form of a final estate planning checklist, or FEPCL, in which unanswered or incompletely answered questions form a “to-do” list for the client.

EOLP and/or FEP experts can review each client's data and “to-do” list, and determine what areas need improvement, and make recommendations to the client to improve their EOL and/or final estate plans. In a preferred embodiment, missing information on the “to-do” list automatically causes a vendor referral via internet links. For example, if a client does not have sufficient insurance, such as life, health, or burial insurance, insurance vendor information can automatically be supplied to the client. At the client's option, vendors can be requested to directly contact the client, and optionally, the vendors can update the client's relevant information stored at the hub should the vendor provide resources to a client. Again, this planning process can include life planning (LP), for example, college or home purchase savings planning.

In a preferred embodiment, client asset-to-obligation ratios are automatically determined by a data processor, and the client automatically provided with a report identifying problems, and with recommendations for improving their end of life plans, including vendor referrals. As used herein, the term vendor referral includes (1) clients receiving by telephone, email (which includes “instant messaging”), regular mail, courier, and/or facsimile vendor information directly from the web site (hub) host, (2) client information being provided to vendors so that vendors can directly contact the client, and (3) anonymous client need information provided to vendors by the hub with vendor product offerings then provided to the client via the hub without direct contact between the client and the vendor.

As the hub cannot guarantee the services of some of the vendors, a disclaimer is provided to clients, which preferably is acknowledged before certain information is provided. For example, prior to referring a client to an estate planning expert, or a lawyer for wills and trust advice, a disclaimer is acknowledged by the client that the hub (i.e., web site host) is not liable for the services provided by the resource to which the client is referred. Likewise, the quality of caskets provided by a supplier, the location and quality of burial plots, funeral services and locations, grief counseling capabilities, hospice care, etc. cannot be guaranteed, so appropriate disclaimers are provided and acknowledged.

Additional advantages of a web site include anytime and anywhere access to stored TL/EOL plan data, clients and vendors. Further, the hub can raise revenue by charging for vendor advertising, for listing vendors on its preferred vendor list, for vendor referrals, and from sales commissions. Revenue is also derived from fees for using the TL/EOLP program, and/or from maintaining TL/EOL plan data.

The system of the present invention provides vendors with “focused client access,” so that advertising on the web site has a higher payoff ratio than general broadcast advertisements. Further, clients referred to vendors are pre-screened by the hub. These are preferred clients, since they have already expressed an interest in, and preferably paid a fee to the hub for, TL/EOLP assistance, and the need of such clients' for the vendor's services has already been identified for the client. Preferably, clients have already indicated a willingness to receive information about the vendor referred by the hub.

In a preferred embodiment, client needs for vendor resources are identified, and where geographic proximity is an important factor, the hub program automatically identifies and refers vendors with facilities located in the zip codes closest to the zip code of the client's residence. Thus, the client is directed to local vendors recommended by the hub (preferably, these are vendors that pay a fee to belong to the network operated and linked by the hub), and the vendors gain motivated local customers.

Economies of scale are another benefit of the hub and spoke LP/EOLP system. Data storage at the main storage and backup sites is more economical since the costs are shared by many, thus obviating the need for each client to store an original and backup of their LP/EOLP plans, although it is recommended that clients have copies for themselves and/or designated parties. Further, paper files on insurance policies, wills, health plans, funeral plans, casket supplier, important family contact information, etc. required at the time of need may be difficult to locate and gather from various locations, or may simply be impossible to locate. By having the required information or locations of key documents kept in a central secure location, clients have the peace of mind that their assets will be automatically utilized to meet their wishes when their LP/EOLP program generated plan stored by the hub is implemented. Further, clients can provide anytime/anywhere access, or restricted access, to their end of life plan to an individual, such as an “informant,” lawyer, trustee, or family member. The access to client information can be limited to certain provisions of the LP/EOL plan, and optionally in the case of a vendor (e.g., insurance), information can be updated by the vendor.

In a preferred embodiment, automatic links to client asset and liability accounts is also provided, and premium notice and payment status for important assets, such as life insurance policies, is automatically updated in the clients LP plan file stored by the hub. In one embodiment, a client's failure to pay a premium on a timely basis would result in the client and/or the client's designee receiving a notice. Automated bill paying is another optional feature, which may be particularly useful for extended vacations and in long term care situations.

An additional aspect of the present invention is an obituary program that enables clients to prepare and store personal history needed for an obituary. At the time of death, the obituary will be made available to pre-selected news agencies and, in a preferred embodiment will be used to create an on-line internet accessible memorial page, which may also include a personal biography, photo album, and audio and video clips. During the data entry, or questionnaire, phase of the EOLP method of the present invention, the client is asked if they would like to prepare an obituary and memorial page, if not for themselves, then for someone else. Fees, which are optional, for storage of on-line memorials and obituary's can be included in the charge for using the LP/EOLP program, charged only when the obituary and/or on-line memorial is utilized, and/or charged as a one-time fee or on an installment basis.

Software and Systems

While an embodiment of the EOLP method of the present invention can be performed with paper and ink via preprinted questionnaires and data entry forms, it is preferred to have an interactive software program that obtains data from the user via a series of questions, also referred to herein as hierarchical interrogatories, stores the information in data fields for future reference, analyzes the information for determining weaknesses in the user's life plans and/or end of life plans, and makes vendor referrals. By the use of a computer program, preferably accessible via the internet world wide web, many additional benefits are derived for LP/EOLP. For example, a program accessible from the internet can be updated without requiring creation and distribution of new hard copies of the program (although program copies can be provided to professional planners under a separate fee program; the planners would then upload their clients data to the hub for a fee). Further, with the widespread use of the internet, many companies offer customized web page and internet site setup services facilitating the set up of a program in accordance with the present invention. The programs used to create the internet accessible program and web sites can be altered without affecting the client's life plans stored with the hub, which are preferably stored in a relational database. Following the program outline set forth herein, conventional web page formatting techniques and software tools can be utilized to carry out the present invention's new and unique method of providing a one-stop on-line location for all LP/EOLP needs, create a central repository of all the necessary information to implement a particular end of life (or whole life) plan, plus provide a means for automatically implementing the life plans when needed.

One of skill in the art will recognize that the present inventions may be implemented by creating programs using known software and/or web site development tools, such as Cold Fusion, Microsoft Front Page, programming languages such as HTML, XML, C++, Java, Perl, Visual BASIC, SQL database, etc. For example, the Oracle7.3 product commercially available from Oracle Corporation of Redwood Shores, California or the Microsoft Access product commercially available from Microsoft Corporation of Redmond, Wash. View or Virtual databases may also be used that treat several databases as if they were a single database. Conventional relational databases with specialized tools for On-Line Analytical Processing, or OLAP-optimized databases may also be used. Such databases are sometimes referred to as MOLAP, ROLAP or DOLAP databases and are described at http://www.sentrytech.com/dw05dem.htm. Non-database implementations such as those storing data using objects, records, arrays or flat files may be used to implement dimensional databases. Keys may be implemented using conventional pointers or look-up table approaches.

For further information on systems and programs capable of collecting, storing, analyzing, updating, and electronically sharing data, see U.S. Pat. No. 5,193,056, to Boes, U.S. Pat. No. 6,151,581, to Kraftson et al., which are incorporated by reference as if reproduced in full below. Also incorporated by reference are existing systems, such as those utilized to run the web sites of Amazon.com (e.g., U.S. Pat. No. 5,960,411, to Hartman et al.) and Priceline.com (e.g., U.S. Pat. No. 5,897,620, to Walker et al.).

Examplary Software and Hardware

Included as an appendix herein is a CD-ROM containing the computer program code of an exemplary system for managing a user's life plan. It will be appreciated that the included content is exemplary and that any suitable content may be used with the disclosed system. The code includes hypertext markup language, Cold Fusion™ markup language, cascading style sheet and JavaScript files which can be executed or displayed by a browser program such as Internet Explorer v5.0 manufactured by Microsoft Corporation, located in Redmond, Wash. The code references binary image files to display various icons and images as part of a graphic user interface and as part of the content. One of ordinary skill in the art will understand that such icons and images are known and that any suitable icons and images that appropriately indicate the represented function or content may be used. To operate the code, refer to the file listing included at the beginning of this document and the additional detail below.

All of the code, as well as suitable image files, should be loaded on one or more media such as a CD-ROM or computer hard drive of a suitable computer server as described below. A suitable computer server is one having a 100 MHz or greater Pentium™ processor, manufactured by Intel Corporation, located in Santa Clara, Calif., or similar class processor running the Windows NT 4.0, or later version, operating system manufactured by Microsoft Corporation. The computer server should have at least 64 megabytes of RAM, at least 50 megabytes for the system (in addition to necessary storage space for the operating system, and necessary operating software as described below). The computer should further include a network interface card, keyboard, mouse or other suitable user input device, a display device, such as a monitor or flat panel display with the capability of generating and displaying graphics at a resolution of at least 640×480 at an 8 bit color depth. Further, to make the system available as an Internet accessible web site, a suitable Internet communications connection is required. An exemplary computer server has a Pentium™ III processor running at 800 MHz, 512 megabytes of RAM, a 20 GB SCSI hard disk and an Intel Pro 100+ network interface card, manufactured by Intel Corporation, located in Santa Clara, Calif. The exemplary server is further coupled with the Internet using a T3 class or faster Internet connection.

In addition to the operating system, the System requires Allaire ColdFusion Application Server 4.0, or later version, manufactured by Allaire/Macromedia, located San Francisco, Calif., Microsoft Access 97, or later version, and a suitable web browser program, such as Microsoft Internet Explorer, 5.0 or later version, both manufactured by Microsoft Corporation. In addition, the System 100 also requires the Microsoft Internet Service Manager (IIS), also manufactured by Microsoft Corporation, or other suitable web server software supported by ColdFusion, such as Apache, Netscape Enterprise Server or O'Reilly WebSite Pro.

To operate the system and make it available as an Internet accessible web site, the Microsoft Internet Service Manager and ColdFusion Application Server software should be loaded on the computer server. The files in the included CD ROM appendix should then be loaded in the web root directory, such as C:\netpub\deni. The Internet Service Manager should then be configured to read and allow browsing of the deni.net files loaded in the web root directory. The ColdFusion software should then be configured to read the deni.net database using the ColdFusion Administrator, as is known. The web site may then be accessed by accessing the computer server via the Internet using a suitable web browser program, either by a suitable URL/domain name or by IP address, and loading the index.html file from the deni directory.

The table below lists file extensions for files on the CD ROM submitted herewith, programs and/or programming language associated with the creation of the corresponding files, and whether the files are in ASCII or binary format:

| | | |
|---|---|---|
| PDF | Adobe Acrobat | Binary |
| BMP | Image file - Bitmap | Binary |
| CFM | Cold Fusion Markup | ASCII |
| CSS | Cascading Style Sheet | ASCII |
| GIF | Image file - Graphic Image Format | Binary |
| HTM | Hypertext Markup | ASCII |
| HTML | Hypertext Markup Language | ASCII |
| JPG | Image file - JPEG | Binary |
| JS | Java Script | ASCII |
| MDB | MS Access Database | Binary |
| DOC | MS Word document (copyright document) | Binary |
| PCX | Image file - Photoshop | Binary |
| PNG | Image file - Generic GIF | Binary |
| PSD | Image file - Photoshop | Binary |
| TIF | Image file - Tagged Image File Format | Binary |

International Network of LP Resources

A further benefit of the internet for implementing the present invention is the creation of an international and national network of LP/EOLP resources that can interact electronically. This access creates the ability for a U.S. citizen to have all essential information, such as health insurance and medical history, etc. provided to a foreign hospital or government via email, facsimile or phone, upon the presentation of their deni.net ID card (or “denicard™”). Thus, in a preferred embodiment, the deni.net denicard™ may be integrated into a variety of formats, for example, it may be included with a passport and/or drivers license, or denicard™ information can be imprinted or included in passports and driver licenses. Hotel guests and students at schools may leave their denicard™ number at registration in place of filling out long information forms. Employers can be given the denicard™ number, and an annotated print out or electronic file of each employee's existing stored plans and other information, and can automatically update employee plan information, such as health, dental, life, disability, and retirement benefits. Since data fields can be made variably accessible, a first group of data fields can be accessible by a first type of card swipe device and/or access code while a second group of data fields can be accessible by a second type of card swipe device and/or access code.

In one embodiment, a relational database is used to manage LP/EOLP data, with one or more fields in a first data set being updatable when one or more linked fields in a second data set are altered.

In a preferred embodiment, each client is provided with an electronic or paper report, summarizing their L/EOL plan data, and identifying areas that should be investigated. The report will optionally include specific recommendations and vendor referrals based on an automatic analysis performed by the computer program using actuarial tables and other planning tools and/or based on analysis by a professional life planner.

### EXAMPLE 1

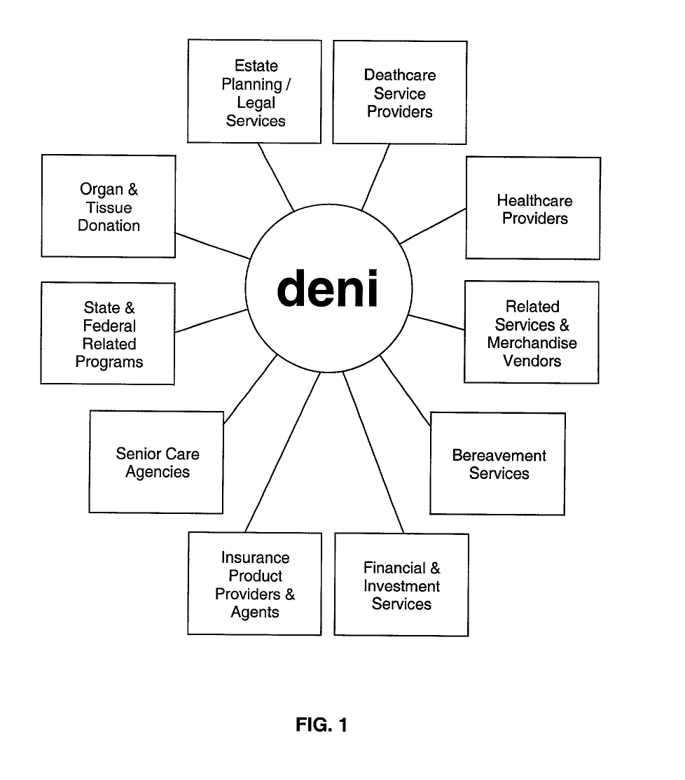

A non-limiting example of a web site layout and navigation method for carrying out the EOLP method of the present invention is presented below. The example is for a web site known as deni™ and intended to be accessible at http://www.deni.net. With reference to FIG. 1, deni™ is shown forming the hub for integrating a variety of resources useful for FEP and EOLP, which can be part of a total life planning process. These resources are all made available to deni™ subscribers via the site, and the site can carry advertisements for various resources so that visitors to the site that do not take advantage of the opportunity to use the LP/EOLP program may still gain helpful information from participating resources. In a preferred embodiment, resources in the deni™ database or that advertise on the site will have links back to deni™ in their web sites in order to integrate their offerings with those of other LP resources.

Web Site Layout & Navigation

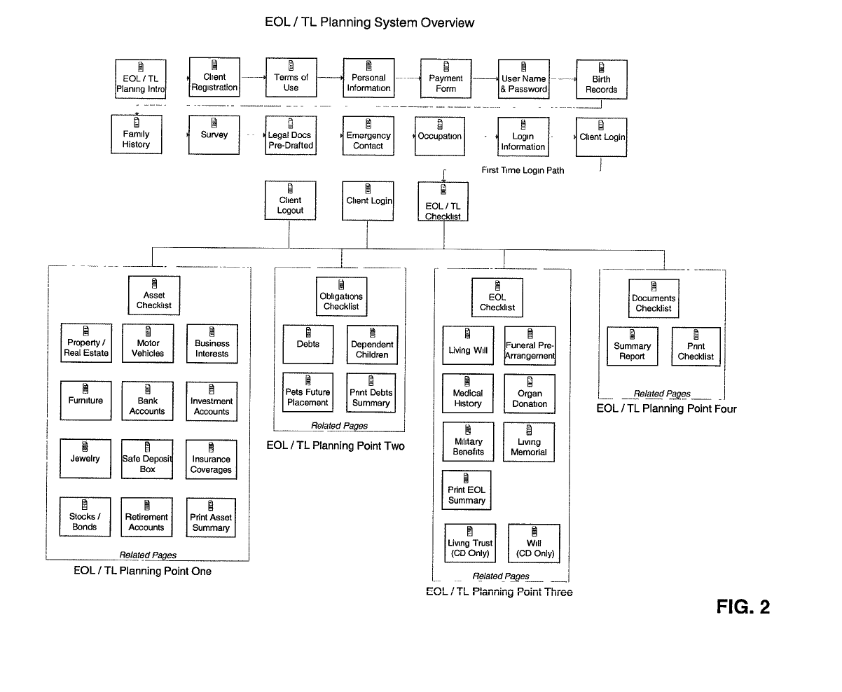

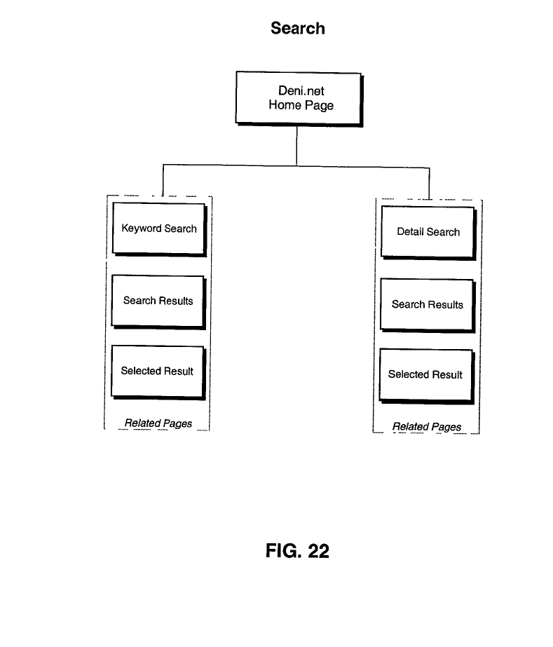

An exemplary web site layout is illustrated in FIG. 22. With reference to FIG. 2, a block diagram flow chart is presented of an exemplary program routine flow chart for a planning program that can be implemented on the internet. Frames may be used that contain navigation links to each section of the web site. For example, there may be two types of links, graphic link buttons and a drop down list containing a site map, so that visitors may be able to access any section of the web site regardless of their current position within the site. When a visitor clicks a navigation link, only the content portion of each page will need to be downloaded.

Final Estate Planning—Client Registration

With reference to FIG. 2, one of the first steps in an exemplary Final Estate Planning process is for clients to register and pay for their membership to deni.net. The registration and payment process is fully automated. In order to register, clients complete the online registration form. The information provided during the registration process will be used through out the Final Estate planning process allowing the system to track the users progress and allow them to update their information.

Once the client has completed and submitted the registration form they will be prompted to enter a password that will be used to access a Final Estate Planning System program. Various program modules (shown as blocks) are sequentially followed, for example, birth record entry, family history entry, etc. The client may receive a confirmation email that includes their user identification number. After the confirmation notice has been received, they will be able to login into the Final Estate Planning System program to begin completing items on the Final Estate Planning Checklist, or “FEPCL,” or into a life planning checklist. A member login link is provided on the web site's home page. Once logged in, clients will be directed to the FEPCL or an LP program.

Below are non-limiting examples of client information that will be collected during registration:

1. Email address

2. Name

3. Date of Birth

4. Address

5. Phone Number

6. Years at Current Residence

7. Place of Birth

8. Social Security Number

9. Martial Status

a. Spouse's Name

b. Spouse's Age

10. Years Employed

11. Occupation

12. Employer Business

13. Father's Name

14. Father's Place of Birth

15. Mother's Name

16. Mother's Place of Birth

Final Estate Planning—Final Estate Planning Checklist

As noted above, a preferred feature of life planning is Final Estate Planning. The Final Estate Planning Checklist, FEPCL, of the present invention serves at least three purposes. First, the checklist provides clients with a list of items to be completed, and, as the items are completed, a checkmark will be placed next to them so that they can easily be identified as completed. Checked items that are fully completed are eliminated from the FEPCL in one embodiment to form a “to-do” list. The second purpose for the checklist is to serve as a gateway to all of the areas identified on the checklist. Third, the checklist ensures completion of the vendor referral process. The FEPCL can be part of a EOL/TL checklist.

From the checklist, clients will be able to access any section of the Planning system. For FEP, the checklist includes four categories corresponding to the deni™ four points of final estate planning method: Point One—“Your Assets”, Point Two—“Your Responsibilities”, Point Three—“The Care of Your Body Before & After Death” and Point Four—“What Have You Done to Document & Fund.” Beneath the category heading will be a list of items to be completed in that category. The category headings and items requested will be clickable links to their corresponding pages. Each category will have an introductory page containing a brief description of information to be entered. Each of the items will be hyper-linked for additional navigation.

In a preferred embodiment, each time a client submits a form or information request to a vendor they will be asked to read and acknowledge a disclaimer.

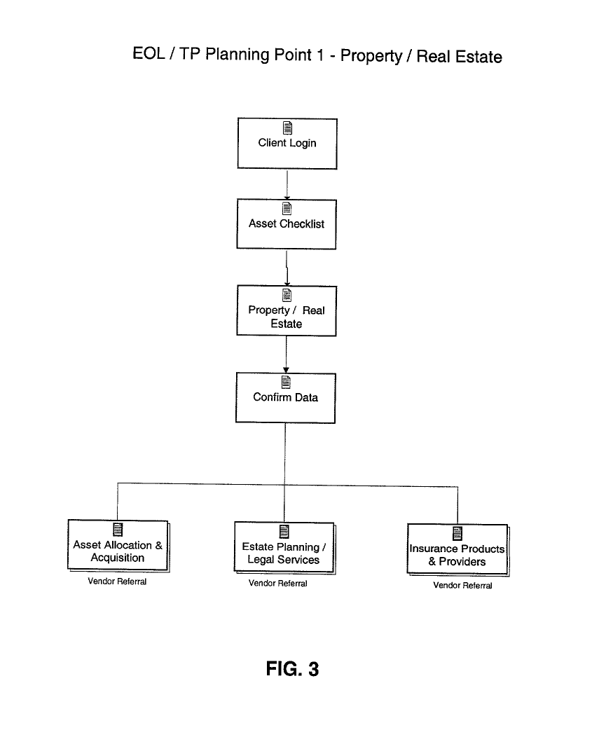

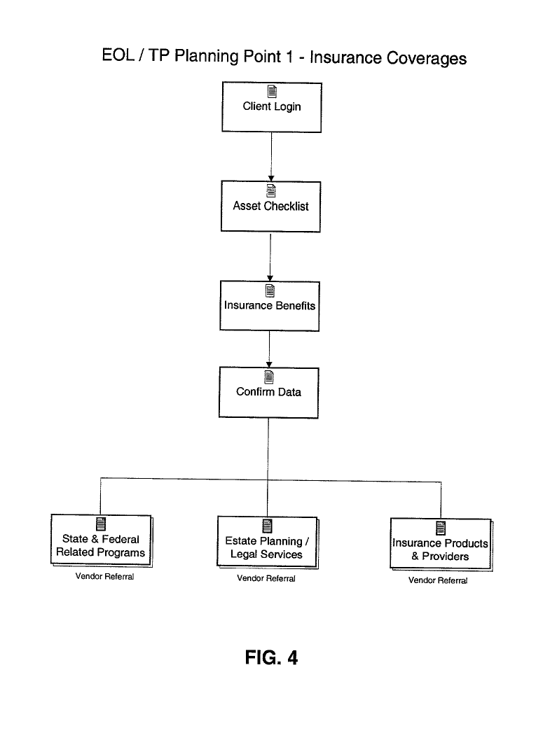

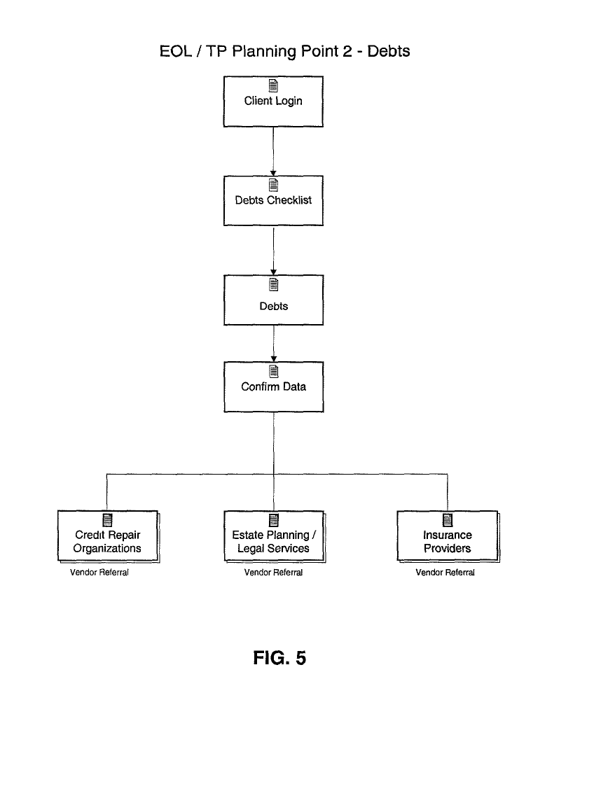

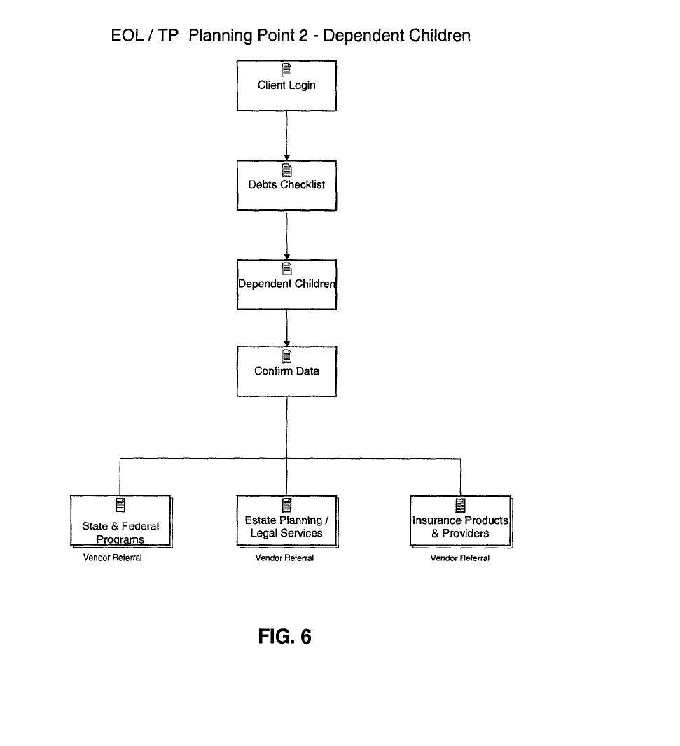

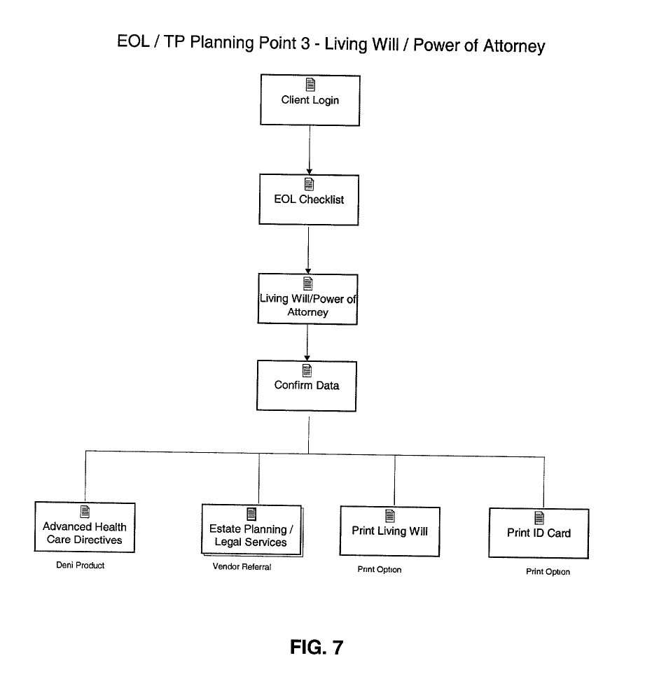

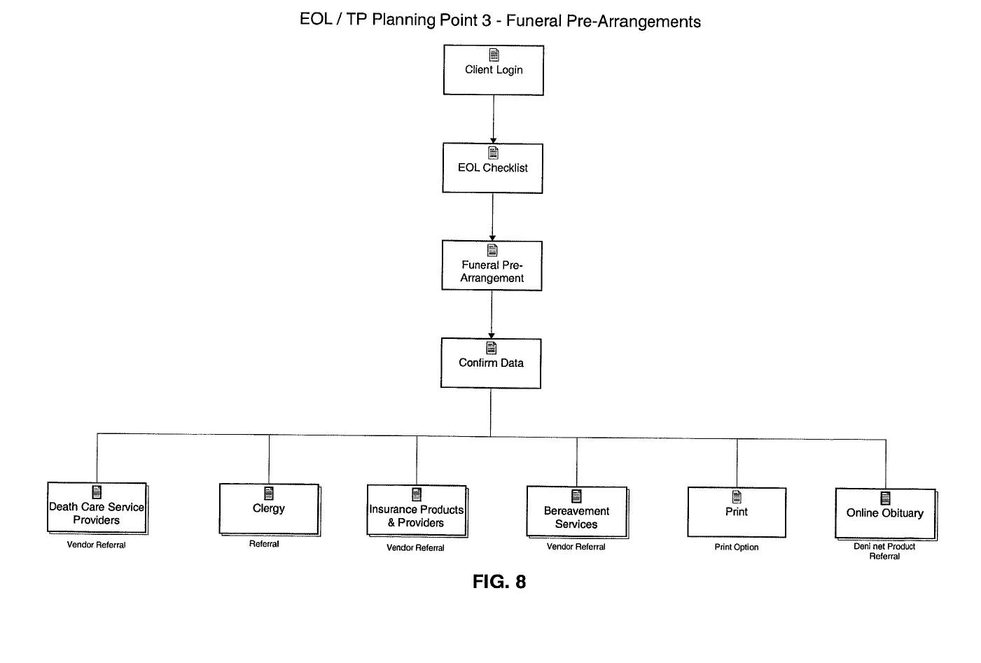

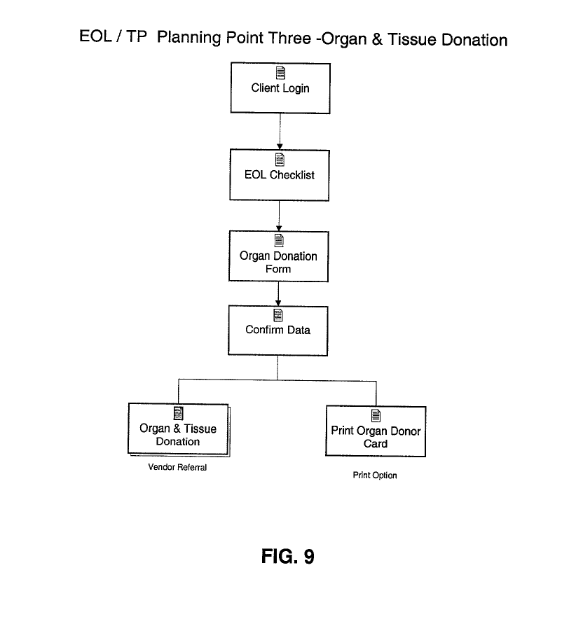

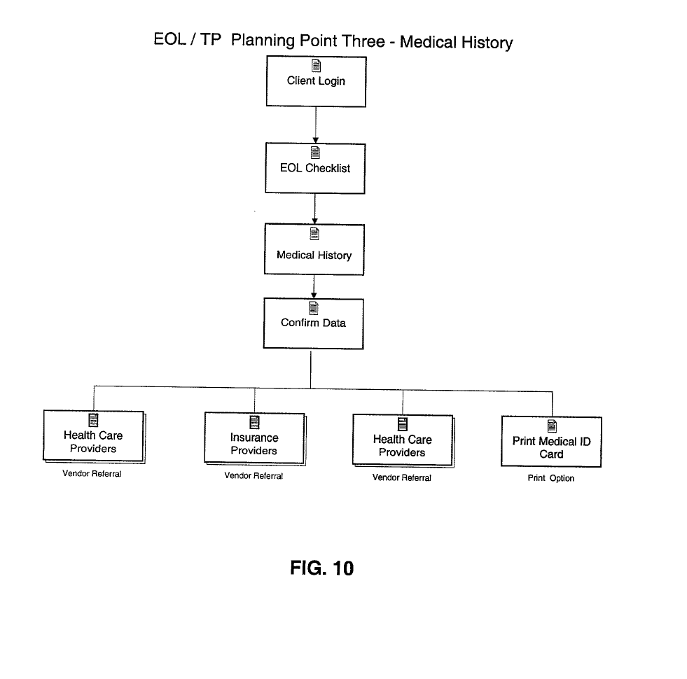

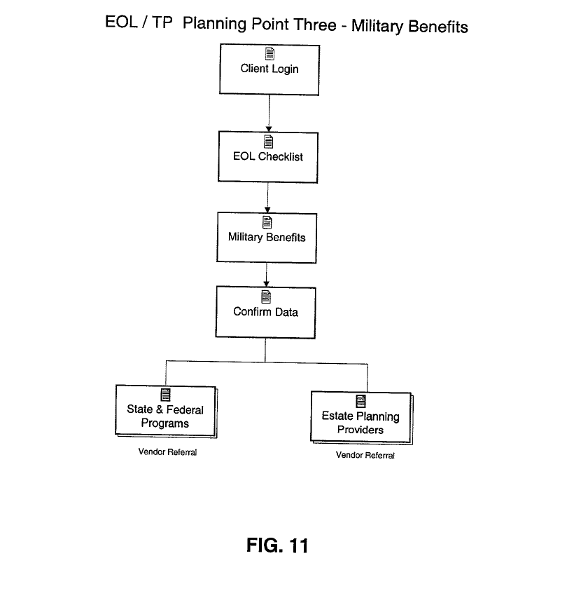

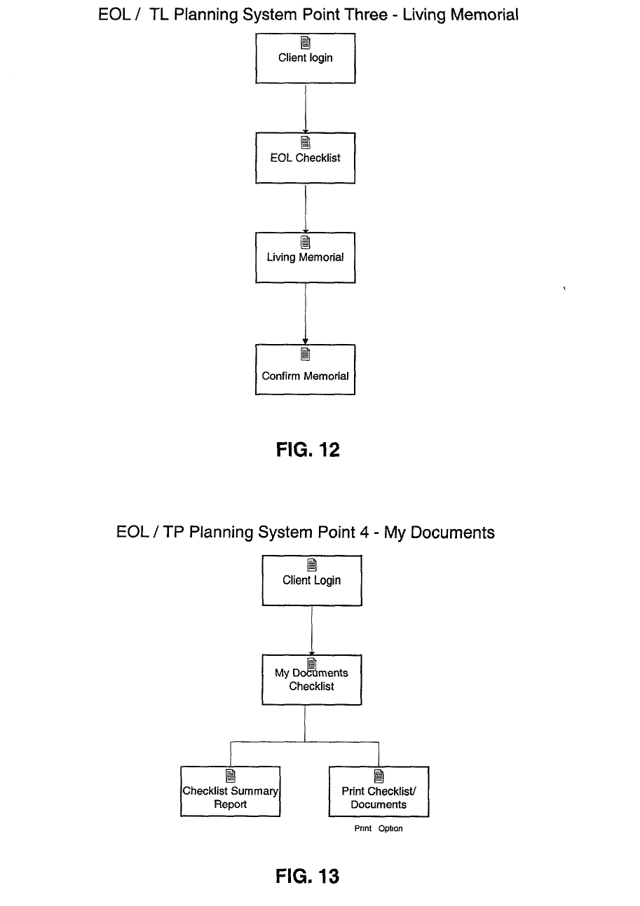

Listed below are examples of the items to include on the Final Estate Planning Checklist. FIGS. 3-21 provide program flow charts for collection and storage of this information, along with disclaimer program modules, and vendor referral program modules.

Point One—“Your Assets”

1. Personal Property

2. Furniture

3. Jewelry

4. Motor Vehicles

5. Accounts/Monies

6. Insurance Benefits

7. Stocks/Bonds

8. Annuities

9. Possible Inheritances

Point Two—“Your Responsibilities”

1. Debts and Individual Monies Owed

2. Minor Children/Dependents

a. Child Caregiver

b. Funds for Under Age Children

c. College Funds

3. Pets Future Placement

4. Power of Attorney/Caregiver

Point Three—“The Care of Your Body Before & After Death”

1. Long Term Care/Coverage

2. Medical Insurance Funding

3. Organ & Tissue Donation

4. Funeral Pre-Arrangements

a. Online Memorial

b. Obituary

5. Power of Attorney Living Will

Point Four—“What Have You Done to Document & Fund the Below”

1. Life Insurance

2. Pre-Paid Funeral Plans

3. Prepaid Interment Burial Or Cremation

4. Annuities

5. Trust

6. Savings

7. Wills

8. Living Trusts

9. Pour-Over Wills

10. Funeral Or Cremation Provider

Planning—Checklist Item Completion

Clients are requested to fill out forms for each of the items listed on the TL/EOL/FEP checklist. Once a form is completed, they will need to submit and verify the information that they have provided. They will be provided an opportunity to make changes to the form at that time or they can come back at any time to update the form. When they have verified their information, they will then be referred to LP/EOLP/FEP resources and/or deni.net vendors in the deni.net vendor network.

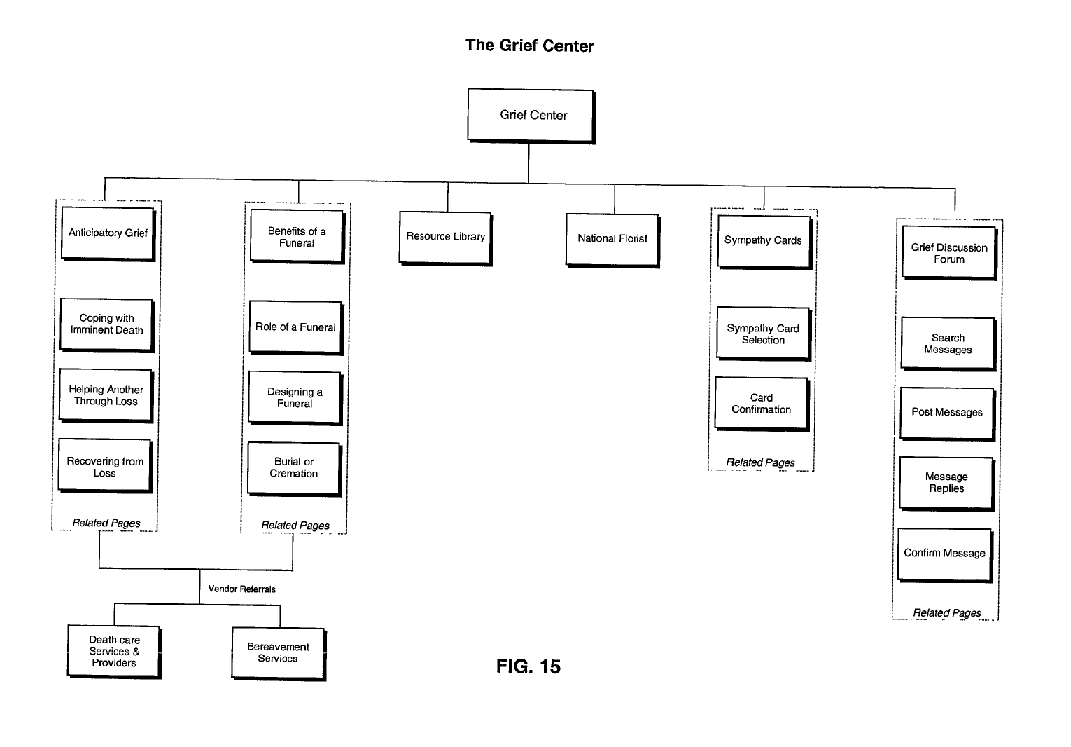

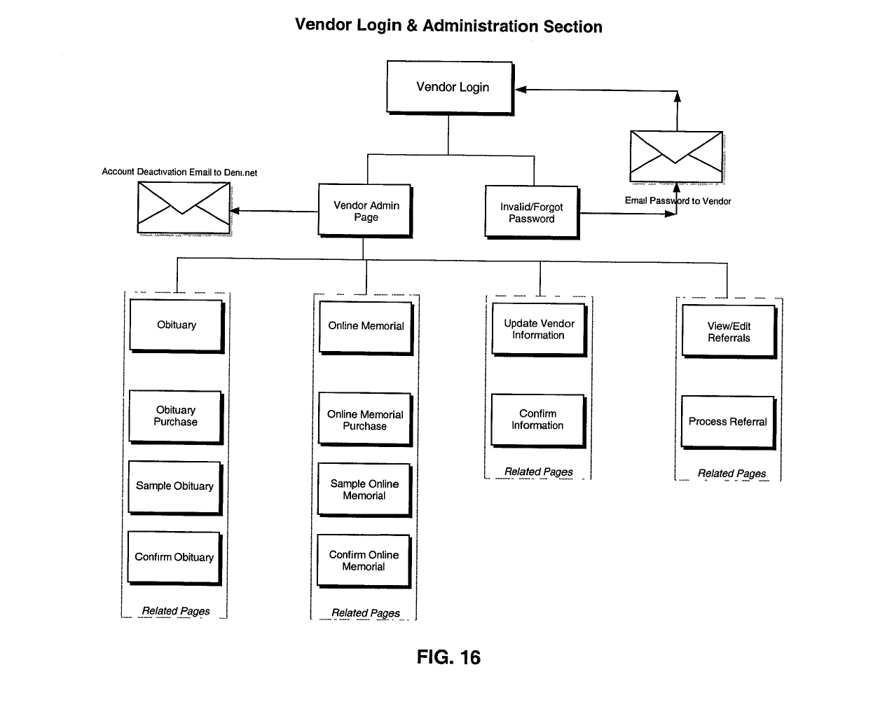

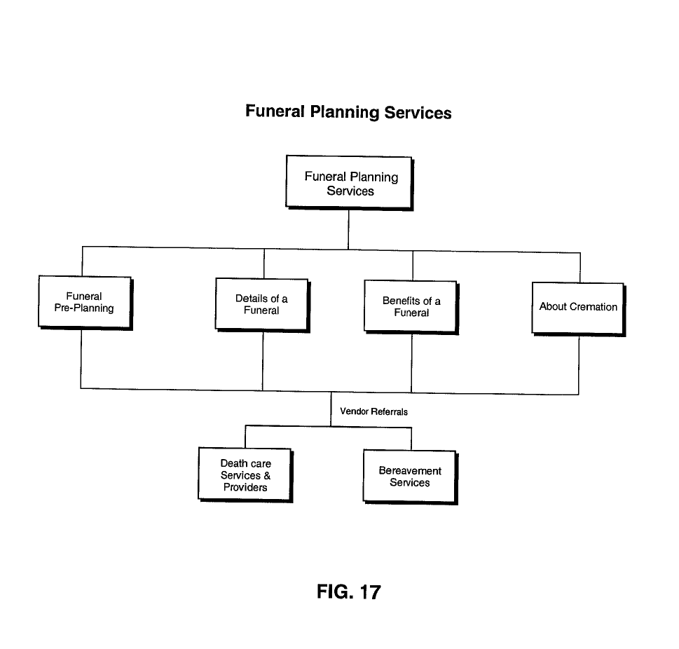

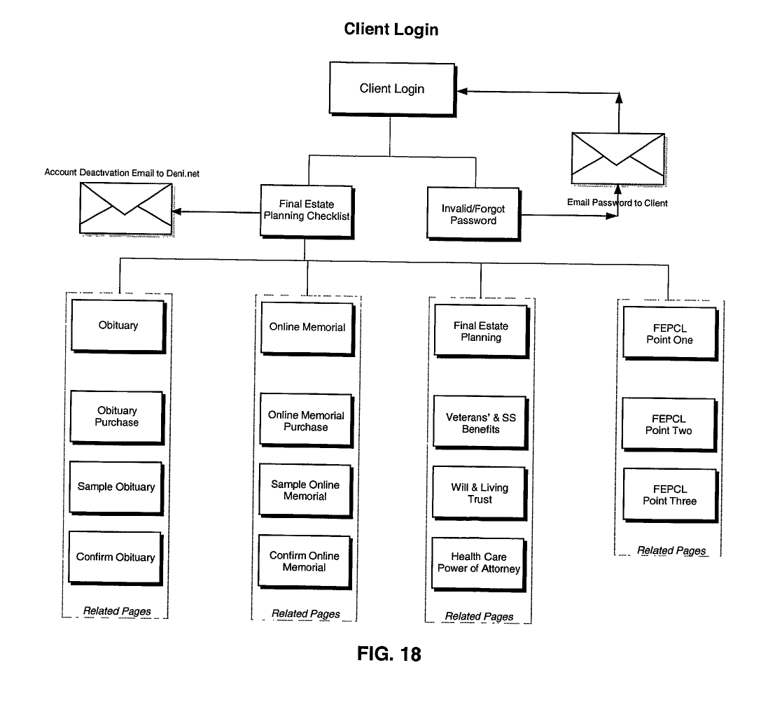

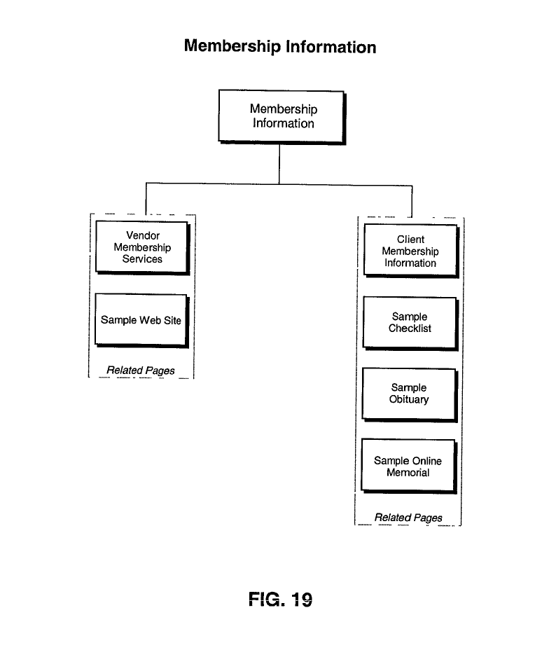

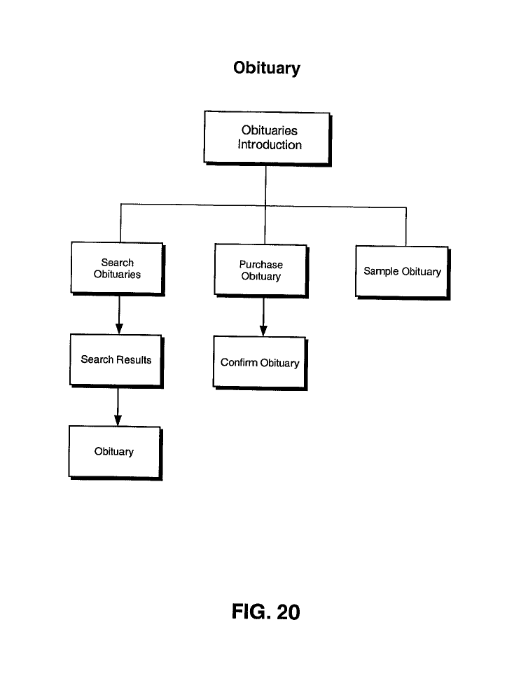

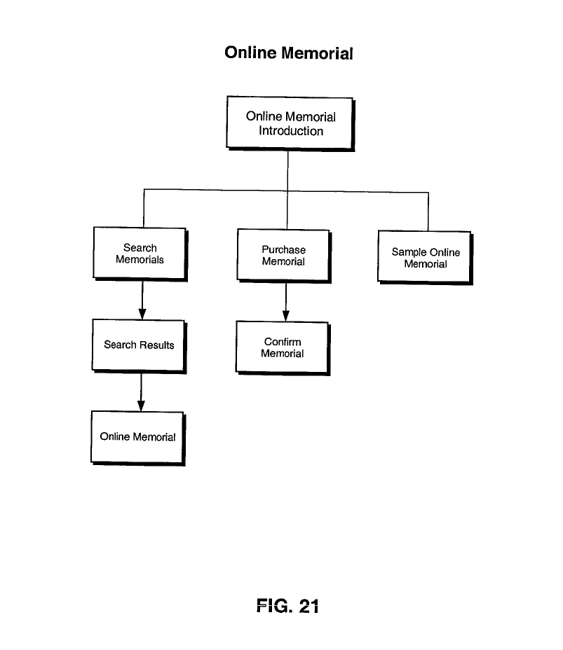

With reference to FIGS. 15-22, program flow charts for resources offered by or through deni™ and additional features and functions of an exemplary web site (hub) are illustrated, including a Grief Center in FIG. 15, Vendor Log-In & Administration features in FIG. 16, Funeral Planning Services in FIG. 17, Client Login program modules in FIG. 18, Membership Information program modules in FIG. 19, Obituary program modules in FIG. 20, Online Memorial program modules in FIG. 21, and site Search program modules in FIG. 22.

Exemplary Web Site Web Page Examples

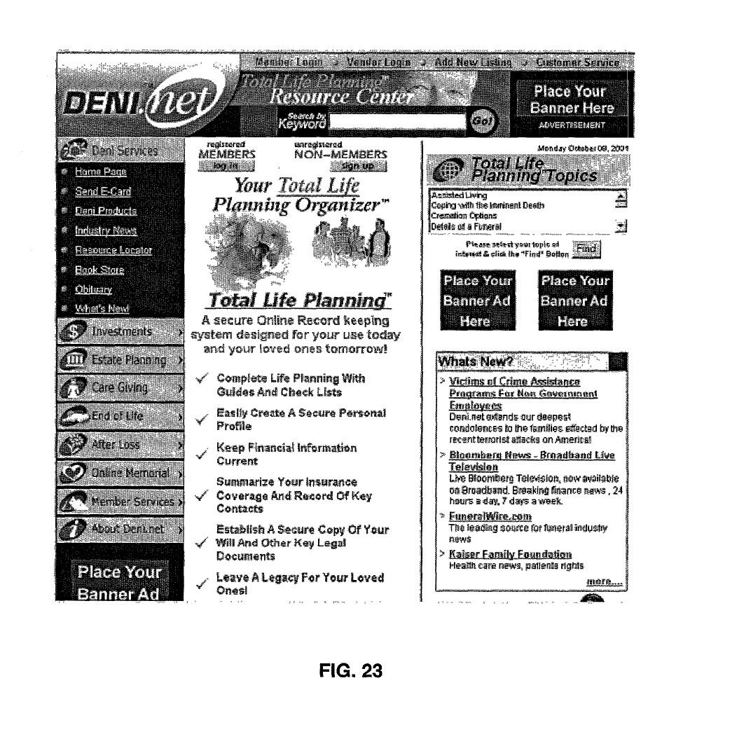

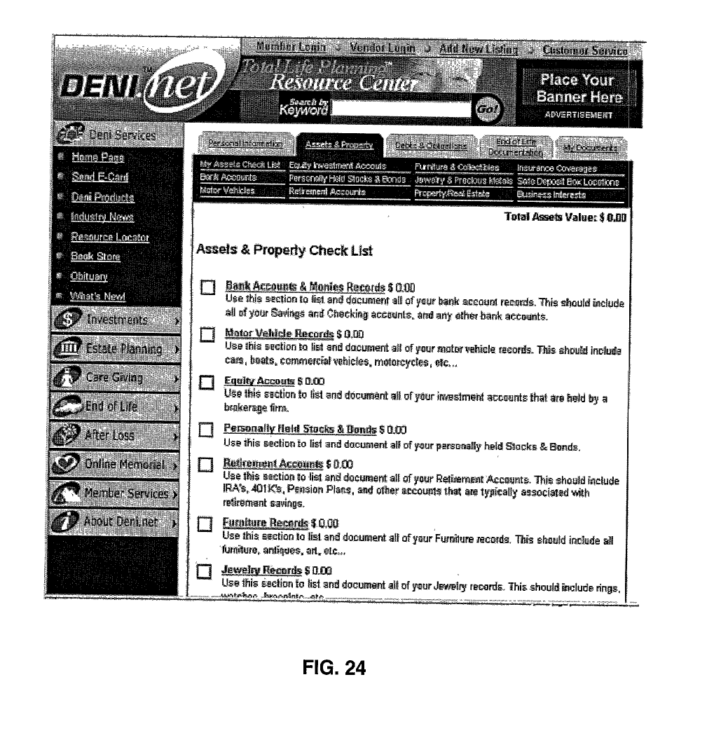

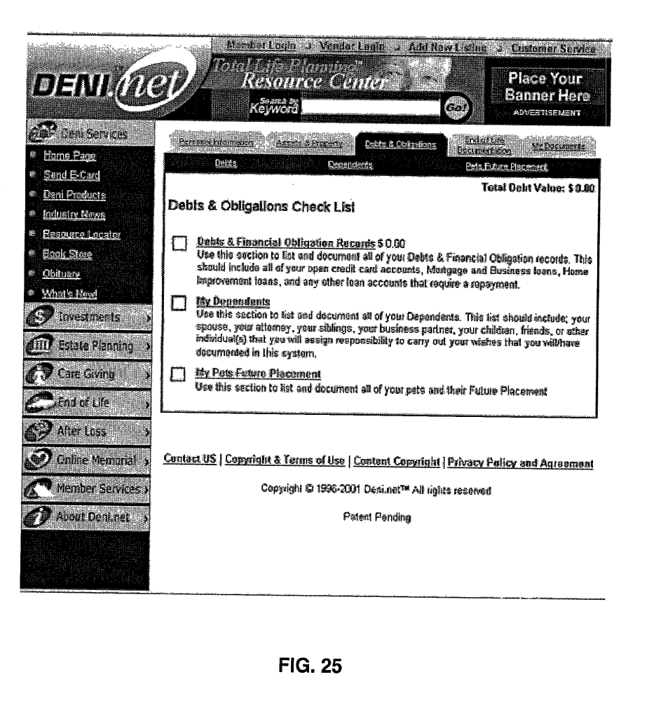

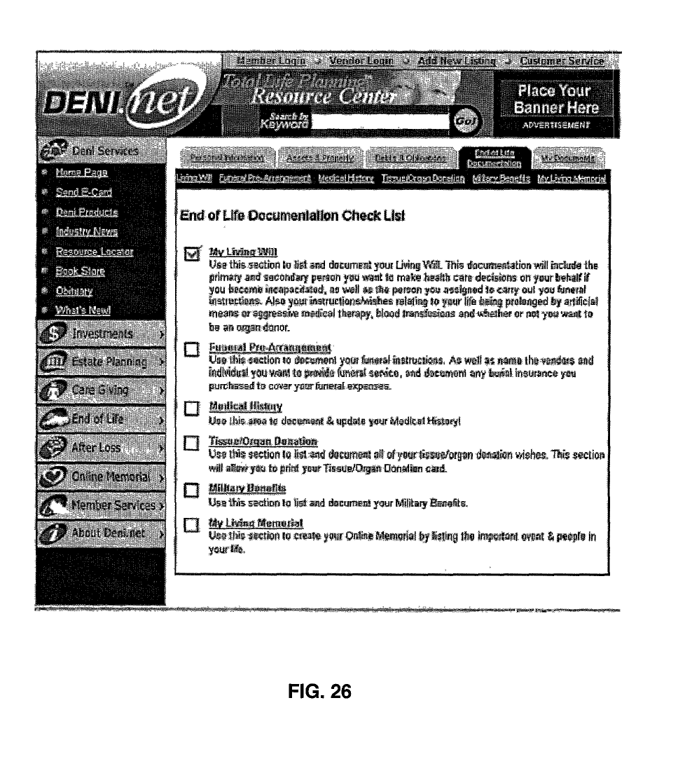

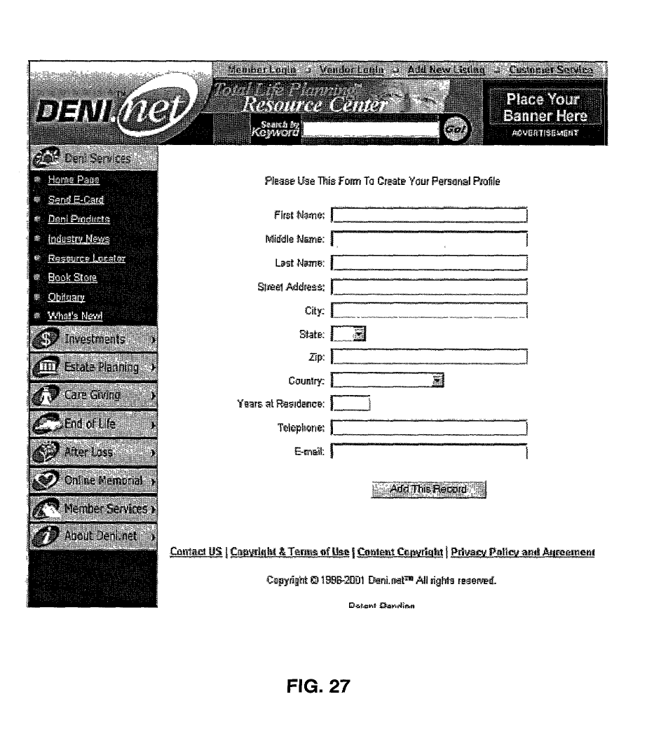

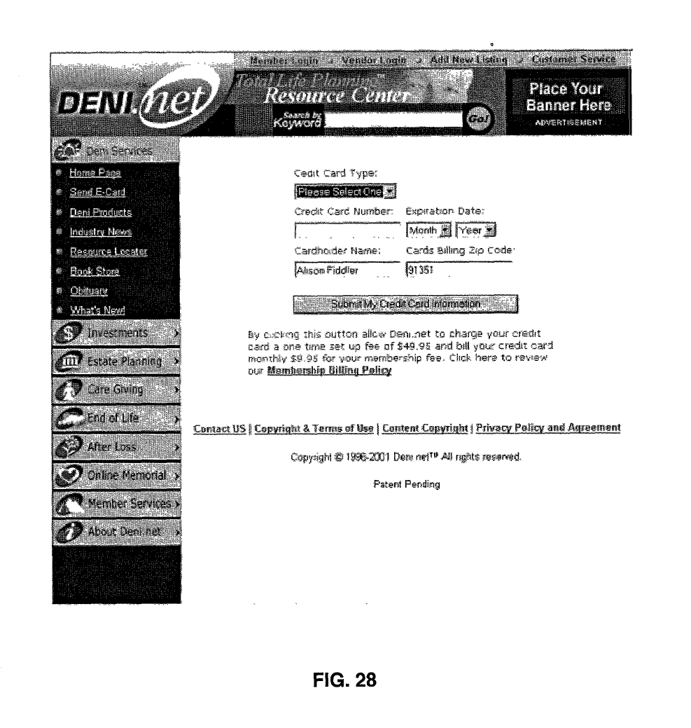

With reference to FIGS. 23-28, actual screen shots from an exemplary planning program of the present invention and implemented via the internet are provided. The program and image files for the program are included with the CD submitted herewith. FIG. 23 illustrates an exemplary home page, which provides information and various interactive features. For example, by moving a cursor to menu items, program routines are activated to provide information or to query the user. FIGS. 24, 25 and 26 provide interactive checklist pages for gathering planning information. FIG. 27 is an interactive page for gathering a personal profile, and FIG. 28 is credit card payment feature. All of these features and more may be accessed at the www.deni.net web site.

Funeral Preplanning

A Funeral Preplanning Kit, by Denise Parker, is available from Deni Resources, Inc. P.O. Box 511, Sunland, Calif. 91041. An edition of the kit including a Funeral Preplanning Workbook and a Funeral Prearrangement Form can also be obtained from the Library of Congress, registration numbers TX 4-636-530 and TX 4-509-887, respectively, both having a registration date of Aug. 18, 1997. The kit includes data collection forms and questions. These forms can be completed and questions answered on paper, or included in a computer program, preferably accessible at the deni.net web site. The amount of detail required for just this aspect of FEP demonstrates the advantages provided by the organization of the deni™ four point FEP system. For example, a textual excerpt from the deni™ workbook follows, which demonstrates the level of detail and amount of information required for a professional type FEP.

The program of the present invention substantially provides all of the information and gathers responses to all of the questions posed below, as well as numerous other features.

FUNERAL PREPLANNING WORKBOOK

Table of Contents

| | |
|---|---|
| 1. | FINAL ESTATE PLANNING CHECK LIST |
| | A checklist of all the items most families will need to complete for the final estate |
| | planning process. |
| 2. | FUNERAL PREPLANNING CHECK LIST |
| | A checklist of the type of arrangements you would want made at the time of death to |
| | prevent any emotional overspending. |
| 3. | DEATH CERTIFICATE CHECK LIST |
| | A list of whom will need a certified copy of the death certificate at the time of |
| | death. |
| 4. | FUNERAL HOME CHECK LIST |
| | A list of those items needed by the funeral home after death. |
| 5. | OUTLINE OF THE SERVICE (For the program) |
| | A listing of the order of the service for the memorial program. |
| 6. | WRITING YOUR OWN OBITUARY |
| | An outline of the information families will need for the program's obituary. |
| 7. | FRIENDS AND FAMILY |
| | List key persons that would need to be notified of the death. |

1. Final Estate Planning Checklist

Below is a list of items you will need to gather together to complete your final estate planning process. Please place copies of these items and any other necessary information in a folder (provided when kit obtained from Deni Resources):

VITAL STATISTICS RECORD

SOCIAL SECURITY DEATH BENEFIT

2 Certified copies of marriage certificate

Spouse's social security number to access social security benefits

PERSONAL HISTORY

VETERANS BENEFITS

Copies of discharge papers to be able to access free land, marker and other benefits

CONTACTS TO NOTIFY:

MAKE LIST OF KEY FRIENDS AND THEIR PHONE NUMBERS.

MAKE A LIST OF WHOM TO SEND DEATH CERTIFICATES TO.

MAKE A LIST OF CREDIT CARDS TO CANCEL.

MAKE A LIST OF ALL INSURANCE POLICIES AND THEIR NUMBERS,

AMOUNTS AND THEIR BUSINESS LOCATIONS.

CONTACT INSURANCE COMPANIES TO VERIFY POLICIES COVERAGE, AMOUNTS AND BENEFICIARIES.

IMPORTANT LEGAL INFORMATION:

WILL.

LIVING TRUST WITH POUR-OVER WILL.

DURABLE POWER OF ATTORNEY FOR HEALTH CARE.

FUNERAL INFORMATION

CEMETERY.

2 copies of deed (include marker, opening and closing information).

FUNERAL RECORDS ON FILE WITH

MISCELLANEOUS INFORMATION

2. FUNERAL PREPLANNING CHECK LIST:

Please, answer the following questions on the space provided. Some questions you may not have an answer to at this time. Leave the line blank until you do.

* FUNERAL BUDGET AMOUNT? _

* HOW WILL EXPENSES BE PAID?_{—}_

* WILL YOU BE:

_{—}_{—}_BURIED

_{—}_{—}_CREMATED

* WHERE WILL YOU BE BURIED?_{—}_

* IS YOUR CEMETERY PLOT PAID FOR? _

* WHERE WILL YOUR CREMATED REMAINS GO?_{—}_

* WHERE WILL YOUR FAMILY SAY THEIR GOODBYES TO YOU?

CHURCH SERVICE

_{—}_{—}_{—}_MORTUARY CHAPEL SERVICE

GRAVE SIDE SERVICE

PRIVATE SERVICE TO BE DETERMINED BY FAMILY MEMBERS

* WILL YOUR BODY BE PRESENT?

* WILL THERE BE A VIEWING OR WAKE THE NIGHT BEFORE? _

* WHERE ARE YOUR CLOTHES COMING FROM? _

* WILL YOU BE WEARING ANY ACCESSORIES? _

* WILL YOU BE HOLDING A:

BIBLE

ROSARY

CROSS

FLOWER

* WHO WILL DO THE COSMETIZING (MAKE UP OR SHAVING)?

* DO YOU HAVE A FAVORITE SONG? _

* WILL THERE BE AN ORGANIST? (NAME AND PHONE NUMBER)

* WILL THERE BE A SOLOIST? (NAME AND PHONE NUMBER) _

* WHO WILL BE PERFORMING THE SERVICE?

NAME & ADDRESS

PHONE NUMBER

* WHAT CHURCH DO YOU WANT THE SERVICES HELD AT?

NAME & ADDRESSD

PHONE NUMBERM

* WILL THERE BE PROGRAMS OR MASS CARDS?_{—}_

* WILL YOUR PICTURE BE ON THE FRONT?

* DO YOU HAVE A FAVORITE SCRIPTURE OR POEM READING YOU WOULD LIKE INSIDE?_

* WHAT IS YOUR FAVORITE FLOWER?

* COLOR OF THE FLOWER?

* DO YOU WANT A CASKET SPRAY?

* WILL THERE BE FLOWERS PINNED ON EACH MEMBER OF THE

FAMILY? _

* WHERE WILL THE PALLBEARERS COME FROM?

FAMILY AND FRIENDSN

FUNERAL HOMEO

* WILL THEY BE WEARING GLOVES?

* WILL THERE BE AN OBITUARY LISTING IN THE LOCAL PAPERS?

* WHICH ONES?

* WILL THERE BE A FAMILY CAR TO PICK UP AND DROP OFF THE

FAMILY?

* HOW MANY WILL BE NEEDED?

* DO YOU WANT THANK YOU CARDS?

* DO YOU WANT A SIGN IN BOOK?

* WILL THE FAMILY FOLLOW FROM THE SERVICE TO THE GRAVESIDE?

* DO YOU NEED ESCORTS?

* HOW MANY DEATH CERTIFICATES DOES THE FUNERAL DIRECTOR

NEED TO ORDER?

* WHO WILL BE IN CHARGE OF YOUR FUNERAL ARRANGEMETS AT

THE TIME?

NAME & ADDRESS

PHONE NUMBER

ADDITIONAL INSTRUCTIONS:

3. DEATH CERTIFICATE CHECK LIST:
Although the number of death certificates needed by families vary, this is
an outline that can make the planning of how many to order easier.
Certified death certificates will be needed by:
EACH BANK (Not each account)

| | | |
|---|---|---|
| BANK NAME | BRANCH | ACCOUNT NUMBER |

EACH INSURANCE COMPANY (Not for each policy)

| | | |
|---|---|---|
| COMPANY NAME | PHONE NUMBER | ACCOUNT NUMBER |

STOCK BONDS OR ANNUITIES (1 per company not per
bond, stock, or annuity)

| | | |
|---|---|---|
| COMPANY NAME | PHONE NUMBER | ACCOUNT NUMBER |

CREDIT UNIONS (1 per company)

| | | |
|---|---|---|
| COMPANY NAME | BRANCH | ACCOUNT NUMBER |

RETIREMENT FUNDS (IRA'S, SEP'S, Pensions, etc.)

| | | |
|---|---|---|
| COMPANY NAME | BRANCH | ACCOUNT NUMBER |

PROPERTY OWNED (Attach property tax information for each one)

| | | |
|---|---|---|
| LENDER | PARCEL NUMBER | LOCATION |

VETERANS ADMINISTRATION (To access benefits see pre arrangement form to complete the information needed)

SOCIAL SECURITY (Required for $ 255.00 death benefit to surviving spouse)

DEPARTMENT OF MOTOR VEHICLES (To change the title of the cars. Only one is needed)

NOTE: KEEP IN MIND DEATH CERTIFICATES WILL BE NEEDED FOR ANYTHING FOR WHICH YOUR NAME IS ON THE TITLE.

4. Funeral Home Check List:

Below is a list of items your family will need to gather together for the funeral director at the time of death. If cremation without a service is selected, personal items may not be needed.

1. CLOTHING (including underclothes)

FOR MEN: Undershirt, shorts and socks

FOR WOMEN: Stockings, slip, bra and underpants

2. COSMETICS AND/OR COLOGNE USED BY DECEASED

3. PHOTOGRAPHY OF HOW HAIR USED TO BE STYLED

4. PICTURE FOR THE PROGRAM

5. INFORMATION TO BE INCLUDED IN THE PROGRAM

6. WRITTEN OBITUARY

7. A LIST OF SIX PALLBEARERS

8. PLACE OF THE FUNERAL WITH ADDRESS AND PHONE NUMBER

9. MINISTER'S NAME WITH ADDRESS AND PHONE NUMBER

10. NUMBER OF DEATH CERTIFICATES NEEDED

11. NAME AND ADDRESS OF CEMETERY, PLOT LOCATION AND LISTING OF WHAT HAS BEEN PAID FOR

12. INSURANCE DOCUMENTS (If any are to be used for payments)

13. VETERANS DISCHARGE PAPERS (If any)

14. CENTRAL LOCATION FOR FAMILY TO BE PICKED UP THE DAY OF lo FUNERAL (If available), INCLUDING NAME, ADDRESS AND PHONE NUMBER

ADD TO THE ABOVE LIST ANY ITEMS YOU WOULD LIKE TO HAVE BURIED WITH YOU

5. Outline of a Funeral Service:

A funeral should reflect the life of the one being honored. Because your life is unique, this section will help your family plan a service or memorial distinctive to you. List your personal preferences for each item below.

SERVICES HELD AT:

OFFICIATOR:

ORGANIST:

SOLOIST:

PROCESSIONAL INFORMATION:

MUSIC SELECTION:

SCRIPTURE SELECTION:

PRAYER OR POEM READING:

MUSIC SELECTION:

ACKNOWLEDGEMENT OF CARDS, TELEGRAMS, ETC. BY FAMILY:

LISTING OF ACTIVE PALLBEARERS (6) LIST NAMES & PHONE NUMBERS

LISTING OF HONORARY PALLBEARERS (6) LIST NAMES & PHONE NUMBERS

PLACE OF INTERNMENT:

FUNERAL ARRANGEMENTS ENTRUSTED TO: (Listing of funeral home)

ADDITIONAL INFORMATION

6. WRITING YOUR OWN OBITUARY Below is an outline of how page one of the average obituary should be written for the memorial program. Included is the information you will need to complete for your family: THE LIFE OF SECTION I (Your Name) WAS BORN TO AND ON (Date of Birth) IN (City, State) (Your Name or Parents Name) IMIGRATED TO THIS COUNTRY IN, AND SETRLED IN SECTION 2 (Your Name) WAS A GRADUATE OF (List all important educational history and years graduated from) HE/SHE SERVED (List any military service and dates served, metals received and/or military accomplishments) IN YEAR, (Your Name) MET AND MARRIED. FROM THEIR MARRIAGE (OR UNION) WERE BORN (List number of sons and their names, list number of daughters and their names). SECTION 3 (Your Name), WAS AN ACTIVE MEMBER IN THE COMMUNITY, (Give a complete listing of pertinent employment, groups, clubs, organizations, memberships and volunteer functions you have taken part in) SECTION 4

IS SURVIVED BY HIS/HER SPOUSE TEIR CHILDREN (List names and the city they currently live in, number of grandchildren, surviving parents and/or grandparents) 7. FRIENDS AND FAMILY: At the time of death, family members may not know whom all your friends are or how to contact them. Use this form to list the names and phone numbers of key friends and family members to ensure everyone is notified in the time to attend the service. NAME: PHONE #: OTHIERS TO CONTACT: ATTORNEY NAME: PHONE #: DOCTOR NAME: PHONE #:_{—}_{—}

MISCELLANEOUS INFORMATION: Add to the above list, any others you would want contacted.

To receive more information about our services and us please, contact: DENI RESOURCES, P.O. BOX 511 Sunland, Calif. 91041-818-951-3364 or visit our website at www.deni.net.

Automating Life Planning

Further advantages of the deni™ four point FEP system are recognized by automating the system via an internet accessible computer program, which preferably is part of a total life planning program. These advantages include the ability to correct and update data (no need for erasers), automatically copy repetitive data (i.e., name, address, etc.) into the fields provided on the various forms (data programs, and relational database programs, such as those available from Oracle Corporation of Redwood, Calif. can be used), store a variety of types of information from various sources in one location, readily transmit all or selected parts of the information to one or more locations, summarize and analyze the data, provide automatic vendor referrals and feedback information, and make the information accessible and updateable from anywhere in the world (or space) that has internet access. Data fields can be linked with those of other deni™ clients or vendors. Thus, for example, if the beneficiary of an insurance policy held by a deni™ client is also a deni™ client and dies, the policy holder would be automatically notified. Further, billing information and fee collection can be automated as well, so that clients can have peace of mind that their final estate plans and end of life plans are adequate and will be carried out.

Final Estate Planning—Vendor Referrals

The vendors that will be referred to clients will provide services or products relating to relevant checklist item(s) that the client completed, partially completed, or for which the client did not provide any information. The list of referred vendors may vary based on the client's zip code prefix. Vendors located in or around the customer's zip code prefix will be listed first, particularly if the service offered is geographically sensitive, such as cemetery location. Preferably, only two vendors will be listed for any particular service or product. Clients will be able to click on each vendor name listed and the link will take them to the vendor's web site contained within the deni.net system, to the vendor's own home page, or if the vendor does not have a web page the client will be directed to the vendor's detail page. The detail page will contain a brief description of the vendor's products and services and contact information. The vendor referral page will also contain a search window to allow clients to search the entire deni.net vendor database.

After a client has selected a vendor, the information gathered on the registration form (or just pertinent fields thereon) and on the other relevant forms (or just pertinent fields thereon) will be sent to the vendor. The information will be stored within the vendor's deni.net database. The vendor will be notified via email that a request has been sent to them. The vendor will then need to log in and access their account records to view the client information.

Payment System

The payment system for both clients and vendors is automated. Payment information is gathered at the time of registration. All payment information is gathered and processed on a secure (SSL compliant) web server. The client and vendor's credit cards will be automatically processed, and after credit card, authorization has been received an email notification will be sent to the client or vendor.

Vendors will be required to pay an annual membership fee. At least seven days prior to the one-year expiration date an email notice will be sent to the vendor reminding them that it is time to renew their membership. Their credit card will automatically be charged unless the vendor responds to the renewal notice, notifying deni.net that they no longer wish to be a member. After the credit card is processed, an email confirmation will be sent to the vendor.

Email System

All emails gathered by clients and vendors will be stored in the deni.net database. Deni.net can have the ability through the administration section of their web site to draft bulk email messages to be sent to clients and vendors who have provided deni.net with their email address.

Online Memorial

An Online Memorial will be available to both clients and vendors. A sample block diagram program flow chart is illustrated in FIG. 21. Clients will be able to complete their own Online Memorial under the Funeral Pre-Arrangements section of the Final Estate Planning process. The Online Memorial can also be accessed from a link on the navigation frame. The Online Memorial can in one embodiment be provided free to paid member clients.

Vendors will have access to the Online Memorial through their vendor page. Vendors will be able to post an Online Memorial for their clients for a fee. Non-members will be able to purchase an Online Memorial by completing the form and submitting their payment information. An automated secure payment system will be set up to process the Online Memorial fees. To post an Online Memorial clients and vendors will need to first complete and submit the Online Memorial form.

The Online Memorial may include for example:

1. Full Name

2. Place of Birth

3. Date of Birth

4. Date of Death

5. Place of Death

6. Place of Final Disposition

7. Final Message

8. Surviving Family

9. Accomplishments

10. Photo

Obituary

Clients may be given a free three-month obituary with their membership, or this can be done for an add-on fee. A sample block diagram program flow chart is illustrated in FIG. 20 for carrying out the obituary program. Vendors can purchase a three-month obituary for their clients for a one-time fee. Additionally, non-members can purchase an obituary by completing the obituary form and submitting their payment information. The payment process will be automated and function similar to the payment system for membership and the Online Memorial. Vendors and client survivors will have access to the obituary system through account login.

The Grief Center

The Grief Center can function as an educational tool and as an aid to those dealing with the loss of a loved one. A sample block diagram program flow chart is illustrated in FIG. 15 for operating the Grief Center. The Grief Center includes informational sections on the Grief Process, Anticipatory Grief, Benefits of a Funeral in the Grief Process and The Resource Library. Furthermore, The Grief Center will serve as gateway to Obituaries, Online Memorials, Bereavement Chat room(s), to vendors providing bereavement services, and to a florist that provides delivery nationwide. Visitors to The Grief Center will be able to search the deni.net database of obituaries, and Online Memorials. Additionally, they will be able to search for a vendor in their area that provides bereavement services. Visitors will also be able to create a free electronic sympathy card. The Grief Center will also be home to the Grief Discussion Forum. The discussion forum will enable visitors to the site to post messages, ask questions, and optionally access a FAQ (frequently asked question) section, which may be linked to a central FAQ site for EOLP. Deni.net and visitors will be able to post a reply message to posted messages. When a reply message is posted, an email notice will be sent to the person that posted the original message. The majority of the educational text is already posted on the existing deni.net web site. This text will need to be reviewed and if necessary updated.

Below are examples of resources accessible from The Grief Center:

1. The Grief Process

2. Anticipatory Grief

3. Benefits of a Funeral in the Grief Process

4. The Resource Library

5. Obituaries

6. Online Memorials

7. Bereavement Chat room

8. Bereavement Service Providers

9. National Florist

10. Electronic Sympathy Cards

11. Grief Discussion Forum

deni.net Company Information

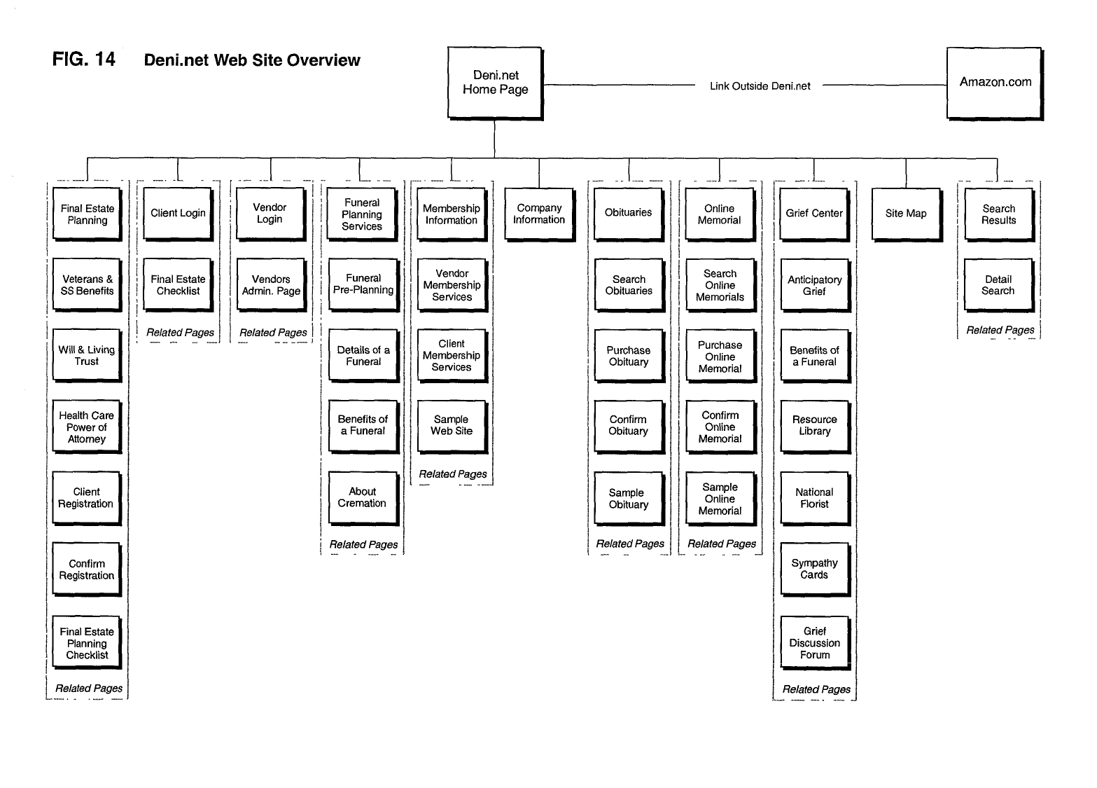

The Company Information section of the web site will provide information to visitors about the history and mission of Deni Resources, Inc and deni.net (see program module block on FIG. 14, which is directly vertically dependent from the deni.net home page block). The text for this section is currently posted on the existing deni.net web site; from time to time it will be updated to reflect the new resources available through and services provided by the organization.

Membership Information

Potential members will find a description of all of the products and services that deni.net provides, as well as the cost for each item. A sample block diagram program flow chart is illustrated in FIG. 19 for performing this function. This section will be divided into two sub-sections for Clients and Vendors.

Listed below are examples of items that will be provided in the Client section:

1. Final Estate Planning Package

2. Online Memorials

3. Obituaries

4. Living Will

5. Electronic Sympathy Cards

6. Funeral Pre-Planning

7. Burial Insurance Coverage (California Only)

8. Description of the Types of Vendors in the deni.net Database

Listed below are examples of items that will be provided in the Vendor section:

1. Basic Listing data (name, address, phone #, etc.)

2. Extending Listing Packages (URL link, business description)

3. Vendor Resources (newsletter, networking feature, vendor chat)

4. Activity Report (statistical data on client referrals)

5. Affiliate Program (vendors offer deni™ services)

6. Billing Information

7. Login Information

Electronic Sympathy Cards

With reference to FIG. 14, one exemplary program module allows visitors to create Electronic Sympathy Cards based on four template designs. Visitors can, for example, select from a number of designs or create their own custom message. Once the design and message have been selected, the visitors will then submit their email address as well as the receiver's email address. The card will then be automatically sent to the receiver. The sender and receiver's email addresses will be stored in the deni.net email database.

Free Vendor Web Page

Vendors will receive a free business description web page with their membership. The web page will be contained within the deni.net web site or hub. Vendors will create their own web page from a template system. Vendors will have the option of creating a custom web page or logo for a fee. In an embodiment, vendors will complete and submit the Web Page Form to deni.net. The information provided on the Web Page Form will make up the content for the web page. Once the vendor has completed and submitted the form, a notice will be sent to Deni.net. Deni.net will then need to review and activate the web page from the Deni.net web site administration section. After the web page has been activated, an automatic email notice will be sent to the vendor.

Database Search

In a preferred embodiment, all visitors to the Deni.net web site will have the ability to search the vendor database. The search feature will be available on every page of the web site. Visitors will be able to search for vendors by zip code, city, state, keyword(s), as well as the type of vendor. After a visitor submits their search criteria, a result page will be displayed. The result page will contain the name of the vendor and a short description of the products and services. The vendors name will be displayed as clickable hyperlinks. If the vendor has a web page, the link will direct the visitor to the vendor's web page. If the vendor does not have a web page, the visitor will be directed to the vendor's detail page, which contains contact information and a brief description of the vendor's products and services.

Affiliates Program

In an embodiment, an affiliates program is provided, including for example a national florist and a major web portal and search engine, such as amazon.com. Deni.net will preferably track visitor usage of the affiliate program. This allows vendors to offer additional resources to their clients, and creates a synergistically beneficial result to all customers and vendors using the site.

Vendor Administration

In an embodiment, Vendors will have the ability to update their records in the deni.net database. Vendors will be able to update all of the information provided during registration (see FIG. 16). Additionally, they will have access to client records, however this access will be limited. Vendors will only be able to update client records for those clients that submitted information to the vendor and only that information which pertains to the service that the vendor will be providing the client. For example, an insurance vendor can update coverage limits, beneficiary information, and send notice of overdue premiums. Vendors will have access to their administration section by logging into the system using their user ID and password.

Disclaimer Program Module

As a virtual meeting room, store, or office for various vendors in the EOLP network to meet with clients, deni.net preferably contains numerous disclaimers that must be acknowledged by its customers and vendors before deni.net arranges contact therebetween. Thus, in a preferred embodiment, all vendor referral programs include a disclaimer program module.

Deni.net Administration Section

Preferably, deni.net administrators will have global access to all information stored in the deni.net databases. Deni.net administrators will need to log into the system using their assigned user ID and password. Once they have gained access, Deni.net administrators will be able to view, edit and delete all records stored in the databases. There will be a bulk email system built into the administration section, which will enable Deni.net to send bulk email to all persons who have provided Deni.net with their email address. From the administration section, Deni.net will be able to activate vendor web pages, vendor records, Online Memorials and Obituaries. Web site traffic reports, client and vendor purchase reports will be available.

Client & Vendor Passwords

If a client or vendor enters an invalid email address or password during the login process they will receive a message that states that the information they entered was incorrect. They will be able to attempt login again after receiving the message. If a client or vendor has forgotten their password, they will have the opportunity to send an email requesting their password. Their password will then be emailed to them.

Data Backups

In an embodiment, the internet hub is for example, deni.net, and is hosted by Egress Communications Inc. with a direct link to Lorber Communications. An exemplary connectivity uplink community is Softaware, UUNET and PCNet, and an example of acceptable broadband consists of up to 8 “T3” lines. However, the number of users accessing the hub may lead to additional capacity and features being added. Further, one of skill in the art will recognize that numerous variations on acceptable hub hardware and software to accomplish the present invention are possible.

The web server preferably has a mirrored hard disk drive system, which means that any files or database records saved on the web server's primary hard disc drive will automatically be saved to a second hard disk drive. Additionally, database backups can be saved to a second server located at the Egress Communications offices in Van Nuys, California. Further, clients are sent hard copies and/or electronic copies of their EOL plan information summary, which can also be forwarded in whole or in part to relevant vendors or designated parties. For example, funeral plans, casket choice, burial plot, and other information can be automatically forwarded to a selected funeral director at the time of preparation (pre-need) or at the time the EOL plan is activated due to death or incapacity.

Client & Vendor Account Deactivation

Clients and vendors will be able to deactivate their account by selecting a link on the Final Estate Planning Checklist for clients or from the Vendor Administration Main Page for vendors. A deactivation email will be sent to Deni.net. A Deni.net representative can then deactivate or delete the client or vendor record from the deni.net Administration Section.

Development of the foregoing capabilities in a web site requires a database structure for storing programming, textual and graphical images provided to users (e.g., hub operator, clients, visitors, and vendors) and for storing client data. As client and vendor EOLP data is organized in predetermined formats, it is readily capable of compression for storage and transmission purposes.

### EXAMPLE 2

In Example 1, a web site and program was described for (1) obtaining, analyzing, maintaining and updating client end of life plans, (2) obtaining, maintaining and updating final estate and EOL plans and vendor resources, (3) providing information and a forum for FEP and EOLP, (4) providing a business to business (B2B) portal for FEP and EOLP resource vendors, and (5) providing for automated implementation of final estate and EOL plans for clients. Numerous variations in how information can be gathered and how programming can be done are possible.

In an embodiment of the computer program, after asking each question and receiving an answer, the computer will query the client whether or not they believe they have completely answered the question, and provide helpful tips on determining if they have. If they do not believe that they have completely answered the question, the computer will generate a “To Do List” (or provide a checklist of items, and/or summary of information provided) at the end of the data collection session in order to assist the client in gathering the information. When the client logs into the program again, the computer will automatically query the client on those questions that were not answered previously. A non-limiting example of a portion of a questionnaire for gathering information for EOLP is provided below:

1.0 Asset Disposition

| | |
|---|---|
| 1.1 Cash | Identify all cash assets; for each bank account identify the |
| | bank, account number and current balance. Also enter, if |
| | known, a telephone contact number for each account number. |
| 1.2 Real Estate | For each piece of real estate, identify the address and/or map |
| | plot number and percentage ownership and whether it is a |
| | tenancy in common, joint tenancy or tenancy by the entirety |
| 1.3 Personal Property | Identify all personal property, such as cars, jewelry, electronic |
| | equipment, and furniture (do a complete household |
| | inventory). It is recommended to videotape and/or take |
| | photographs, and if you have done so, simply refer to where |
| | the location of the photographs are or digital video. In a |
| | preferred embodiment of the deni.net site, digital photos and |
| | video can be stored on a central computer file with all other |
| | client data. |
| 1.4 Insurance and other | List all insurance policies by company name(s), account |
| financial instruments | number, policy limits, dates that premiums are due, |
| | representatives, beneficiaries, and policy amounts. List all |
| | stocks, bonds and annuities by company or in the alternative |
| | identify a brokerage account, telephone number and broker |
| | where this information can be obtained. |
| 2.0 Fiscal And Human Care | |
| Responsibility | |
| 2.1 Family | Identify your current spouse, full name and social security |
| | number. Current location if other than your residence address |
| | above. Spouse date of birth. Identify all children and other |
| | legal dependents by name, social security number, date of |
| | birth and current known address if different than yours. |
| 2.2 Employer Information | Identify your employer and contact person in the event of |
| | disability or death. Also list below any specific instructions |
| | for your employer in the event of your death or permanent |
| | disability. Also identify contact person for all employee |
| | benefits. |
| 2.3 Military | Did you serve at least two years in the military or were you |
| | permanently injured during the first two years of service? If |
| | you are a veteran, specify so and identify your military serial |
| | number below and any wars or conflicts that you served in, |
| | and include date of induction and date of discharge and rank |
| | at discharge. Indicate what branch of military service you |
| | served. |
| 2.4 Guardian | Who will be the guardian of your minor children in the event |
| | that both you and your spouse are disabled or deceased? |
| | Identify the caregiver, current address, telephone number and |
| | any professional affiliations, i.e. hospital, etc. |
| 2.5 Pets | Identify any pets. What type of pet? Description, age of pet |
| | and desired disposition of pet (i.e. gift to a particular family, |
| | or particular pet retirement home and/or animal hospital to |
| | which animal should be taken. |
| 3.0 Creditors | List all current creditors, including mortgages, rental |
| | payments due, credit cards, utilities, loans, etc. For each |
| | creditor, identify the name of the creditor, address, account |
| | number, amount owed and/or monthly payments and list a |
| | contact number for each creditor. |
| 4.0 Care of Body Before | Identify any assistant, moving and/or long-term healthcare |
| And After Death | plans or preferences. If you haven't already done so under |
| (Corporal Disposition) | asset disposition, identify all healthcare, insurance plans along |
| | with plan number and contact telephone number. |
| 4.1 Organ Donation | Do you wish your organs donated? If you wish this limited it |
| | to any specific organs, please identify the organs (i.e. eyes, |
| | kidneys, liver, etc.). Do you wish to be maintained on life- |
| | support when death would otherwise be imminent in the |
| | absence thereof? |
| 4.2 Blood Transfusions | Do you object to blood transfusions, even if necessary to save |
| | your life? |
| 5.0 Informant | Identify one person and an alternate along with address, |
| | telephone number and any other relevant contact information |
| | that will be responsible for making decisions upon your |
| | disability and/or death. |
| 6.0 Funeral Arrangements. | |
| 6.1 How | Do you plan on being buried or cremated? If cremated, skip to |
| | 6.2.1 |
| 6.1.2 Burial, Where | Where will you be buried? |
| 6.1.3 Payment plan | Is your cemetery plot paid for? |
| 6.2.1 Cremation | Where will your remains go? |
| 6.3 Funeral, Where | Where do you wish your final services to be held (i.e. church, |
| | mortuary chapel, gravesite, indoor private service)? |
| 6.3.1 Corpus at Funeral | Will your body be present for your funeral service? |
| 6.3.2 Wake | Will there be a viewing or wake the night before? |
| 6.4 Who | Do you have an agreement with a funeral home, or a preferred |
| | funeral home that you wish contacted in the event of your |
| | death? |
| 6.4.1 Prearranged Funeral | Do you have a pre-need file established with any particular |
| | funeral home? |

The foregoing are merely sample questions that may be asked in portions of a data collection session.

### EXAMPLE 3

A non-limiting example of a portion of a narrative program flow chart for registering and gathering information for EOLP is provided below.

A. REGISTRATION PROCESS

1. OBTAIN AND STORE CLIENT BILLING INFORMATION,

INCLUDING PASSWORD

2. ESTABLISH ACCOUNT

3. PAYMENT CONFIRMED?

4. IF NO, Advise User

IF YES, EMAIL CLIENT ACCOUNT NUMBER & PASSWORD

(Send via regular mail at client option)

B. DATA GATHERING SESSION: CLIENT ACCESSES SITE/OR PROGRAM, AND ENTERS CLIENT NUMBER AND PASSWORD

1. PASSWORD MATCHES ACCOUNT NUMBER?

IF NO, Advise User

IF YES, RECALL CLIENT DATA AND INITIATE INTERACTIVE DATA ACQUISITION PROGRAM

2. HAS CLIENT USED PROGRAM BEFORE?

IF NO, GO TO NEXT STEP (#3)

IF YES, Skip to step 4

3. INITIATE DATA ACQUISITION PROGRAM (INTERACTIVE QUESTIONAIRE), STORE DATA AS COLLECTED, GENERATE “TO DO LIST” AND “REFFERAL LIST”

4. PROVIDE CLIENT WITH MENU

A. REVIEW ACCOUNT DATA

B. RESUME PLANNING ASSESSMENT PROCESS WHERE YOU STOPPED (Go to step 3)

C. ENTER DATA REQUESTED ON “TO DO LIST” GENERATED FROM PRIOR SESSION

D. SELECT FROM LISTS OF CATEGORIES TO ENTER DATA

5. ASK CLIENT IF THEY WANT INTERIM OR COMPLETE REPORT SENT TO PARTICULAR PERSON(S)

6. ASK CLIENT IF THEY WISH FOR PRINTED INTERIM OR COMPLETE REPORT TO BE SENT TO THEM BY MAIL

7. DOES CLIENT WISH FOR COMPUTERIZED RECORD TO BE DESTROYED AFTER RECEIPT OF PRINTED COPY CONFIRMED?

8. WOULD CLIENT LIKE TO HAVE REFERRALS TO END OF LIFE PLANNING RESOURCES?

IF YES, INITIATE REFERRAL PROGRAM TO IDENTIFY RESOURCES THAT MAY BE HELPFUL TO CLIENT AND SEND CLIENT NAME, EMAIL AND/OR PHYSICAL ADDRESS TO RESOURCES, PROVIDE RESOURCE INFORMATION DIRECTLY TO CLIENT AND ALLOW CLIENT TO ACCESS RESOURCES DIRECTLY VIA WEB SITE, OR DIRECTLY LINK CLIENT TO RESOURCE WEB SITE

IF NO, end session, and forward reports requested by client.

C. FOUR POINTS OF FINAL ESTATE PLANNING DATA ACQUISITION PROGRAM (INTERACTIVE QUESTIONAIRE)

THE FOLLOWING INTERACTIVE QUESTIONAIRE ASKS QUESTIONS DESIGNED TO GATHER DATA NEEDED TO ASSESS WHETHER OR NOT ALL FOUR POINTS OF FINAL ESTATE PLANNING HAVE BEEN ADEQUATELY MET. WHETHER OR NOT YOU ARE SATISFIED WITH YOUR END OF LIFE PLANS IS SUBJECTIVE. HOWEVER, BY ANSWERING THESE QUESTIONS AS COMPLETELY AS POSSIBLE, YOU CAN GAIN A BETTER UNDERSTANDING OF OPTIONS AVAILABLE AND THEIR COST, THE STATUS OF YOUR END OF LIFE PLANS, AND HAVE PEACE OF MIND THAT, WHATEVER YOUR PLANS ARE, SOMEONE WILL KNOW THEM AND BE CHARGED WITH CARRYING THEM OUT.

THE FOLLOWING QUESTIONS ARE BROKEN INTO FOUR CATEGORIES:

1. WHAT ARE YOUR ASSETS?

2. WHAT ARE YOUR LIABILITIES (FISCAL AND OTHERWISE)?

3. WHAT DO YOU WANT DONE WITH YOUR BODY BEFORE AND AFTER DEATH?

4. WHAT PROVISIONS HAVE YOU MADE FOR HANDLING YOUR ASSETS, LIABILITIES AND BODY SHOULD YOU BE DISABLED OR DIE?

The foregoing is merely exemplary of a portion of a narrative program outline for accomplishing an embodiment of the present invention.

### EXAMPLE 4

As is readily evident from the foregoing examples, there are a variety of ways to describe and implement the present invention. A description of an alternative embodiment follows.

The 4 Points of Final Estate Planning (4 Point FEP) system can be implemented via a Final Estate Planning Check List and associated programming to give families worldwide access to a complete final estate planning system that can be part of a complete EOLP system. This 4 Point FEP system methodically determines what points of preparation have been successfully completed as well as reveals those plan components that have yet to be made. In order to assist clients in completing plan components that have not been initiated or completed, the system provides for vendor referrals directly, via hyperlink and/or e-mail. Service providers are referred from the local community of the client and/or from within the community that the one in need of services lives (i.e., long distance caregiving). This system enables clients not only to complete the final estate preplanning process, but also to personally customize a final estate and/or EOL plan by utilizing their own unique financial circumstances and individually pertinent information that they provide in the process.

Clients that register with deni™ and submit payment are then issued a permanent file identification number (via e-mail). Clients are invited to re-enter the site (e.g., http://www.deni.net) and are forwarded to a 4 Points of Final Estate Planning Check List to begin the documentation and completion of their final estate preplanning process. Within a secured location, a database stores all the information obtained from the client, allowing them to return to their file in order to update, make changes and/or to complete the process. Once all of the check list components have been completed, a copy of the file number can then be forwarded to (a) the person listed in charge of future arrangements, (b) an attorney selected by client, and/or (c) an end-of life provider. This is done only if requested by client at the time the file is completed (via an automatic forwarding system using internet technologies). This enables future survivors/caregivers access to all vital information required when a medical emergency and/or death does occur. The client is also encouraged to print out copies of their Final Estate Planning Summary and Assessment, created by Deni's automated system, or from a professional planner that has evaluated the information provided to deni™, based upon their individual preplanning assets and needs.

An embodiment of an EOLP program is described below which includes steps to perform the deni™ FEP 4-point system.

#1 Registration

The client is requested to list, in response to prompts, information including: e-mail address, full name, complete date of birth and location, address, city, state, zip code, phone number, number of years at current residence, social security number, spouse's full name (and maiden name), current age, total number of years employed to date, occupation, name of employer and type of business, as well as father's full name and birthplace, mother's full name and birthplace.

#2 Completing Registration

After the registration form is complete, the client is prompted to establish a personal logon code, as well as a password. The client is asked to complete a payment processing form which will allows submission of payment via secured internet payment processing technology.

#3 Confirmation

An e-mail confirmation and welcome letter is sent to the client as receipt of payment. Within that letter, a personal access number (or code), generated by information provided by the client, is given to the client, which consequently provides him/her access to their files. This code can be used at any time by the client to gain entry to the secured section of the site to begin or continue processing of their Final Estate Planning Check List (based on 4 Points of Final Estate Planning System).

#4 Acquisition of Client EOLP Data

The client returns to the “4 Point” site location and types in his/her code and is automatically sent to the next step.

#5 Asset Data Acquisition

Point number 1 of the 4 point process appears on screen: “What is to happen to your assets?” (asset allocation). The client is requested to list all assets in response to prompts: i.e., all personal property such as furniture, jewelry, cars, monies held in banks, trusts and mutual funds, insurance policies (e.g., those personally purchased or provided by employer, including life, term, burial and mortgage), stocks, bonds, annuities, retirement accounts and vehicles that they own. Possible future inheritances and other items that the client may acquire can also be entered. The client is prompted to provide the names of companies/firms (used to hold monies), addresses, phone numbers, policy numbers, account numbers, total monies held, the estimated value of each individual asset listed, and the location of the asset or documents evidencing asset ownership or entitlement.

#6 Processing Assets

The program saves the asset data, totals the amounts inserted within an estimated value section, saves that total, and inserts the total into the Final Estate Planning Assessment Report, which will be provided to client at the end of the final estate planning process within the “assets allocation-total of current assets” section.

#7 Optional Save Step

The client is prompted, at any time within the process, to save listed data within that page so that completion of forms can take place at another time, if needed. An automatic data saving function can be executed periodically to keep users from losing data entered but not yet saved.

#8 Continuing

The system tracks where the client last ended in the process, and the client is then taken automatically to the next step within the process. Point number 2 of the “4 Point” process appears on screen. “How have you provided for your responsibilities?” (fiscal, ethical and moral responsibilities)

#9 Gathering Obligation Information

The client is requested to list all debts, including lender name, address, phone number, amount owed, account number, etc., with separate prompts for mortgages, credit cards, car loans, and for listing any items not specifically requested, number of minor children and ages, list future care givers, estimate amount needed to provide for children until age 18 and/or through college, estimate spouse's support for a minimum of five years (program will include a module, show a chart listing how to calculate this amount), number of pets and their future placement, as well as promptings to list names, addresses and phone numbers for anyone for whom they hold power of attorney or to which they may be potentially obligated.

#10 Processing Obligation

The program saves client obligation data, then totals the amounts provided by the client within the “$ owed” section. The total is saved and inserted into the Final Estate Planning Assessment Report to be provided to the client at the end of “4 Points” of final estate planning process within the “fiscal and moral responsibilities” section total of current debts section. Noting the possible need for additional insurance coverage required by the client, the client is referred to a list of preferred insurance vendors/financial planners within the deni™ data base, located in the client's zip code area, or the client can authorize vendor referral by deni.net. The client can then gain direct contact with the selected vendor(s) via an e-mail or hyperlink letter stating that they were referred by deni™, noting the area(s) of current need.

#11 Continuing

The system tracks where the client last ended in the process and then the client is taken automatically to the next step within the process. Point number 3, step 1, of the “4 Poinf” process appears on screen. “What do you want done with your body before and after death?” (end-of-life provisions)

#12 Assisted Living and Corporal Disposition

The client is then educated on the role of assisted living services and long-term health care coverage within the end-of-life preplanning process. The client is requested to list all prompted information, stating if they currently have long term care coverage and/or any medical insurance funding, as well as list for each provider the name, address, phone number, policy number, and type of coverage.

#13 Referral

If no or inadequate insurance plans are listed, the program will save the data, and the client is referred to a listing of preferred insurance resources, and long term care and medical providers from the deni TM data base, preferably located within or close to the client's zip code area. The client can then gain direct contact with the selected vendor(s) via an e-mail or hyperlink letter stating that they were referred by Deni, noting the area(s) of current need, and/or complete price comparisons to make a selection at that time.

#14 Medical Insurance

The system tracks where the client last ended in the process, and the client is taken automatically to the next step within Point number 3, step 1, of the “4 Point” process which appears on screen prompting the client to complete the selection process for a medical insurance coverage provider. The program saves the data and inserts it, at the completion of this process, into the Final Estate Planning Assessment Report to be provided to client at the end of “4 Points” of final estate planning process within the “end-of-life provisions” section.

#15 Organ Donation

The system tracks where the client last ended in the process and the client is taken automatically to the next step within the process, Point number 3, step 2, of the 4 point process appears on screen. The client is then educated on the importance of and need for organ donation(s), and requested to list all prompted information needed regarding future organ donation, if desired, as well as providing a listing of the client's name, address, city, state, current doctor's name and contact information and phone number of next of kin to be contacted with a request by the client to be considered for organ or land tissue donation and/or giving a brief list of only “these organs to be considered”.

#16 Organ Donation Card

The program saves organ donation data and the organ donation data is inserted into a wallet size card format for the client. The client is prompted to print out their personalized organ donor card with their desired requests and the information supplied in step #15, and asked if they would like a laminated card to be mailed to them.

#17 Continuing

The program saves the client's data and processes the data for insertion into the Final Estate Planning Assessment Report to be provided to client at the end of the “4 Points” of final estate planning process within the “end-of-life provisions” section.

#18 Living Will

The system tracks where the client last ended in the process, and the client is taken automatically to the next step within Point number 3, step 3, of the “4 Point” process that appears on screen. The client is then educated on Living Wills/Advance Healthcare Directives with Durable Powers of Attorney for Healthcare. The client is requested to list all prompted information needed to complete the Living Will/Advance Healthcare Directive with Durable Power of Attorney for Healthcare Form. This form also requests the name, address, city, state, zip code, phone number of the client (these data fields should have been completed during registration so can be copied automatically), as well as the name, address, city, state, and phone number of (a) one primary person to represent them in a medical emergency, and (b) one secondary person to represent them in an medical emergency. The client is then prompted to check off their desired wishes regarding life support, blood transfusions, and the person they designate to be named, after death, as the person in charge of future arrangements. They are also prompted to create a brief statement documenting how they would wish to be cared for by future caregivers.

#19 Living Will/Advance Healthcare Form Generation

The program saves data that was inserted and prepares a multi page document which includes areas that will enable the client to (a) sign and date, within the presence of three witnesses, or (b) sign and date within the presence of a notary public.

#20 Living Will Printout

The client is then prompted to print out their personalized Living Will/Advance Healthcare Directive with Durable Power of Attorney for Healthcare Form

#21 ID Card Printout

The program prompts the client to print out a wallet size information card stating: ‘“CLIENT NAME” has completed an Advance Healthcare Directive and Durable Power of Attorney for Healthcare Form. Please Contact: “CONTACT NAME (S)”, and the ID card provides other information, such as address(es) and phone number(s). For example, both sides an exemplary ID card are provided below:

[image]

#22 Continuing

The program saves data including whether or not a form and/or ID card was printed out.

#23 Prearranged Cremation/Funeral Arrangements

The system tracks where the client last ended in the process and the client is taken automatically to the next step within Point number 3, step 4a, of the “4 Point” process which appears on the screen as prearranged cremation/funeral arrangements. The client is then educated on funeral, burial, and cremation options. The client is requested to list all information as prompted to provide information required by state departments of health for the completion of a certified death certificate. The program's automated system shows all information completed within the registration process, and requests that the client list the name address, and phone number of the firm that will be asked to pick up the body (i.e., funeral home, cemetery, etc.) after the death takes place.

#24 Referral to Healthcare Providers

If no healthcare provider is listed by the client, the program will save the data entered and the client is referred to a listing of preferred deathcare firms/providers within the deni™ data base, preferably located in or close to the zip code of the client. The client can then gain direct contact with the selected vendor(s) via an e-mail or hyperlink letter stating that they were referred by deni, noting the area(s) of current need, and/or complete price comparisons to make a selection at that time.

#25 Continuing

The system tracks where the client last ended in the process and the client is taken automatically to the next step within Point number 3, step 4a, of the “4 Point” process that appears on screen prompting the client to complete the selection process for a deathcare service provider including current e-mail address listed within deni's data base. The program saves that data and inserts it at the completion of this process into the Final Estate Planning Assessment Report to be provided to client at the end of “4 Points” of final estate planning process within the “end-of-life provisions” section.

#26 Post Death Arrangements

The system tracks where the client last ended in the process & the client is taken automatically to the next step, Point 3 Step 4b. The client is requested to list all information as prompted to assist future caregivers/survivors in making funeral, cremation and burial arrangements. The client is asked for a current end-of-life funding budget; how expenses are to be paid, (i.e., insurance, cash etc.) or if any have been prepaid, listing name, address, city, state, phone number, and file number of those prepaid plans; cemetery plot locations, funeral plans, if they are to buried or cremated; name, address and phone number of the location they are to be buried; what is to be done with their cremated remains if cremated, what type of service will they have (church, mortuary, grave side or private arrangement determined by family); will their body be present for the service; is there anything they'd like buried/cremated with them; the name address, and phone number of the person to perform service; the name, address and phone number of the location they would like the service held; the name, address, city, state, zip code, phone number, and relationship of the person they have listed in charge of completing and carrying out their final interment requests; and what type of container or casket will be used (i.e., wood or metal)?

#27 Casket Selection

The client is then prompted to select to (a) purchase a casket from a funeral home or (b) purchase a casket from a wholesale vendor. If ‘purchase from whole sale vendor’ is selected, the program will save the provided data and the client is referred to a listing of wholesale casket vendors within the deni™ database, preferably in or close to the client's zip code. The client can then gain direct contact with the selected vendor(s) via an e-mail or hyperlink letter stating they were referred by Deni, noting the area(s) of current need and/or complete price comparisons to make a selection at that time.

#28 Continuing

The system tracks where the client last ended in the process and the client is taken automatically to the next step within Point number 3, step 4b, of the “4 Point” process that appears on screen, prompting the client to complete the selection process for a deathcare service provider-casket. The program then saves that data and inserts the data and completion of this process into the Final Estate Planning Assessment Report to be provided to client at the end of “4 Points” of final estate planning process within the “end-of-life provisions” section.

#29 Corporal Disposition

The system tracks where the client last ended in the process and the client taken automatically to the next step. Point 3, Step 4c. The client is then requested to list all information as prompted to assist future caregivers/survivors in completing funeral, cremation, and/or burial arrangements. The client is asked if the place determined for interment is (a) within the area they live or (b) out of state. If out of state is selected, the client will be prompted to complete the name address and phone number of the receiving deathcare service provider or relative.

#30 Corporal Disposition Referral

If no name, address, or phone number is listed for corporal disposition, the client is referred to a listing of preferred providers within the deni™ data base, preferably in or close to the zip code of the client. The client can then gain direct contact with the selected vendor(s) via an e-mail or hyperlink letter stating they were referred by deni™, noting the area(s) of current need and or complete price comparisons to make a selection at that time.

#31 Continuing

The system tracks where the client last ended in the process and the client is taken automatically to the next step within Point number 3, step 4c, of the “4 Point” process which appears on screen prompting the client to complete the selection process for a deathcare service provider. The program saves the data and inserts it at. The completion of this process into the Final Estate Planning Assessment Report to be provided to client at the end of “4 Points” of final estate planning process within the “end-of-life provisions” section.

#32 Other Post Death Plan Details

The system tracks where the client last ended in the process and the client is taken automatically to the next step Point 3, Step 4d. The client is requested to list information as prompted to assist future caregivers/survivors in completing funeral, cremation, and burial arrangements. The client is asked how many death certificates will be ordered by the deathcare service provider, if they will using veterans burial benefits to gain assess to free cemetery property for themselves and/or their spouse (if “yes,” the client completes the section within the form requiring a listing of veterans serial number, date, and place of induction and discharge, branch of service, and in which war or conflict they served).

#33 Continuing

The program saves the data and inserts the data at the completion of this process into the Final Estate Planning Assessment Report to be provided to client at the end of “4 Points” of final estate planning process within the “end-of-life provisions” section.

#34 Documenting and Funding Plans

The system tracks where the client last ended in the process and the client is taken automatically to the next step. Point number 4a, of the “4 Point” process appears on screen. “What have you done to document and fund all of the above?” The client is then educated on the importance of wills and or living trusts. The client is requested to check off as prompted information needed to complete the final estate preplanning process, i.e., have they completed a will, a pour over will, advance healthcare document (available earlier in the program), and a living trust, as well as listing the name, address, and phone number of the attorney/legal firm that assisted in that process.

#35 Referral to Legal Resources

If no will or living trust is listed by the client, the program will save the data entered, and the client is referred to a listing of preferred legal resources within the deni data base, and in or close to the zip code of the client. This referral, as with others, is preferably contingent on the client acknowledging a disclaimer. The client can then gain direct contact with the selected vendor(s) via an e-mail or hyperlink letter stating they were referred by deni.

#36 Continuing

The system tracks where the client last ended in the process and then the client is taken automatically to the next step within the process. Point number 4, step 4a, of the “4 Point” process which appears on screen prompting client to complete the selection process for a legal service provider. The program saves that data and inserts the data at the completion of this process into the Final Estate Planning Assessment Report to be provided to the client at the end of the “4 Points” of final estate planning process within the “end-of-life provisions” section.

#37 Funding Plans

The system tracks where the client last ended in the process and the client is taken automatically to the next step within Point number 4, Step 4b. The client is requested to list as prompted information needed to assist future caregivers/survivors in completing the funding of future funeral, cremation and burial arrangements. The client is asked to check that all beneficiaries listed on current policies and accounts have been brought up to date, and if they have future funeral/cremation arrangements prepaid, to list the name, address, city, state, and phone number of the provider.

#38 Burial/Funeral Insurance Referral

If there are no future arrangements prepaid by the client, the program will save the data and the client is referred to a listing of preferred burial insurance/prepaid funeral plan providers from the deni™ data base, preferably located in or near the zip code of the client. The client can then gain direct contact with the selected vendor(s) via an e-mail or hyperlink letter stating they where referred by deni™, noting the area (s) of current need and/or complete price comparisons to make a selection at that time.

#39 Continuing

The system tracks where the client last ended in the process and the client is taken automatically to the next step within Point number 4, step 4b, of the “4 Point” process that appears on screen prompting the client to complete the selection process for a prepaid service provider. The program saves that data and then inserts the data at the completion of this process into the Final Estate Planning Assessment Report to be provided to the client at the end of “4 Points” of final estate planning process within the “end-of-life provisions” section.

#40 Forwarding of Data to Funeral Provider

The system tracks where the client last ended in the process and the client is taken automatically to the next step within Point number 4, Step 4c. The client is asked if they would like to have both their vital statistics and funeral service information provided in Point number 3, 4 a, b, c and d of the final estate planning check list forwarded to the funeral service provider selected, and to set up a preneed funeral service file. If the client checks “yes,” the e-mail address listed for that service provider from the deni™ database, will be shown. The client is then able to, via e-mail, forward the desired information, at that time, directly to the firm they have listed to complete that process. An optional confirmation/follow-up program module may be implemented here.

#41 denicard™

The system tracks where the client last ended in the process and the program saves that data and inserts the data and completion of this process into the Final Estate Planning Assessment Report to be provided to the client at the end of “4 Points” of final estate planning process within the “end-of-life provisions” section after which time the client is taken automatically to the next step. The client is prompted to print out their personalized deni™ Emergency Identification Card, or denicard™, listing their access code number provided within the registration process, and optionally their name, address, city, state, phone number. The denicard™ also provides contact information and instructions for communicating with the contact.

#42 Print Out Assessment Report

The client has now completed the “4 Points” of Final Estate Planning Check List. The client is invited to print out their personalized Final Estate Planning Assessment Report that includes:

Letter of congratulations, including client's name and file number.

A listing of all vital statistics provided during the registration process.

A listing of all data provided regarding assets within Point number one, under the heading of asset allocation. This listing includes a total of the dollar value(s) of assets provided by the client.

A listing of all data provided regarding responsibilities and debts within Point number two under the heading of fiscal, ethical and moral responsibilities, including a total of the dollar value(s) owed.

A listing of all information provided within point number three, under the heading of end-of-life provisions.

A listing of all information provided within point number four, under the heading of end-of-life provisions.

A listing of all the areas not completed within each point with notes to the client regarding these deficiencies.

A listing of all registered deni™ service providers within the client's zip code area.

#42 Plan Forwarding

The client is then asked if they would like a copy of their completed fileand/or, or their file number/access code sent to (a) the person(s) listed in charge of future arrangements, and/or (b) an attorney selected by client. The client is then able to, via e-mail, forward the desired information (i.e., file, access code and/or file number) at that time, to the individual(s) that they list. This is done by the client submitting the addressees name, address, city, state, phone number, and e-mail address within the space provided.

#43 Client Data Storage

The program saves that data and inserts the data at the completion of this process into the Final Estate Planning Assessment Report to be retained within the deni TM client database. All client information now housed within the deni™ database can be accessed by: the client, the assigned caregiver(s)/person(s) listed in charge of future arrangements, the assigned attorney, the coroners office, and/or emergency medical personnel. Files can be removed from the system at the request of the client, or certification of the death of the client.

The 4 Points of Final Estate Planning is a simplified preplanning system and questioning process that assists families, care givers, attorneys, funeral directors, health care providers and insurance agents in determining what has been taken care of and what has yet to be done. Although not everything can always be planned for in advance, this final estate planning system is designed to ensure that the emotional, physical and financial needs of the one dying and of future survivors will be met.

However, since all of the industries involved in providing some form of service to those preparing for end-of-life are accustomed to working independently of each other, families are now given a single place to go to that will assist them with assessing all planning components taking into account their own life style and circumstances—before a painful event. The 4 Points of Final Estate Planning changes the current paradigm and unites all industries within the final estate planning process into one common goal/result. deni™ Resources takes the 4 Point system and integrates it into a comprehensive network of final estate planners and other resources.

As used herein, assets includes but is not limited to any and all personal property, money, insurance policy benefits, vehicles, possible social security benefits, future inheritances etc. Obligations includes but is not limited to monies owed, i.e., (bills don't die because we do), requirements for maintaining the standard of living for surviving spouse and or minor children, pets, or any other legal or moral commitments or desires. Assisted Living and Corporal Disposition Plans includes but is not limited to assisted living and/or long term health care, life support instructions, advanced care directives, organ donations, funeral, cremation and or internment arrangements. Funding and Documentation of EOC Plans includes but is not limited to applying assets, such as savings, investments, long term care and life insurance to cover debts and comprehensive advance health care directives stating all end-of-life wishes, i.e., life support, pain control, who's in charge even after the death, blood transfusions, organ donor requests, living trusts, wills, powers of attorneys, living trusts, preplanned funeral & internment arrangements, etc.

The 4 Points of Final Estate Planning System address many of the repeatedly overlooked aspects of final estate planning. Designed to be a completely integrated and automated system, representing the best interest of the public, this model via Deni (a death education need information resource) will educate families in all aspects of final estate planning without conflict of interest, while also educating them to the importance of preplanning before a painful event takes place. Families/end-of-life care professionals that are either planning ahead, facing a death or have just experienced a loss are given access and vital information to assist them via 8 departments:

a. member services (a nationwide program to target, enroll & list within the directory professionals that specialize in any form of end-of-life care and services allowing them to network with each other. The system also allows users to keep each other up to date on industry changes etc.)

b. healthcare providers (national directory of hospitals, care organizations, hospices palliative care providers, etc.);

c. coping with loss (grief articles, resource listing, directory of bereavement professionals & resources nationwide, etc.);

d. death care services (burial, cremation, burial insurance, caskets, funeral trusts, directory of funeral service providers nationwide etc.);

e. aging services resources & current issues & organizations (state & federal related programs, i.e., victim's assistance etc.);

f. estate planning legal (wills, living trusts, living wills & online ordering forms, directory of estate planning attorneys nationwide etc.);

g. gifts of love (i.e.,: articles on organ donation, on-line organ donor cards and new break throughs within the end-of-life care profession, flower ordering services, e-cards, books, kits, on-line organ donor cards etc.); and

h. end of life pre funding options (insurance, long term care, assisted living, prepaid interment arrangements).

While exemplary embodiments of the invention have been described, numerous variations are envisioned to fall within the scope of the following claims.

I claim:

1. A device for providing and obtaining information about the owner or bearer thereof, comprising:
a first medium for storing information, and
identity information stored on said first medium, wherein said identity information includes a code for identifying the owner or bearer of the device and contact information, said contact information comprising instructions for communicating with a contact entity, wherein, in the event of the incapacity or death of the owner or bearer of the device, communication of said code to said contact entity causes instructions stored by said owner or bearer relating to the incapacity or death of same to be implemented, wherein said instructions comprise at least one of the group consisting of: information required to complete a death certificate, health insurance information, organ donation desires, funeral information, long term care desires, a living will, life insurance information, family information, and representative information.

2. The device of claim 1, wherein said device includes words to advise a viewer thereof to communicate said code to said contact entity in the event of the incapacity or death of the bearer.

3. The device of claim 1, wherein said contact information comprises at least one of the following contact communication details: a phone number, an email address, a facsimile number, a physical mailing address, and an internet address.

4. The device of claim 1, wherein said identity information is not damaged by contact of said device with water.

5. The device of claim 1, further comprising a second medium for storing information, said second medium selected from the group consisting of an electronic data storage device and a magnetic data storage device, wherein said second medium can be used to store information about the assisted living and final estate plans of the bearer or owner.

6. The device of claim 5, wherein said second medium is capable of accessing data stored at a location remote from the location of said device.

7. The device of claim 1, wherein said instructions are incorporated in a data file, said data file comprises final estate plans for the bearer or owner of said device.

8. A system for conducting life planning, comprising at least one computer in operable relationship with a data storage device, a data input device, and a data output device, wherein a hierarchical set of interrogatories are incorporated into a computer program that can be stored and implemented by said computer, wherein said system can be used to obtain, store, analyze, update and output information provided in response to said interrogatories, wherein a method for end of life planning for assisting individuals to gather information related to final estate planning can be performed, said method comprising obtaining information in response to inquiries organized into a first, a second, a third and a fourth category, said first category comprising inquiries about an individual's assets and the location of said assets, said second category comprising inquiries about the individual's responsibilities, said third category comprising inquiries about the individual's corporal plans in the event of incapacity or death, and said fourth category comprising inquiries about how the individual desires said assets to be applied to meet said responsibilities and said plans and documentation expressing said desires.

9. The system of claim 8, wherein said computer program is accessible via an internet hub, wherein individuals may remotely access said program, enter personal data, and store said data with said hub.

10. The system of claim 8, further comprising an identity device for providing and obtaining information about the owner or bearer thereof, said identity device comprising a first medium for storing information, and identity information stored on said first medium, wherein said identity information includes a code for identifying the owner or bearer of said identity device and contact information, wherein said code is linked to information about the owner or bearer of said identity device provided in response to said inquiries, and said contact information comprises instructions for communicating with a contact entity, said contact entity having access to said information about the owner or bearer of said identity device provided in response to said inquiries.

11. The system of claim 10, wherein providing said code to said contact entity causes instructions relating to the incapacity or death of same to be implemented, said instructions provided by the owner or bearer of said identity device in response to said inquiries, wherein said instructions comprise at least one of the group consisting of: information required to complete a death certificate, health insurance information, organ donation desires, funeral information, long term care desires, a living will, life insurance information, family information, emergency contact information, medical history, and representative information.

12. The system of claim 10, further comprising a list of end of life planning resources, said resources being linked to said inquiries, wherein at least one of said inquiries is accompanied by information about at least one of said end of life planning resources to assist in answering the inquiry.

13. The system of claim 8, further comprising data on end of life planning resources, said resources being linked to said inquiries based on subject matter, wherein at least one of said inquiries is accompanied by information about at least one of said end of life planning resources in a subject matter corresponding to the subject matter of said inquiry to assist in answering the inquiry, wherein said system provides for individuals answering said inquiries to be provided a vendor referral for a resource that will enable an inquiry to be answered.

14. The system of claim 13, wherein data provided in response to said interrogatories can be updated by a vendor.

15. The system of claim 10, wherein said hub is linked to at least one internet search term selected from the group consisting of deni, deni.net, death, dying, disability, will, trust, probate, estate, funeral, casket, urn, cemetery, burial, grief, mourning, retirement, obituary, life insurance, health insurance, assisted living, and financial planning.

16. The system of claim 10, further comprising an assessment program for identifying final estate or end of life plan deficiencies and for making vendor referrals to assist in curing said deficiencies.

17. The system of claim 16, wherein said vendor referrals include a program for acknowledgement of a disclaimer of liability by said hub.

18. The system of claim 16, wherein said assessment program includes a checklist for identifying final estate or end of life plan details and deficiencies.

19. The system of claim 18, wherein information provided to complete said checklist is automatically analyzed and vendor referrals are made as needed automatically in response thereto.

20. The system of claim 19, wherein said vendor referrals include referrals to at least one of the group consisting of an insurance provider, an investment advisor, a financial planner, a funeral planner, a legal advisor, a casket vendor, an urn vendor, a florist, a crematory service vendor, a cemetery, a long term care provider, an assisted living provider, a bank, a real estate agent, a retirement home, and a grief counseling provider, said insurance provider comprising a provider of at least one of the group consisting of health insurance, life insurance, disability insurance, funeral insurance, and burial insurance.

21. The system of claim 19, wherein revenue can be raised by the operator of said system by at least one of the group consisting of fees for vendor advertising, fees for listing vendors on a preferred vendor list, fees for vendor referrals, sales commissions, fees for using the program to obtain and store data, fees for identity devices, fees for updating stored plan data, and fees for implementing stored instructions.

22. A method for end of life planning for assisting individuals to gather information related to final estate planning, said method comprising obtaining information in response to inquiries organized into a first, a second, a third and a fourth category, said first category comprising inquiries about an individual's assets and the location of said assets, said second category comprising inquiries about the individual's responsibilities, said third category comprising inquiries about the individual's corporal plans in the event of incapacity or death, and said fourth category comprising inquiries about how the individual desires said assets to be applied to meeting said responsibilities and said plans and documentation expressing said desires.

23. A kit for end of life planning, comprising a series of inquiries accessible via computer or in paper form, said inquiries comprising inquiries for assisting individuals to gather information related to final estate planning, said inquiries organized into a first, a second, a third and a forth category, said first category comprising inquiries about an individual's assets and the location of said assets, said second category comprising inquiries about the individual's responsibilities, said third category comprising inquiries about the individual's corporal plans in the event of incapacity or death, and said fourth category comprising inquiries about how the individual desires said assets to be applied to meeting said responsibilities and said plans and documentation expressing said desires, said kit further comprising an identity card, said card having a data field for a code corresponding to a particular entity and information for accessing said data provided in response to said inquiries for a particular entity.

24. A computer program for final estate planning embodied in a computer readable medium, said computer program comprising:
a user interface routine, said user interface routine capable of providing questions and information to and receiving information from a user;
a first storage routine coupled to said user interface routine, said first storage routine comprising a plurality of interactive messages, each of said plurality of interactive messages operative to derive a response from a user, at least one of said interactive messages being related to a user's final estate plans;
a second storage routine coupled with said user interface routine, said second storage routine operative to receive and direct the storage of responses to each of said plurality of interactive messages in a record; and
a program logic routine coupled with said user interface routine and said first and second storage routines wherein said program logic routine utilizes said user interface routine to present each of said plurality of interactive messages to said user and receive each response, said program logic routine including a storage routine to store each response in said record,
wherein said plurality of interactive messages further comprises first, second, third and fourth subsets of interactive messages, said first subset comprising interactive messages about an individual's assets and the location of said assets, said second subset comprising interactive messages about the individual's responsibilities, said third category comprising interactive messages about the individual's corporal plans in the event of incapacity or death, and said fourth category comprising interactive messages about how the individual desires said assets to be applied to meet said responsibilities and said plans and related documentation.

25. The computer program of claim 24, wherein said program logic routine including a routine to generate an access medium to said user, said access medium being transferable to a transferee and comprising an authorization to access at least part of said record from said second storage.

26. The computer program of claim 25, wherein said program logic is further operative to receive said authorization and provide said record in response thereto.

27. The computer program of claim 24, wherein at least one of said plurality of interactive messages is coupled with a resource external to said computer program, said resource operative to assist said user to provide said response.
